(19) United States
(12) Patent Application Publication
(10) Pub. No.: US 2026/0310499 A1
(43) Pub. Date: Oct. 8, 2026

(54) Alternative Digital Tool Selection and Optimization in Digital Model Platforms

(71) Applicant: Istari Digital, Inc., Charleston, SC (US)

(72) Inventors: William Roper, JR., Charleston, SC (US); Christopher Lee Benson, Arlington, VA (US); Sriram Krishnan, Cambridge, MA (US); Baha aldeen E. A. Abunojaim, Roslindale, MA (US); James C. Pavur, Arlington, VA (US); Akil Bhagat, Kirkland, WA (US); Danne Lauren Stayskal, Eastsound, WA (US); Amal Hussein, Great Barrington, MA (US); Adam Jacobson, Washington, DC (US); John Bradley Wood, Boston, MA (US); Najem Aldeen Abu Rmaileh, Amman (JO)

(21) Appl. No.: 19/707,341

(22) Filed: Jun. 14, 2026

Related U.S. Application Data
(63) Continuation of application No. PCT/US24/61606, filed on Dec. 21, 2024.
(60) Provisional application No. 63/613,556, filed on Dec. 21, 2023.

(51) Int. Cl. G06F 9/48

(52) U.S. Cl. CPC G06F 9/4881

(57) ABSTRACT

Systems and methods for completing a digital task using an alternative digital tool are provided. The method may include receiving a user request indicative of the digital task; retrieving a digital model file; and identifying a platform function from a resource-capability mapping of the digital platform. An execution of the platform function may complete the digital task on the digital model file, and the platform function may be associated with a given function schema. Next, identifying, from the resource-capability mapping, an initial function variant of the platform function implemented with an initial digital tool. Then, retrieving, from the resource-capability mapping, an alternative function variant of the platform function implemented with the alternative digital tool, both the initial and the alternative function variants complying with the given function schema. And finally, executing the alternative function variant to complete the digital task on the digital model file using the alternative digital tool.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT application No. PCT/US24/58547 (Docket No. IST-04.001PCT), filed on Dec. 4, 2024, entitled “Data Sovereignty Assurance for Artificial Intelligence (AI) Models,” relates to data sovereignty assurance during AI model training and evaluation.
PCT application No. PCT/US24/49149 (Docket No. IST-02.006PCT), filed on Sep. 28, 2024, entitled “Artificial Intelligence (AI) Assisted End-to-End Workflow Integration for Software Development in Digital Model Platforms,” describes workflow integration with AI-assistance.
PCT application No. PCT/US24/47434 (Docket No. IST-03.010PCT), filed on Sep. 19, 2024, entitled “Platform-Enabled Orchestration and Optimization of Digital Workflows,” describes digital workflow optimization.
PCT application No. PCT/US24/44938 (Docket No. IST-03.006PCT), filed on Sep. 1, 2024 entitled “Multimodal Digital Document Interfaces for Dynamic and Collaborative Reviews,” describes interface enhancement for digital software platforms.
PCT application No. PCT/US24/42768 (Docket No. IST-02.004PCT), filed on Aug. 16, 2024, entitled “Artificial Intelligence (AI) Assisted Automation of Testing in Software Environments,” describes workflow enhancement for digital software platforms.
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P1), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/721,250 (Docket No. IST-04.001P3), filed on Nov. 15, 2024, entitled “Data Sovereignty Assurance for Artificial Intelligence (AI) Models,” further details data sovereignty assurances during AI model training and evaluation.
U.S. provisional patent application No. 63/650,498 (Docket No. IST-05.001P), filed on May 22, 2024, entitled “Fyber: Distributed Digital Threading Platform for Trusted Data Sources.”
U.S. provisional patent application No. 63/664,676 (Docket No. IST-05.002P), filed on Jun. 26, 2024, entitled “Discontinuous Access to Interconnected Digital Model Platforms.”
U.S. Pat. No. 11,775,707 (Docket No. 54332-0057001) filed on Oct. 25, 2022, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This invention relates to digital model platforms, and more specifically to the usage of digital tools within said digital model platforms.

### BACKGROUND OF THE INVENTION

The statements in the background of the invention are provided to assist with understanding the invention and its applications and uses, and may not constitute prior art.

Digital modeling, digital tasks, and digital workflows have become indispensable across various fields of human endeavor, revolutionizing how tasks are accomplished. From healthcare and finance to manufacturing and creative industries, automated digital operations streamline complex procedures, enhance collaboration, and boost productivity. For example, within the field of engineering, such digital approaches allow engineers to simulate, test, and optimize designs before physical prototyping, significantly reducing time and costs. Digital engineering is a comprehensive methodology that represents an integrated digital approach to systems engineering.

While digital engineering relies on diverse digital tools from multiple disciplines for design, validation, verification, manufacturing, to certification of complex systems, these digital tools and their generated models often remain siloed within different software platforms. Users are typically confined to specific native software environments when working with their digital model type files, with access to a limited selection of digital tools. While similar functions may be performed by multiple analogous digital tools that range from proprietary commercial offerings to freely available open-source solutions, users often hesitate to switch or even explore substitution options. This reluctance stems from the prohibitive monetary costs already invested in commercial software licenses and the anticipated time cost for learning and training on new digital tools.

Furthermore, interoperability among different digital tools involved in a digital workflow is highly desirable, yet the aforementioned user access limitations to these digital tools present additional challenges that complicate any integration process. Interoperability among diverse digital tools refers to their capacity to integrate seamlessly, facilitating the exchange of data and the execution of digital tasks across disparate software environments. This integration is particularly pivotal in the implementation of digital workflows and the establishment of digital threads, which necessitate a continuous flow of data and information throughout diverse tools and various phases of a digital workflow. While many respective digital tools existing today are quite mature with a variety of options available, the lack of direct interoperability among them constrains the user from fully utilizing and leveraging the spectrum of digital tools and technologies at their disposal.

Therefore, in view of the aforementioned difficulties, there is an unsolved need to provide a digital collaboration system and platform that offers and integrates a plethora of digital tools to streamline digital workflows.

It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Broadly, the present invention relates to methods and systems for the optimization and enhancement of digital workflows by providing alternative digital tools to perform user-requested digital tasks on digital models, thus better balancing cost, compute power, error, and overall digital workflow performance. Specifically, embodiments of the present invention are directed to alternative digital tool selection, a process that encompasses one or more of digital tool usage pattern and digital task history tracking, digital tool functionality and performance characteristic evaluation, mapping, and isomorphic analysis, alternative digital tool recommendation based on the digital task at hand and iterative user feedback, and token management to link selected alternative tools to execute and complete a requested digital task. Exemplary system components of an interconnected digital model platform (IDMP) for alternative digital tool selection include one or more of a user interface, a digital tool and task history database storing user action data and an IDMP resource-capability mapping, an analysis engine for tool usage pattern tracking, a rule-based or machine learning (ML)-based comparator and recommender module, and a token management module.

Alternative tool recommendation and utilization within the integrated digital model platform may be facilitated by model splicing technologies that standardize digital model data and provide generalized Application Programming Interface (API) interfaces and functions. This standardization and generalization enable the access of model type files outside of their native software environments, allow for linking of different digital model type files that may not previously be interoperable, and facilitate substitution of individual digital tools without interrupting the execution of a digital workflow. Furthermore, model splicing enables the scripting of digital model operations encompassing disparate digital tools into a corpus of normative program code. Codification of digital model operations then enables the generation and training of artificial intelligence (AI) and machine learning (ML) models for the purpose of manipulating digital models through various digital tools. In the context of digital workflow enhancement via alternative tool recommendation and selection, tool usage patterns and digital task history may be tracked, along with digital tool functionality and performance characteristic mapping and isomorphic analysis, to facilitate the training of a rule-based or ML-based recommender module. Such a recommender module may suggest or predict digital tools most suitable for a user's specific requirements, based on user query, input model type file, or other relevant considerations.

The digital workflow optimization resulting from alternative digital tool recommendation and selection may lead to significant reductions in cost and delays while maintaining or improving performance throughout different stages of a digital engineering lifecycle. A wider range of digital model file types and formats may also be supported through alternative tools, thereby enhancing the system's overall interoperability. Furthermore, integration of multiple alternative tools in specific digital tasks such as digital modeling and simulations can expand the design space, diversify the output datasets, and allow a more comprehensive evaluation of potential design performances. The enrichment of datasets within the same design space can further provide additional training data for the development of machine learning models for digital simulation applications. From a user-centric perspective, alternative digital tool selection simplifies the process of integrating new digital tools into a user's existing tasks, and expands the range of cost-performance tradeoffs available to users.

In a first aspect, one embodiment of the present invention, is one or more non-transitory physical storage media storing program code. The program code is executable by a hardware processor. The hardware processor when executing the program code causes the hardware processor to complete a digital task using an alternative digital tool. The one or more non-transitory storage media may include program code to receive a user request indicative of the digital task involving an input digital model. The program code may include code to retrieve a digital model file of the input digital model, wherein the digital task is to be completed on the digital model file using an initial digital tool within a digital platform. The program code may include code to identify a platform function from a resource-capability mapping of the digital platform, wherein an execution of the platform function completes the digital task on the digital model file, wherein the platform function is associated with a given function schema, wherein the resource-capability mapping provides a correspondence between a given resource on the digital platform and a corresponding capability of the given resource, wherein the given resources comprise tool functions and digital model types accessible on the digital platform, and wherein the corresponding capabilities of the given resources comprise platform functions executable on the digital platform. The program code may include code to identify, from the resource-capability mapping, an initial function variant of the platform function implemented with the initial digital tool, wherein the initial function variant complies with the given function schema. The program code may include code to retrieve, from the resource-capability mapping, an alternative function variant of the platform function implemented with the alternative digital tool, wherein the alternative function variant also complies with the given function schema. The program code may include code to execute the alternative function variant of the platform function to complete the digital task on the digital model file using the alternative digital tool.

In some embodiments, the program code further comprises code to receive a user selection of the initial digital tool.

In some embodiments, the program code further comprises code to receive a user request for the alternative digital tool; determine that the resource-capability mapping of the digital platform does not include the alternative function variant implemented with the alternative digital tool; in response to determining that the resource-capability mapping of the digital platform does not include the alternative function variant, perform an isomorphic analysis between the initial digital tool and the alternative digital tool, based on usage information of the initial digital tool and of the alternative digital tool retrieved from a digital tool and task history database, API documentation of the alternative digital tool, and the resource-capability mapping of the digital platform, wherein two isomorphic digital tools comprise corresponding tool functions that perform similar data operations on similar tool function inputs; generate the alternative function variant for the platform function, based on a result of the isomorphic analysis; and add the alternative function variant to the resource-capability mapping.

In some embodiments, the isomorphic analysis is limited to tool functions of the initial digital tool called upon by the initial function variant.

In some embodiments, the initial function variant and the alternative function variant are written in a scripting language, and wherein the program code to generate the alternative function variant further comprises code to substitute each tool function call of the initial tool function in the initial function variant with a corresponding function call of the alternative tool function.

In some embodiments, the program code further comprises code to execute the initial function variant of the IDMP function to complete the target digital task on the digital model file using the initial digital tool, to generate a first output, wherein the execution of the alternative function variant of the platform function completes the target digital task on the digital model file to generate a second output; and generate a comparison result from comparing the first output and the second output based on one or more evaluation criteria.

In some embodiments, the program code further comprises code to present the comparison result to a user; receive from the user, a selection of the alternative digital tool for use to complete the target digital task; and add the user selection to the digital tool and task database.

In some embodiments, the program code to retrieve the alternative function variant further comprises code to identify the alternative function variant, by analyzing digital tool and task history data stored in a digital tool and task history database to pattern-track how the user navigated through the digital platform and the user's tool decisions to complete analogous tasks in the past.

In some embodiments, the user request is indicative of a user intent related to the digital platform, wherein the user request comprises one or more operations performable by the user on the digital platform to achieve the user intent, wherein the user intent comprises an outcome desired by the user when interacting with the digital platform, and wherein the program code further comprises code to generate the digital task based on the user intent.

In some embodiments, the program code further comprises code to track, using a token management module, the execution of the alternative function variant to complete the digital task using one or more idempotent tokens to avoid duplicate executions.

In some embodiments, the initial digital tool and the alternative digital tool are provided by at least two distinct digital tool providers, and at least one of the initial digital tool and the alternative digital tool is open-sourced.

In some embodiments, the program code further comprises code to modify a platform script to generate a modified platform script by replacing an invocation of the initial function variant with an invocation of the alternative function variant.

In some embodiments, the program code further comprises code to verify that the modified platform script, when interpreted, generates an identical output as the platform script, within a given error tolerance.

A second aspect, or another embodiment of the present invention, is a computer-implemented method for completing a digital task using an alternative digital tool. The method may include receiving a user request indicative of the digital task involving an input digital model; retrieving a digital model file of the input digital model, wherein the digital task is to be completed on the digital model file using an initial digital tool within a digital platform; identifying a platform function from a resource-capability mapping of the digital platform, wherein an execution of the platform function completes the digital task on the digital model file, wherein the platform function is associated with a given function schema, wherein the resource-capability mapping provides a correspondence between a given resource on the digital platform and a corresponding capability of the given resource, wherein the given resources comprise tool functions and digital model types accessible on the digital platform, and wherein the corresponding capabilities of the given resources comprise platform functions executable on the digital platform; identifying, from the resource-capability mapping, an initial function variant of the platform function implemented with the initial digital tool, wherein the initial function variant complies with the given function schema; retrieving, from the resource-capability mapping, an alternative function variant of the platform function implemented with the alternative digital tool, wherein the alternative function variant also complies with the given function schema; and executing the alternative function variant of the platform function to complete the digital task on the digital model file using the alternative digital tool.

Features described with respect to the first aspect apply equally to the second aspect.

In another aspect or embodiment of the present invention, a non-transitory, computer-readable storage medium is provided, the non-transitory, computer-readable storage medium storing executable instructions which when executed by a processor, causes the processor to perform a process for completing a digital task using an alternative digital tool including the aforementioned steps.

In yet another aspect or embodiment of the present invention, a computer program product is provided. The computer program may be used for completing a digital task using an alternative digital tool and may include a computer-readable storage medium having program instructions, or program code, embodied therewith, the program instructions executable by a processor to cause the processor to perform the aforementioned steps.

In yet another aspect or embodiment of the present invention, a system for completing a digital task using an alternative digital tool is provided, the system including a memory that stores computer-executable components, and a hardware processor, operably coupled to the memory, and that executes the computer-executable components stored in the memory, where the computer-executable components may include components communicatively coupled with the processor that execute the aforementioned steps.

In yet another aspect or embodiment of the present invention, a system for completing a digital task using an alternative digital tool is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In yet another aspect or embodiment of the present invention, a computerized server is provided, including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and also include the processes and modes of operation of the systems and servers described herein.

In yet another aspect or embodiment of the present invention, an edge computerized system is provided, the edge computerized system running on a physical system or physical twin (PTw) with either access to, or dedicated, processing, memory, computer code stored on a non-transitory computer-readable storage medium of the physical system or PTw, and a plurality of sensor data being measured on said physical system or PTw, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

### Interconnected Digital Model Platform (IDMP)

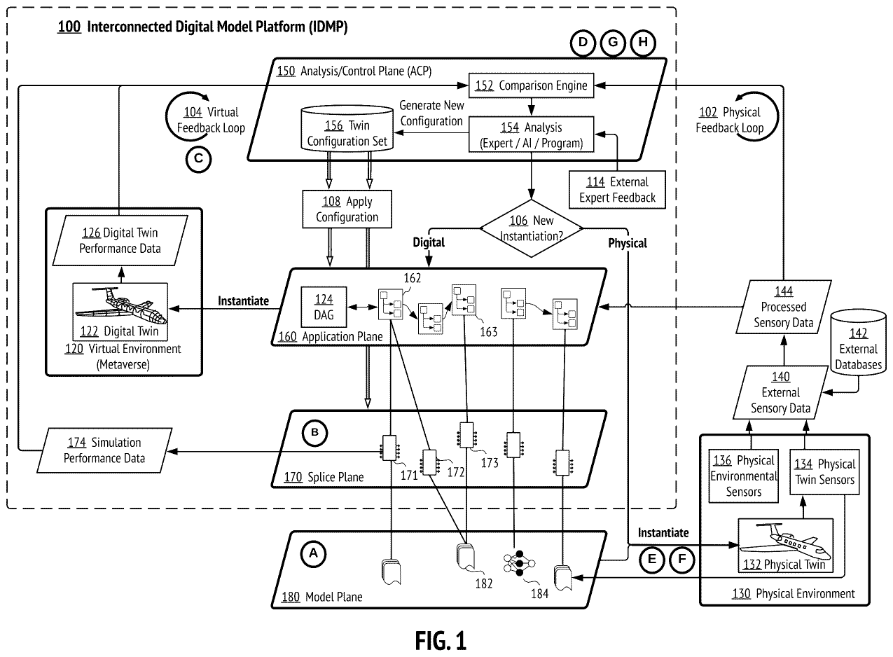

FIG. 1 shows an exemplary interconnected digital model platform (IDMP) architecture, in accordance with some embodiments of the present invention.

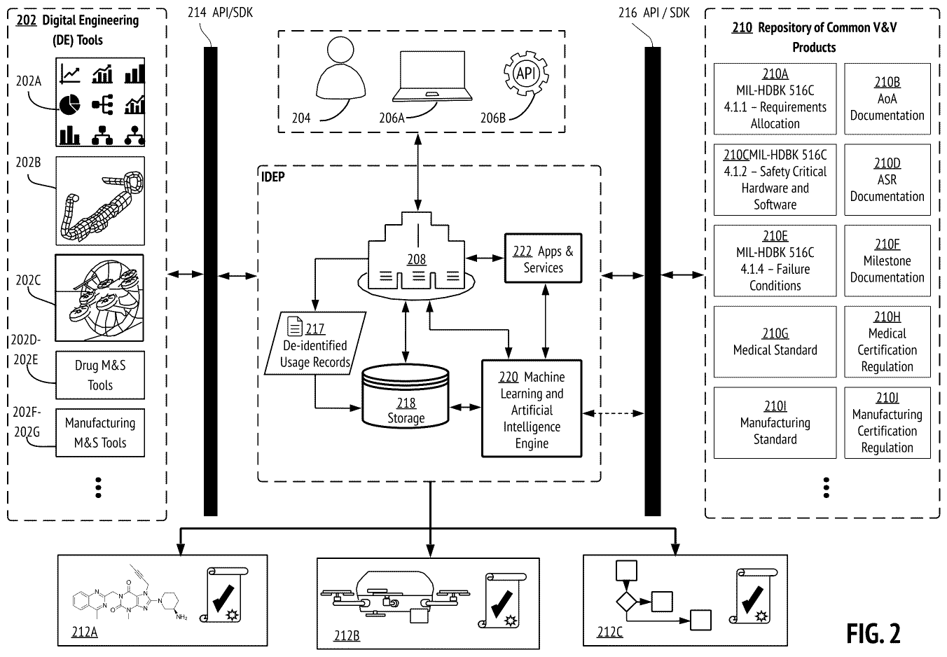

FIG. 2 shows an exemplary implementation of an IDEP as an interconnected digital engineering (DE) and certification ecosystem, and exemplary digitally certified products, in accordance with some embodiments of the present invention.

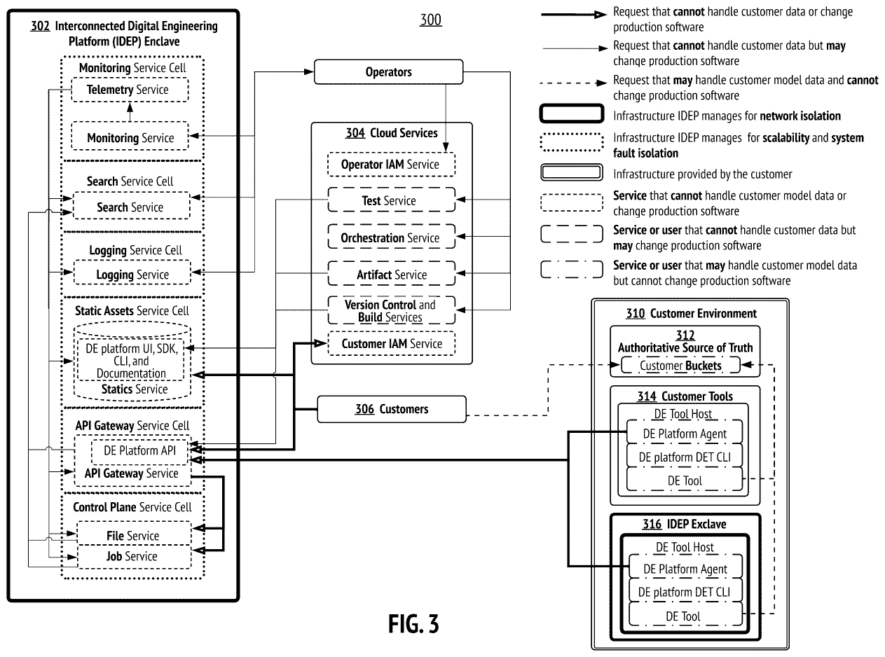

FIG. 3 shows another exemplary implementation of the IDEP illustrating its offered services and features, in accordance with some embodiments of the present invention.

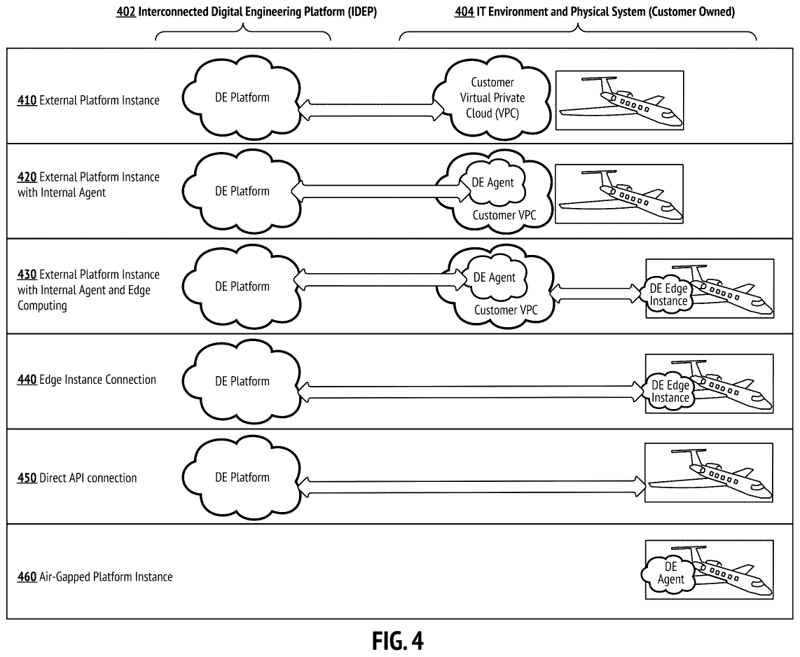

FIG. 4 shows potential scenarios for instantiating an IDEP in connection to a customer's physical system and IT environment, in accordance with some embodiments of the present invention.

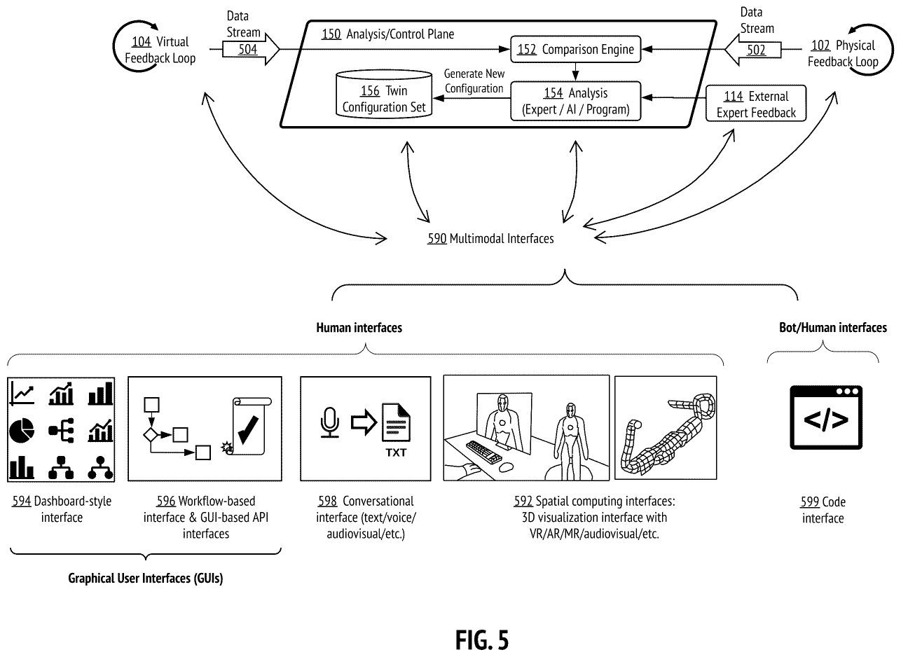

FIG. 5 shows exemplary multimodal interface designs for integration of feedback in an IDEP, in accordance with some embodiments of the present invention.

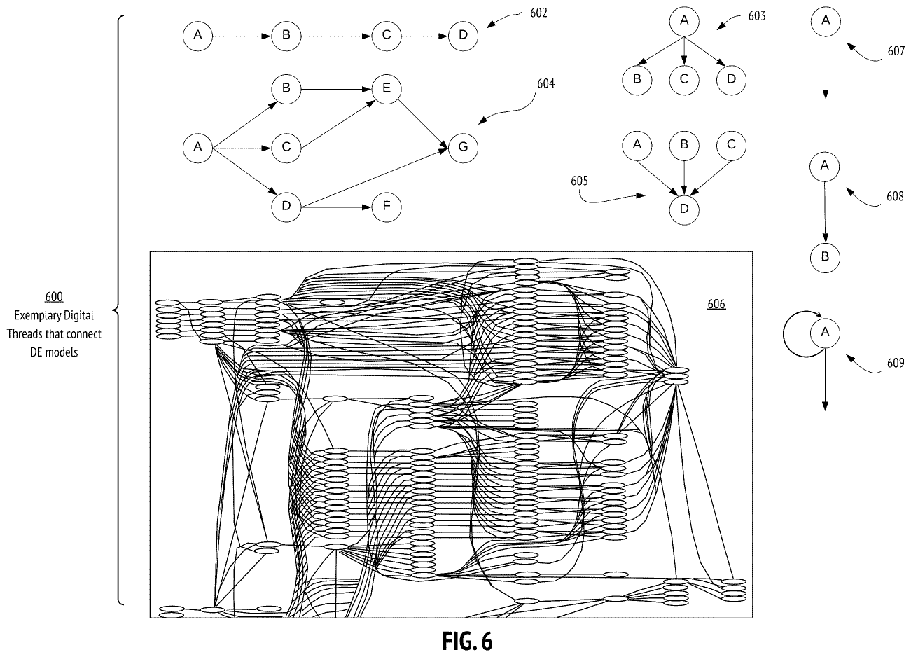

FIG. 6 is a schematic diagram comparing exemplary digital threads that connect DE models, in accordance with some embodiments of the present invention.

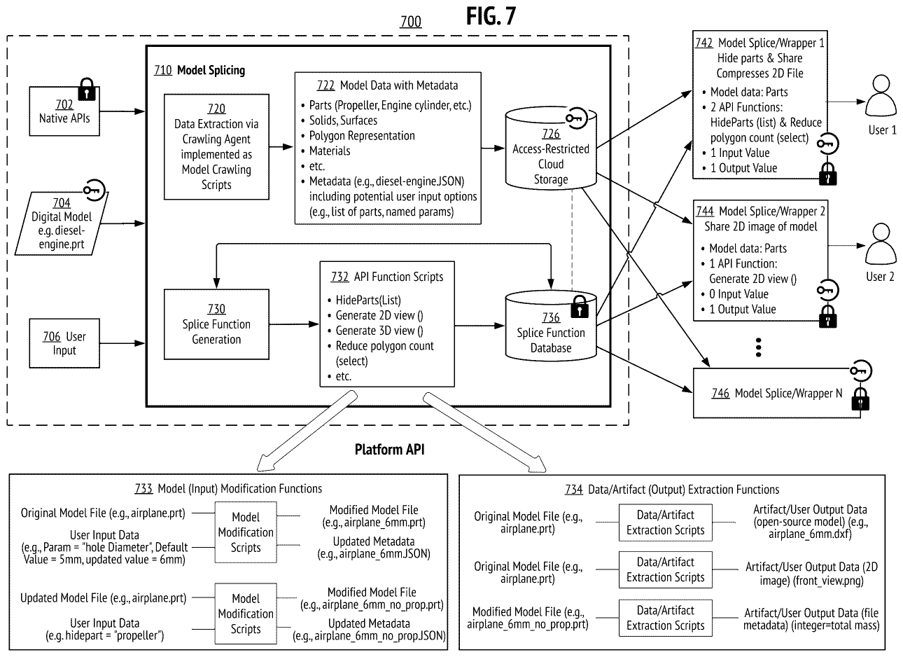

FIG. 7 is a schematic showing an exemplary DE model splicing setup, in accordance with some embodiments of the present invention.

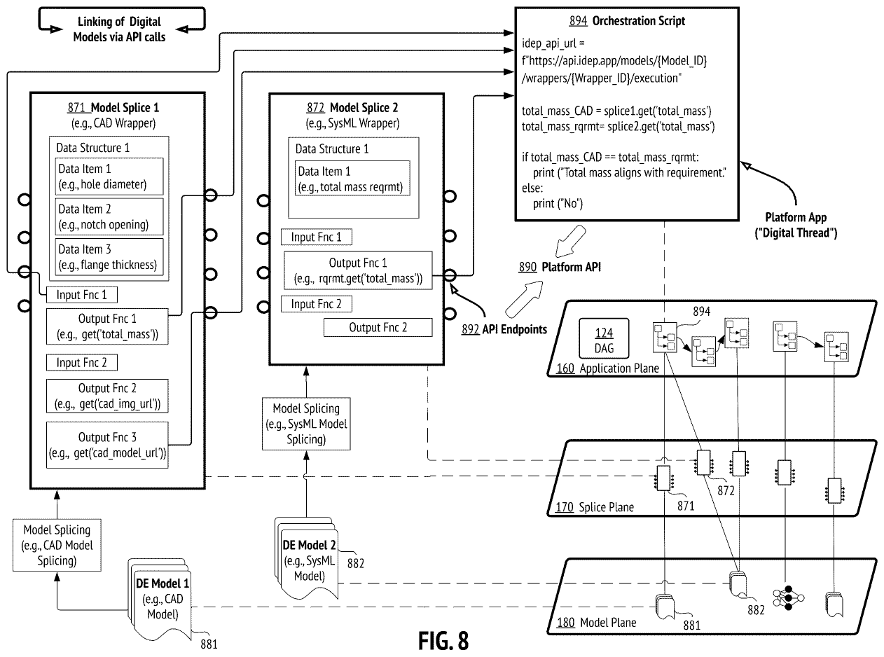

FIG. 8 is a schematic showing digital threading of DE models via model splicing, in accordance with some embodiments of the present invention.

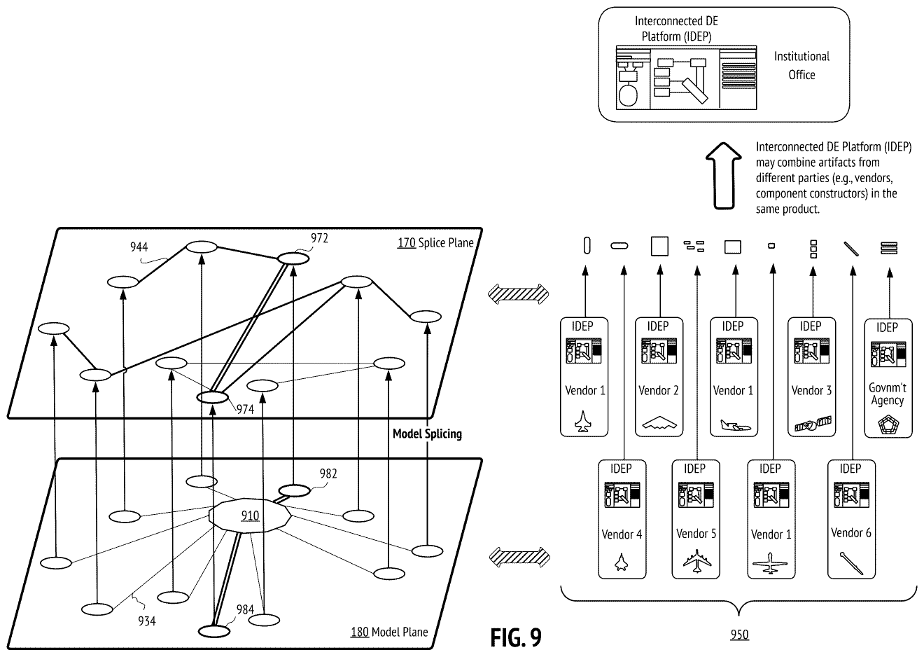

FIG. 9 is a schematic illustrating the linking of DE model splices in a splice plane and comparing digital threading with and without model splicing, in accordance with some embodiments of the present invention.

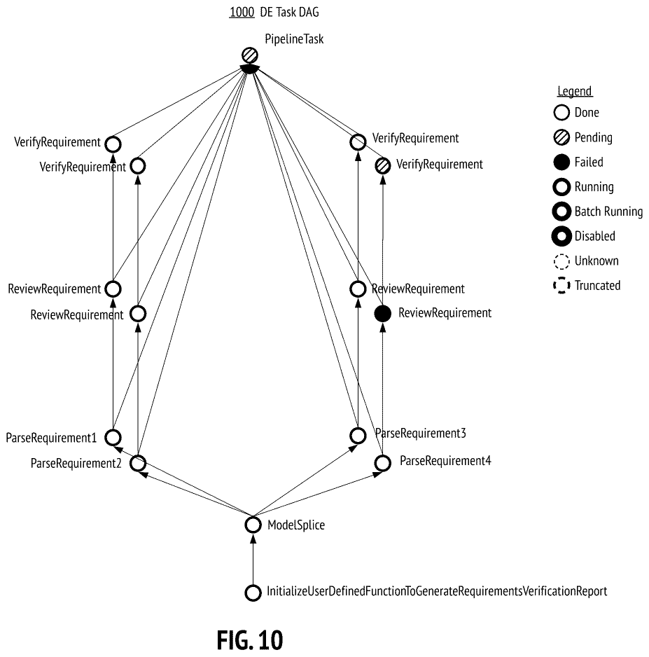

FIG. 10 shows an exemplary directed acyclic graph (DAG) representation of pipelined DE tasks related to digital threads, in accordance with some embodiments of the present invention.

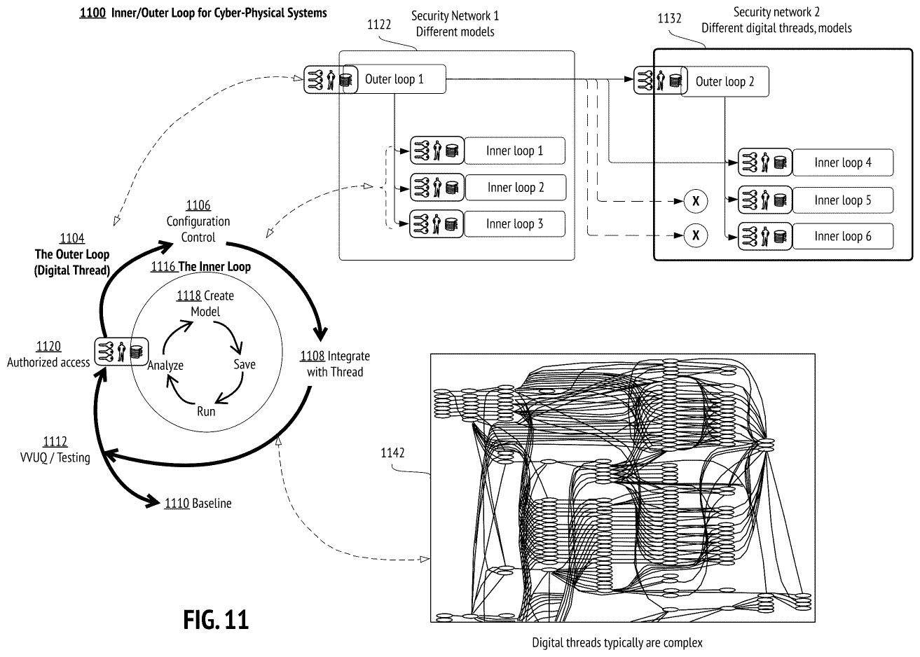

FIG. 11 is an exemplary schematic illustrating the interplay between a digital thread and the individual models or artifacts it uses, defining outer and inner loop processes, in accordance with some embodiments of the present invention.

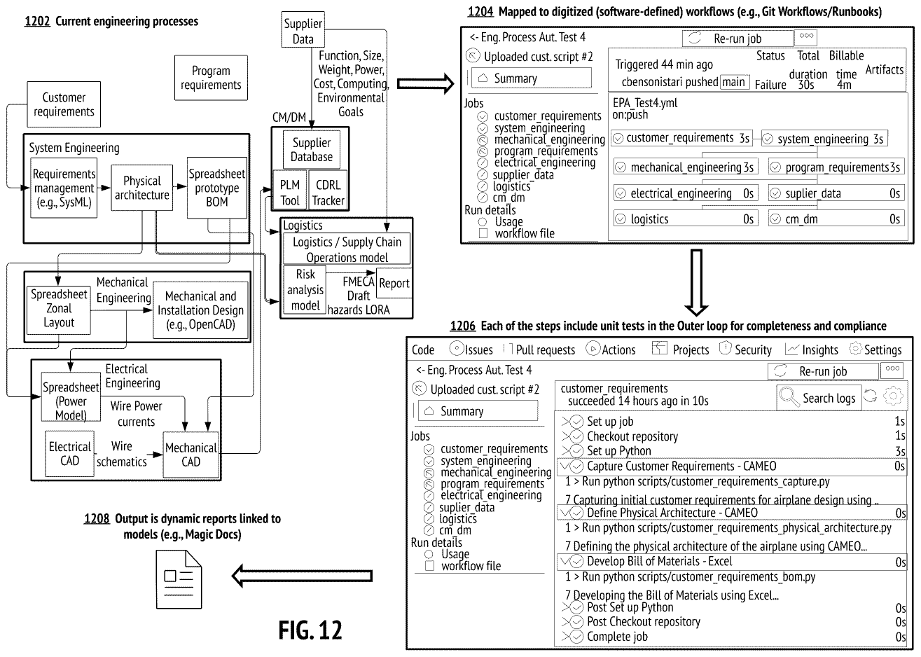

FIG. 12 illustrates an exemplary digital engineering process in the aerospace industry, showing outer loop processes, in accordance with some embodiments of the present invention.

### Alternative Tool Selection in Digital Model Platforms

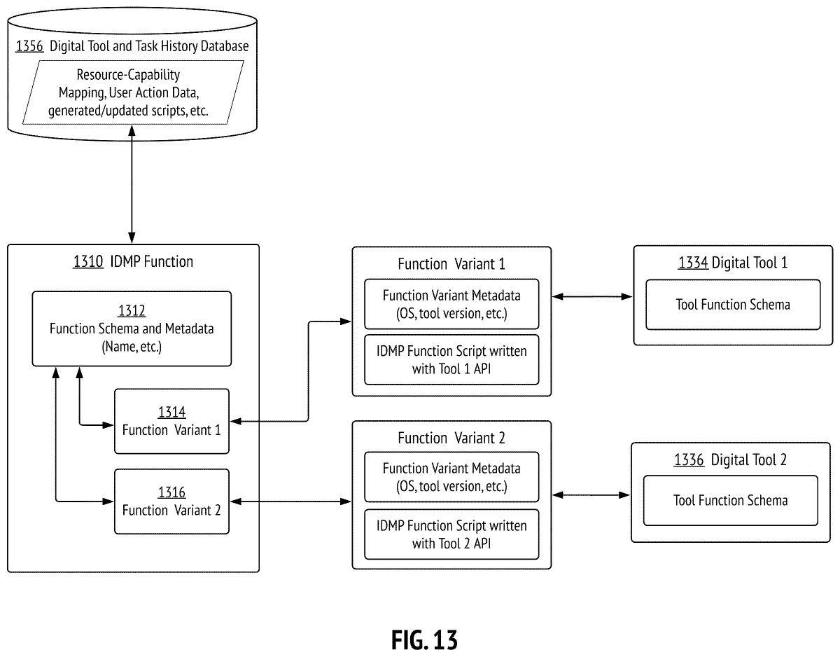

FIG. 13 illustrates platform function variants under the same platform function schema, in accordance with some embodiments of the present invention.

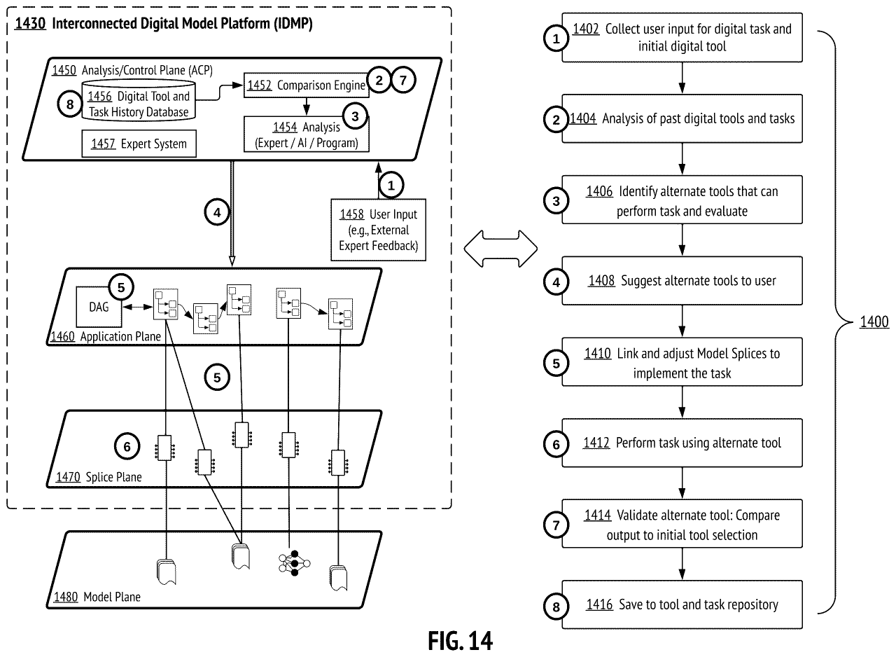

FIG. 14 shows an exemplary implementation of alternative digital tool selection within an IDMP based on a user request, in accordance with some embodiments of the present invention.

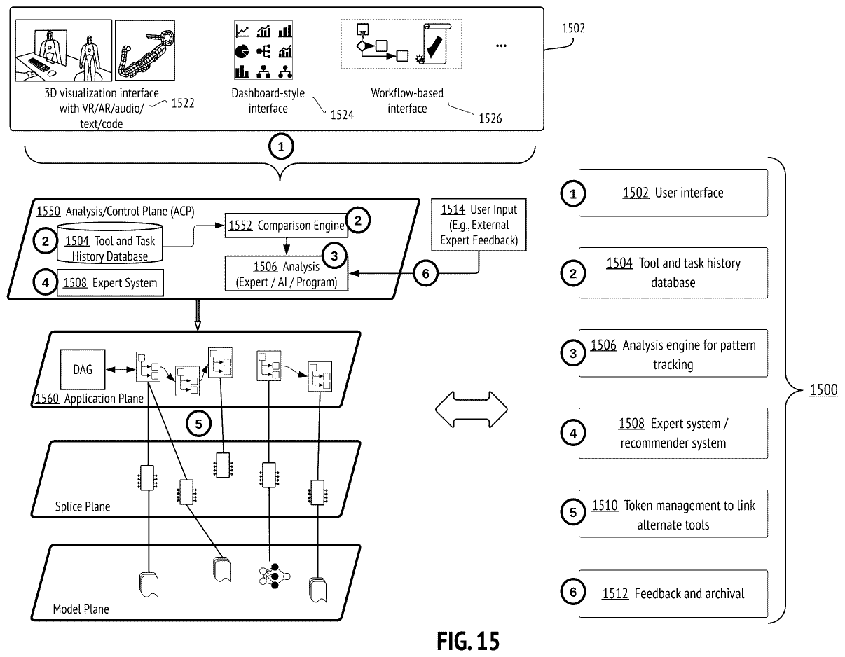

FIG. 15 shows illustrative component modules of an IDMP that implements alternative tool selection, in accordance with some embodiments of the present invention.

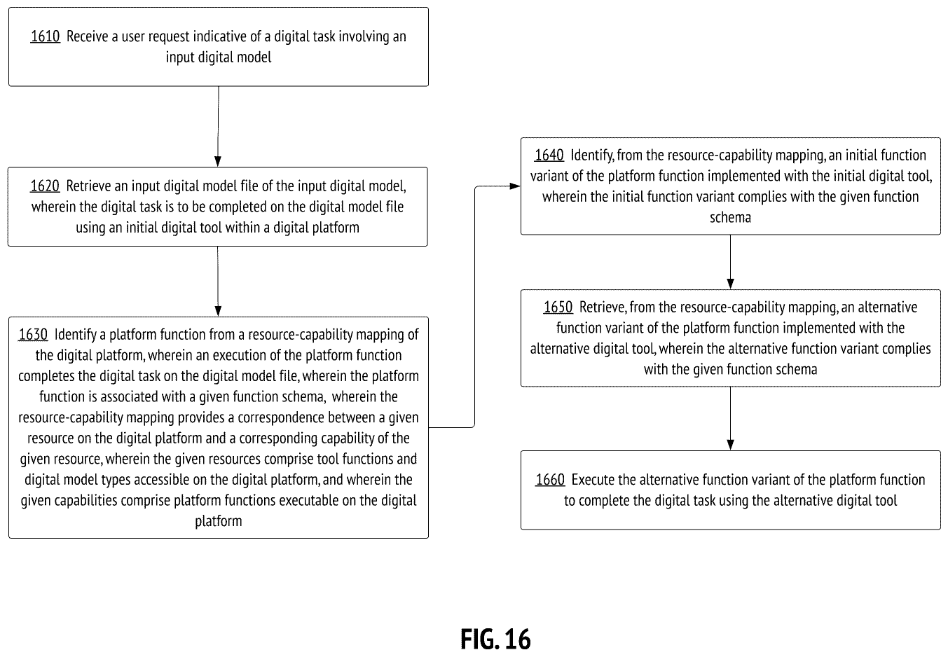

FIG. 16 is an exemplary flowchart showing a process for alternative digital tool selection, in accordance with some embodiments of the present invention.

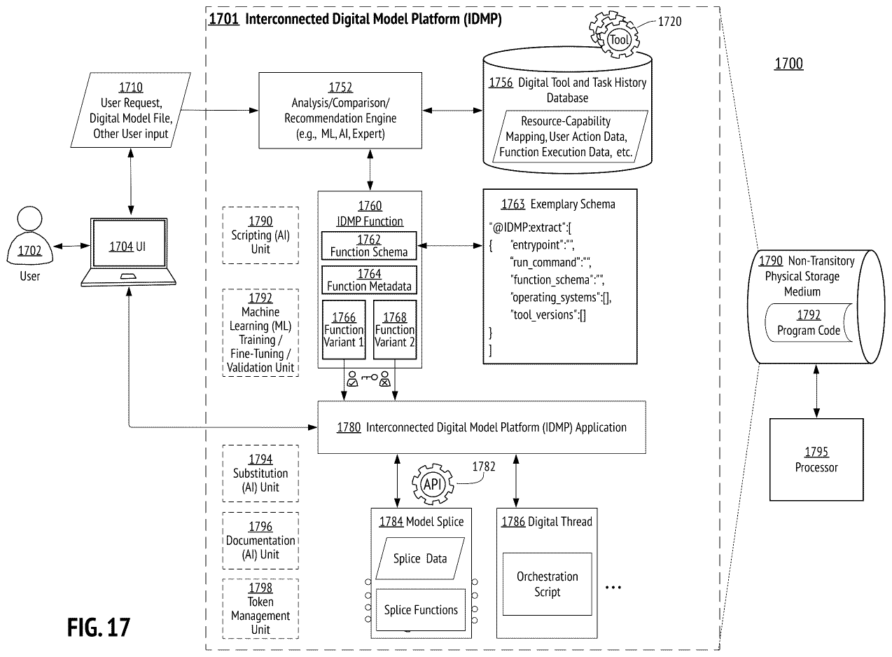

FIG. 17 is an exemplary system diagram for implementing an alternative digital tool selection process on the IDMP, in accordance with some embodiments of the present invention.

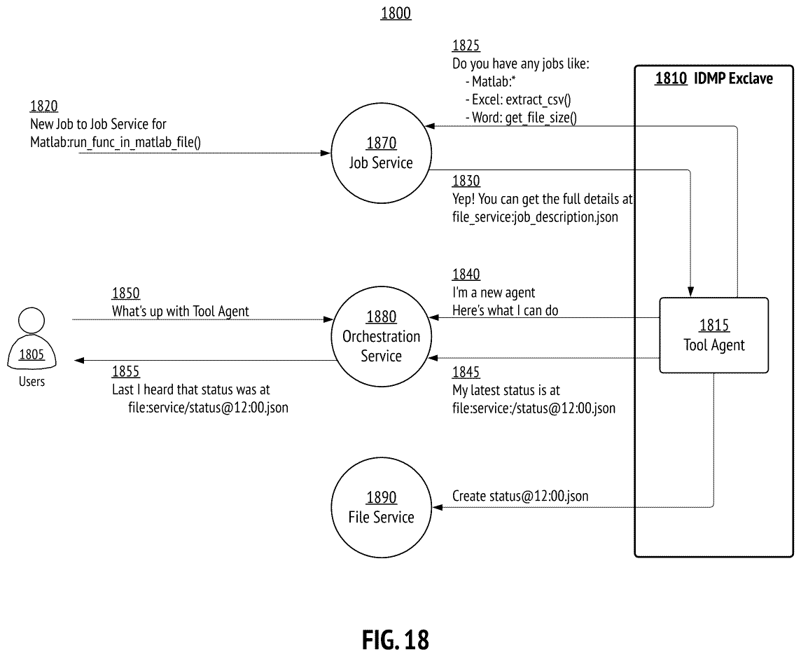

FIG. 18 is an exemplary schematic diagram illustrating the orchestration of agents in an IDMP exclave, in accordance with some embodiments of the present invention.

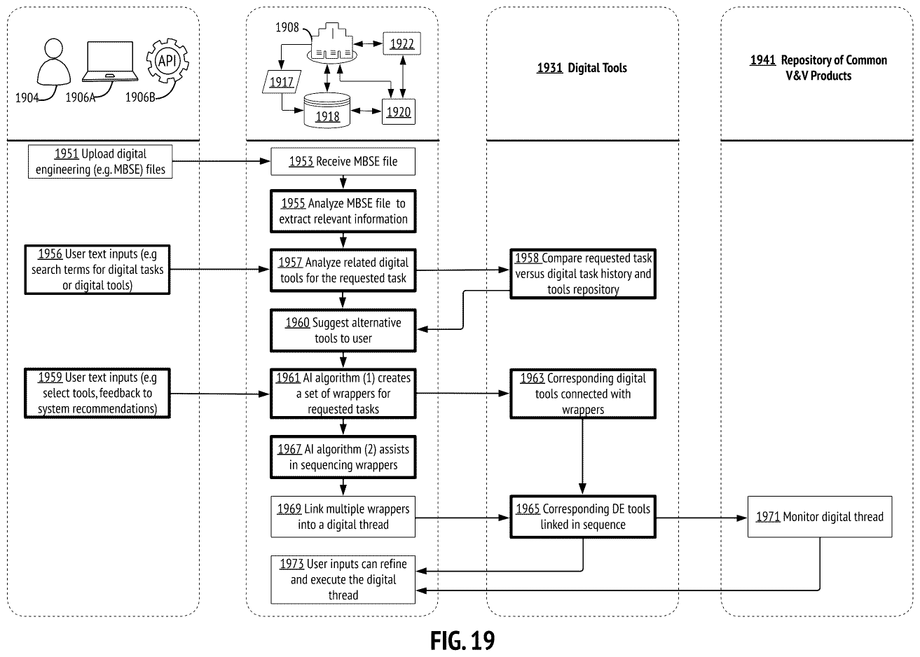

FIG. 19 shows an exemplary schematic illustrating implementation steps for digital thread creation on the IDMP from input Model-Based Systems Engineering (MBSE) model file as uploaded by a user for a particular user application, with options for alternative tool selection, in accordance with some embodiments of the present invention.

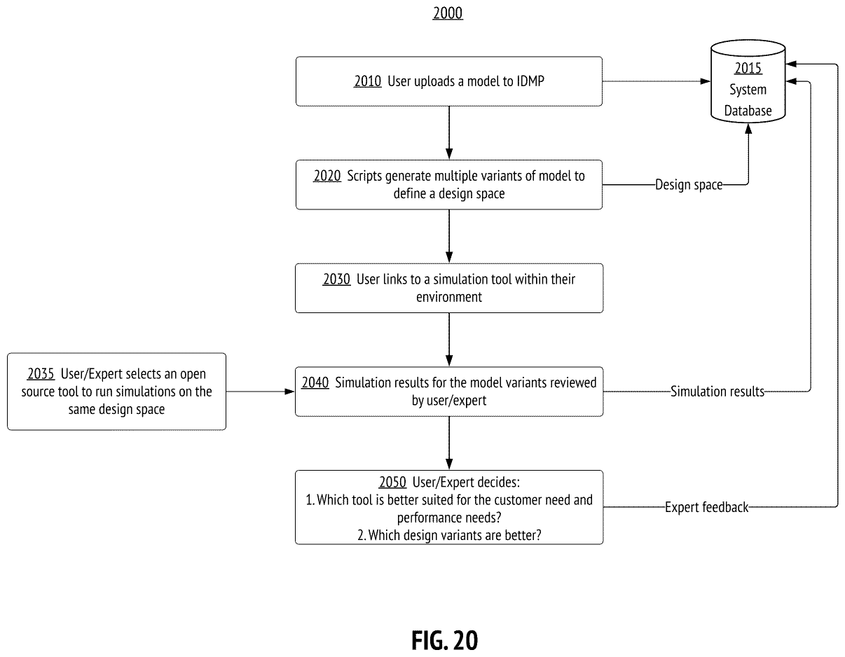

FIG. 20 shows an illustrative process for implementing the selection of alternative simulation tools for the same design space, in accordance with some embodiments of the present invention.

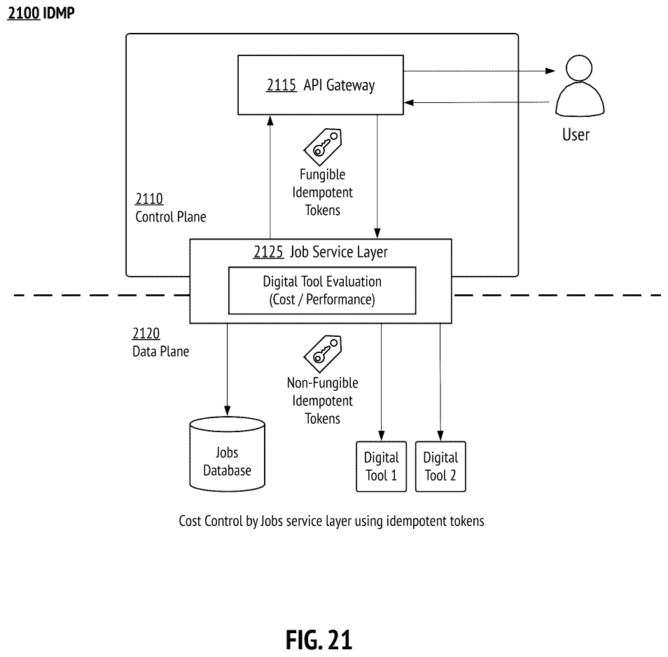

FIG. 21 shows an illustrative data flow when a requested DE task is assigned to a tool and tracked using idempotent tokens to avoid duplicate executions, in accordance with some embodiments of the present invention.

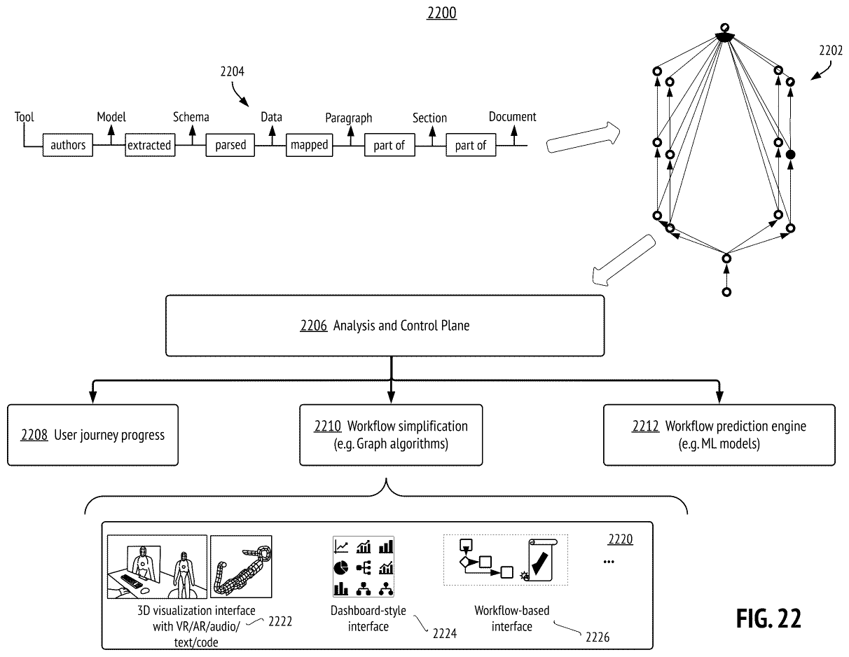

FIG. 22 presents an overview of potential approaches within the IDMP to simplify certification workflows.

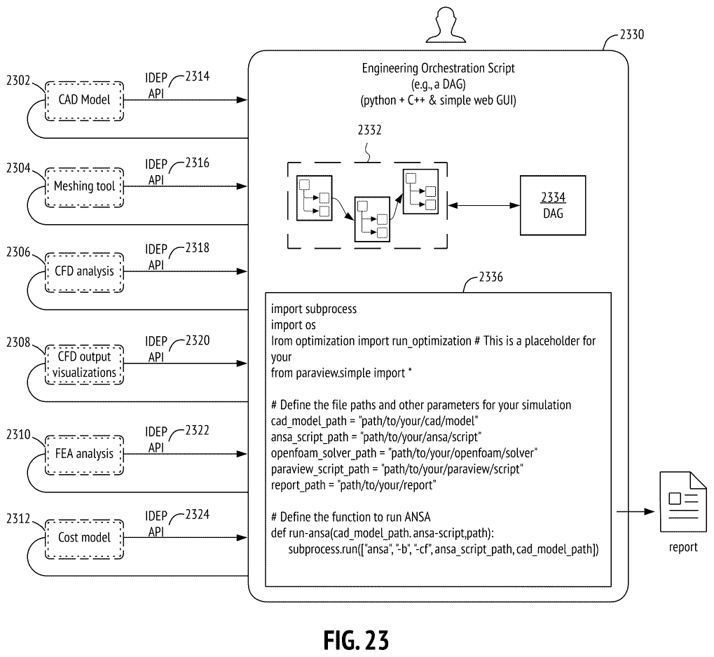

FIG. 23 shows an example of evaluating CAD models within a simulation environment, enhanced through orchestrated digital threads over the IDMP, in accordance with the examples disclosed herein.

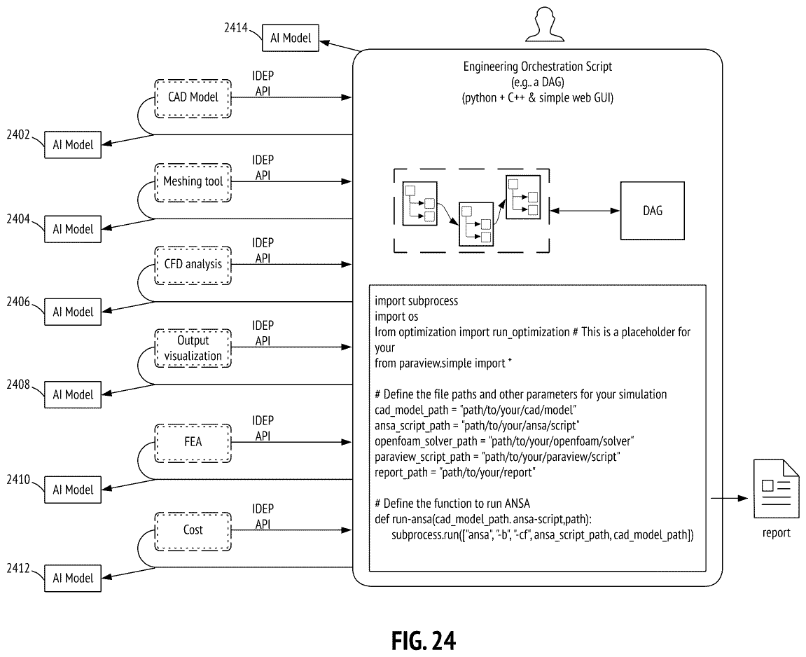

FIG. 24 shows the example of evaluating CAD models within a simulation environment, further enhanced through AI-enabled processes over the IDMP, in accordance with the examples disclosed herein.

### Machine Learning Implementation Architecture for IDMP/IDEP Operations

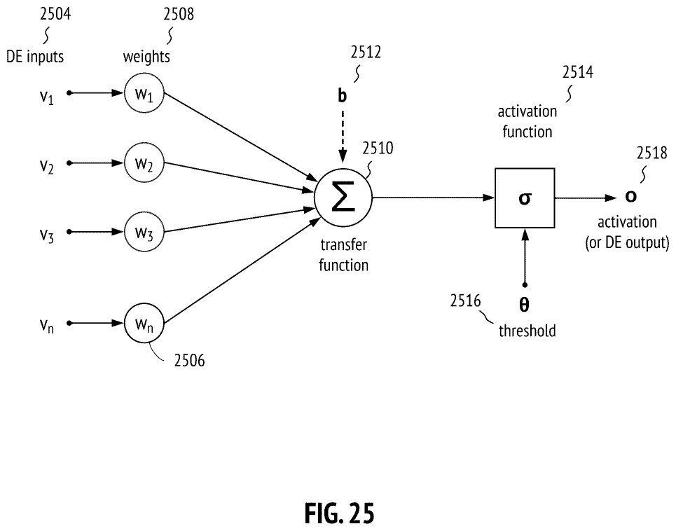

FIG. 25 describes neural network operation fundamentals, in accordance with some embodiments of the present invention.

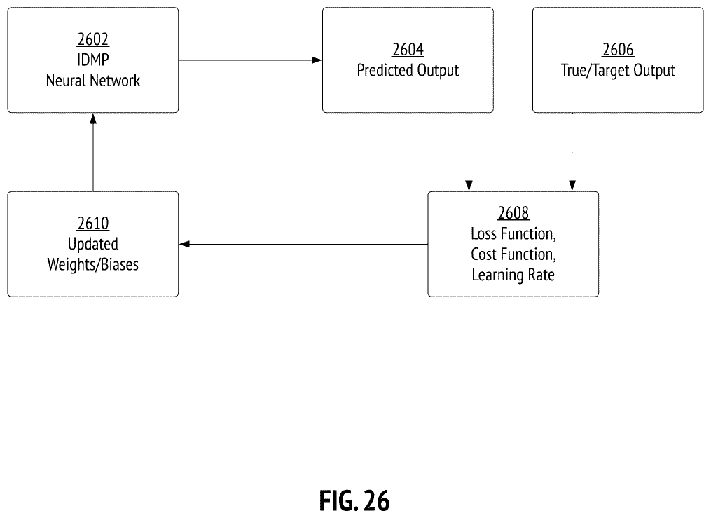

FIG. 26 shows an overview of an IDMP neural network training process, in accordance with some embodiments of the present invention.

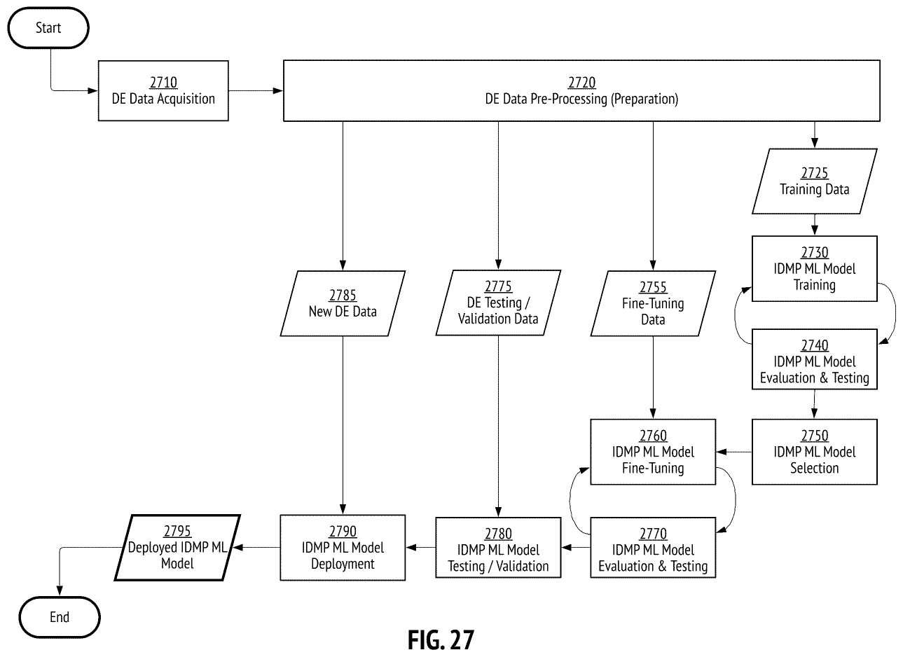

FIG. 27 is an illustrative flow diagram showing the different phases and datasets involved in training an IDMP machine learning model, in accordance with some embodiments of the present invention.

### Hardware and Software Architecture for IDMP/IDEP Operations

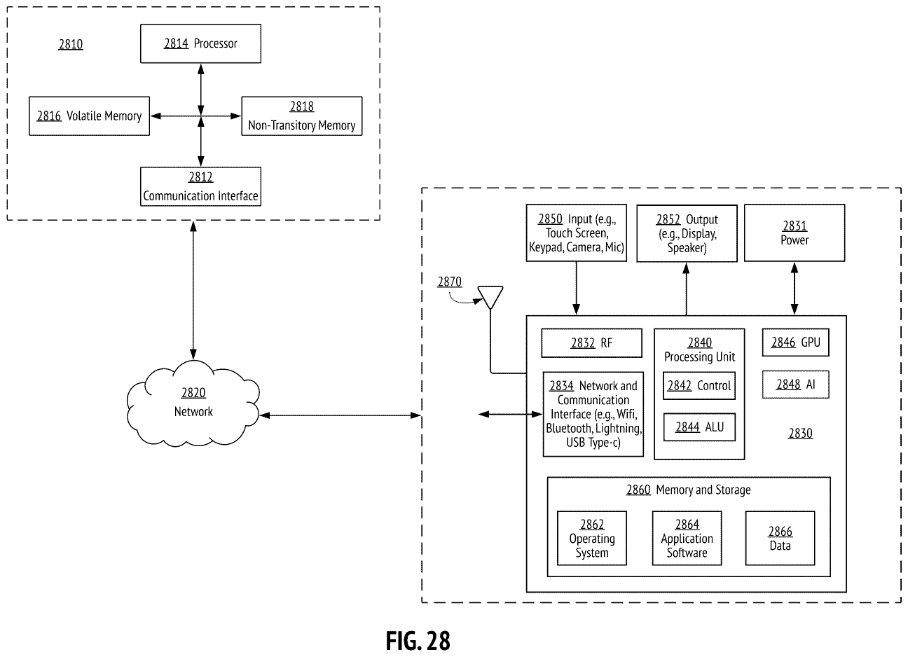

FIG. 28 provides illustrative schematics of a server (management computing entity) and a client (user computing entity) used within an IDMP, in accordance with some embodiments of the present invention.

### DETAILED DESCRIPTION OF THE INVENTION

In the following description, for purposes of explanation, numerous specific details are set forth to provide a thorough understanding of the invention. It will be apparent, however, to one skilled in the art that the invention can be practiced without these specific details. In other instances, structures, devices, activities, methods, and processes are shown using schematics, use cases, and/or diagrams to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, the present invention relates to methods and systems for the optimization and enhancement of digital workflows by providing alternative digital tools to perform user-requested digital tasks on digital models, thus better balancing cost, compute power, error, and overall digital workflow performance. Specifically, embodiments of the present invention are directed to alternative digital tool selection, a process that encompasses one or more of digital tool usage pattern and digital task history tracking, digital tool functionality and performance characteristic evaluation, mapping, and isomorphic analysis, alternative digital tool recommendation based on the digital task at hand and iterative user feedback, and token management to link selected alternative tools to execute and complete a requested digital task. Exemplary system components of an interconnected digital model platform (IDMP) for alternative digital tool selection include one or more of a user interface, a digital tool and task history database storing user action data and an IDMP resource-capability mapping, an analysis engine for tool usage pattern tracking, a rule-based or machine learning (ML)-based comparator and recommender module, and a token management module.

With reference to the figures, embodiments of the present invention are now described in detail. First, an interconnected digital model platform (IDMP) and its digital engineering embodiment (IDEP) are explained in detail. Next, digital model splicing and threading operations are described in detail. The alternative tool selection process and its exemplary implementations and use cases are then detailed within the framework of model splicing and threading on the IDMP.

### Terminology

Some illustrative terminologies used herein are provided at the end of this document to assist in understanding the present invention, but these are not to be read as restricting the scope of the present invention. The terms may be used in the form of nouns, verbs, or adjectives, within the scope of the definition.

### An Interconnected Digital Model Platform (IDMP) Architecture

FIG. 1 shows an exemplary interconnected digital model platform (IDMP) architecture, in accordance with some embodiments of the present invention. In the context of digital engineering (DE), IDMP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals. In what follows, the terms IDMP and IDEP are used interchangeably, as an interconnected digital engineering platform (IDEP) is a representative type of IDMPs.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 124. A DE task DAG example is discussed in further detail with reference to FIG. 10.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such analysis may be done by an analysis module 154, and may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads. Within the ACP 150, the analysis module 154 may carry out testing of the product. Additionally, testing of the twin configuration set 156, which includes feature testing, may occur in the connection between the analysis module 154 and the twin configuration set 156.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

Model splicing is discussed in further detail with reference to FIGS. 7 to 9. Model splicing enables the scripting of any DE operation involving DE model files in model plane 180, where each DE model is associated with disparate and siloed DE tools. Codification of DE models and DE operations with a unified corpus of scripts enable IDMP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected platform or ecosystem 100. As a consequence, the generation and training of AI modules for the purpose of manipulating DE models (e.g., 182), digital threads (e.g., 162), and digital twins (e.g., 122) become possible over the programmable and unified IDMP 100.

### Virtual and Physical Feedback Loops

FIG. 1 uses letter labels “A” to “H” to denote different stages of a product's lifecycle. At each stage, IDMP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144. In one exemplary embodiment, temperature readings from environmental sensors located within the physical environment are completed, adjusted (e.g., shifted), and/or calibrated using data from external temperature databases.

Data from PTw sensors 134 may be directly added to the model files in model plane 180 by the DE software tools used in the design process of PTw 132. Alternatively, PTw sensor data may be added to digital thread 162 associated with PTw 132 directly via application plane 160. In addition, processed sensory data 144 may be integrated into IDMP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDMP 100, or automated changes enabled by IDMP 100 where updates to DTw 122 are generated through programmed algorithms or AI modules. This iterative updating process continues until DTw 122 and PTw 132 are in sync and the product's performance meets desired goals. While IDMP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:
A. Digital models reside within customer environments: a product may be originally represented by model files that are accessible via software tools located within customer environments. Model plane 180 encompasses all model files (e.g., 182) associated with the product.
B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 7 to 9.
C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.
D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.
E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDEP 100 components described above may be used in the assembly process. In its authoritative iteration, DTw 122 ultimately captures the precise details of the physical assembly, enabling comprehensive analysis and control in subsequent stages of the process.
G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but are not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.
H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

The hardware components making up IDMP 100 (e.g., servers, computing devices, storage devices, network links) may be centralized or distributed among various entities, including one or more DE service providers and DE clients, as further discussed in the context of FIGS. 3 and 4. FIG. 4 shows an illustration of various potential configurations for instancing a DE platform within a customer's physical system and information technology (IT) environment, usually a virtual private cloud (VPC) protected by a firewall.

### Digital Documentation Through Live Digital Objects

The methods and systems described herein enable the updating and generation of digital documents using the full functionality of the IDMP shown in FIG. 1. In FIG. 1, the IDMP virtual feedback loop 104 allows the scripting of program code within a digital thread 162 for the generation, storing, and updating of digital twins 122 and twin configurations 156. Similarly, the IDMP virtual feedback loop 104 also allows the scripting of program code within a digital thread 162 for the generation, storing, and updating of digital documents. This enables the creation and maintenance of so-called live digital objects.

Live digital objects are more akin to a DTw than a conventional static document in that they are configured, through a digital thread, to be continuously updated to reflect the most current changes within a particular twin configuration. In particular, an authoritative/trusted live digital object is configured to reflect the latest authoritative/trusted twin configuration. Specifically, live digital objects are digital objects that (1) include a digital artifact extracted from a digital model through a model presentation (e.g., model splice), where (2) a modification of the digital artifact appears in the live digital object within a predetermined delay. In various embodiments, the updates are effectively real-time or near real-time.

Live digital objects may use a document interface, yielding live digital documents, or live documents. Live digital documents may pull data from multiple model files. Preliminary design reviews may thus take the form of a live digital document.

Live digital objects may also use a dashboard interface, yielding live digital boards, or live boards. In some embodiments, a live digital board may display one or more documents and one or more applications on a two-dimensional (2D) screen rendered on a modality of a multimodal interface such as a 2D display, a two-and-a-half-dimensional (2.5D) display, and a three-dimensional (3D) semi-immersive or fully immersive display. Live digital boards may combine multiple documents through a VR/AR and/or conversational interface, into a board/screen 2D, 2.5D format. For example, a live board may combine multiple model files from a CAD software with collaboration chat rooms over a 2D screen rendered on a 2D display (traditional display), a 2.5D display, or a 3D semi immersive or fully immersive display. In one embodiment, the live board combines multiple view screens.

Finally, a live digital object may take the form of a live digital space (or live space), a 3D virtual environment or an augmented environment. In some embodiments, a live digital space displays one or more documents and one or more other applications in a virtual space rendered through a 3D spatial display. Live digital spaces may combine multiple documents through VR/AR and/or conversational interfaces into a 3D spatial representation. For example, a live space may display multiple 3D model files from a CAD software with collaboration chat rooms over a 3D semi immersive or fully immersive display spatial display.

Live digital objects may be stored and accessed through an IDMP. Specifically, live digital objects may be used to provide the background context for a given digital thread, and may specifically be used to display and organize a digital thread's associated artifacts, as described herein.

Live digital objects may hence be known as magic objects (i.e., live documents may be denoted “magic documents”, live boards may be denoted “magic boards”, and live spaces may be denoted “magic spaces”) as changes implemented within a twin configuration (e.g., through a modification of a model file) may appear instantaneously within the relevant data fields of the live digital objects. Similarly, authoritative/trusted live digital objects may also be known as authoritative/trusted magic objects as they continuously reflect data from the authoritative twin, thus always representing the authoritative source of truth.

Given the massive quantities of data and potential modifications that are carried out during a product's lifecycle, the scripts implementing live digital objects may be configured to allow for a predefined maximum delay between the modification of a model file (e.g., the modification of a digital artifact) and the execution of the corresponding changes within a live digital object. Moreover, for similar reasons, the scripts implementing live digital objects may be restricted to operate over a specified subset of model files within a DTw or a system, thus reflecting changes only to key parameters and configurations of the DTw or the system.

The “printing” of a live digital document or board corresponds to the generation of a frozen (i.e., static) time-stamped version of a live digital document or board. Therefore, “printing”—for a live digital document or board—is equivalent to “instantiation” for a digital twin. Similarly, the “printing” of a live digital space may also be envisaged, yielding a frozen 3D representation of a given system or digital thread.

In one embodiment of the present invention, an IDMP script (e.g., an IDEP application) having access to model data via one or more model splices and digital document templates to create and/or update a live digital object may dynamically update the live digital object using software-defined digital threads over an IDMP platform. In such an embodiment, the IDMP script may receive user interactions dynamically. In response to the user updating data for a model and/or a specific parameter setting, the IDMP script may dynamically propagate the user's updates into the digital object through a corresponding digital thread.

In another embodiment of the present invention, an IDMP script may instantiate a digital object with sufficient specification to generate a physical twin (PTw). In such an embodiment, the IDMP script may receive a digital twin configuration of a physical twin, generate a live digital object associated with the digital twin configuration, receive a predetermined timestamp, and generate a printed digital object (i.e., a static, time-stamped version of the live digital object at the predetermined timestamp). Such an operation may be referred to as the “printing of a digital twin”.

In yet another embodiment of the present invention, an IDMP script may instantiate (i.e., “print”) a digital object specifying an updated digital twin upon detecting the update. In such an embodiment, the IDMP script may detect a modification of a digital model or an associated digital thread. In response to detecting the modification, the IDMP script may update relevant data fields and sections of the live digital object based on the detected modification, and generate an updated printed digital object with the updated relevant data fields and sections based on the always-updated live digital object.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, In one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent, is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

FIG. 2 shows an exemplary implementation of the IDEP as an interconnected digital engineering (DE) and certification ecosystem 200, and exemplary digitally certified products, in accordance with some embodiments of the present invention. Interconnected DE and certification ecosystem 200 may be viewed as a particular instantiation or implementation of IDEP 100 shown in FIG. 1. The IDEP may also be referred to as a “DE Metaverse.”

Interconnected DE and certification ecosystem 200 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 200 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 2 shows an example of an interconnected DE and certification ecosystem and examples of digitally certified products 212A, 212B, and 212C (collectively referred to as digitally certified products 212). For example, in some implementations, digitally certified product 212A may be an unmanned aerial vehicle (UAV) or other aircraft, digitally certified product 212B may be a drug or other chemical or biologic compound, and the digitally certified product 212C may be a process such as a manufacturing process. In general, the digitally certified products 212 can include any product, process, or solution that can be developed, tested, or certified (partially or entirely) using DE tools such as 202. In some implementations, digitally certified products 212 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 212 in FIG. 2 may be designed and/or certified using interconnected DE and certification ecosystem 200. Interconnected DE and certification ecosystem 200 may include a user device 206A, API 206B, or other similar human-to-machine, or machine-to-machine communication interfaces operated by a user. A user may be a human 204 of various skill levels, or artificial users such as algorithms, artificial intelligence, or other software that interface with ecosystem 200 through API 206B. Ecosystem 200 may further comprise a computing and control system 208 (“computing system 208” hereinafter) connected to and/or including a data storage unit 218, an artificial intelligence (AI) engine 220, and an application and service layer 222. In some embodiments, the artificial intelligence (AI) engine 220 is a machine learning (ML) engine. References to “machine learning engine 220” or “ML engine 220” may be extended to artificial intelligence (AI) engine 220 more generally. For the purposes of clarity, any user selected from various potential human or artificial users is referred to herein simply as the user 204. In some implementations, computing system 208 may be a centralized computing system; in some implementations, computing system 208 may be a distributed computing system. In some cases, user 204 may be considered part of ecosystem 200, while in other implementations, user 204 may be considered separately from ecosystem 200. Ecosystem 200 may include one or more DE tools 202, such as data analysis tool 202A, computer-aided design (CAD) and finite element analysis (FEA) tool 202B, simulation tool 202C, drug modeling and simulation (M&S) tools 202D-202E, manufacturing M&S tools 202F-202G, etc. Ecosystem 200 may also include a repository of common V&V products 210, such as regulatory standards 210A-210F related to the development and certification of a UAV, medical standard 210G (e.g., CE marking (Europe), FCC Declaration of Conformity (USA), IECEE CB Scheme (Europe, North America, parts of Asia & Australia), CDSCO (India), FDA (USA), etc.), medical certification regulation 210H (e.g., ISO 13485, ISO 14971, ISO 9001, ISO 62304, ISO 10993, ISO 15223, ISO 11135, ISO 11137, ISO 11607, IEC 60601, etc.), manufacturing standard 210I (e.g., ISO 9001, ISO 9013, ISO 10204, EN 1090, ISO 14004, etc.), and manufacturing certification regulation 210J (e.g., General Certification of Conformity (GCC), etc.), etc.

In FIG. 2, computing system 208 is centrally disposed within the architecture and is configured to communicate with (e.g., receive data from and transmit data to) user device 206A or API 206B such as an API associated with an artificial user, DE tools 202 via an API or software development kit (SDK) 214, and repository of common V&V products 210 via an API/SDK interface 216. For example, computing system 208 may be configured to communicate with user device 206A and/or API 206B to send or receive data corresponding to a prototype of a design, information about a user (e.g., user credentials), engineering-related inputs/outputs associated with DE tools 202, digitized common V&V products, an evaluation of a product design, user instructions (e.g., search requests, data processing instructions, etc.), and more. Computing system 208 may also be configured to communicate with one or more DE tools 202 to send engineering-related inputs for executing analyses, models, simulations, tests, etc., and to receive engineering-related outputs associated with the results. Computing system 208 may also be configured to communicate with repository of common V&V products 210 to retrieve data corresponding to one or more digitized common V&V products 210 and/or upload new common V&V products, such as those received from user 204, to repository of common V&V products 210. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 208 may process and/or store the data that it receives to perform analysis and control functionalities, and in some implementations, may access machine learning engine 220 and/or application and service layer 222, to identify useful insights based on the data, as further described herein. The central disposition of computing system 208 within the architecture of the ecosystem has many advantages including reducing the technical complexity of integrating the various DE tools; improving the product development experience of user 204; intelligently connecting common V&V products such as standards 210A-210F to DE tools 202 most useful for satisfying requirements associated with the common V&V products; and enabling the monitoring, storing, and analysis of the various data that flows between the elements of the ecosystem throughout the product development process. In some implementations, the data flowing through and potentially stored by the computing system 208 can also be auditable to prevent a security breach, to perform data quality control, etc. Similarly, any analysis and control functions performed via computing system 208 may be tracked for auditability and traceability considerations.

Referring to one particular example shown in FIG. 2, user 204 may use the DE and certification ecosystem to produce a digitally certified UAV 212B. For example, user 204 may be primarily concerned with certifying the UAV as satisfying the requirements of a particular regulatory standard 210E relating to failure conditions of the UAV (e.g., “MIL-HDBK 516C 4.1.4—Failure Conditions”). In this usage scenario, user 204 may develop a digital prototype of the UAV on user device 206A or using API 206B and may transmit prototype data (e.g., as at least one of a CAD file, a MBSE file, etc.) to computing system 208. Along with the prototype data, user 204 can transmit, via user device 206A, additional data including an indication of the common V&V product that user 204 is interested in certifying the product for (e.g., regulatory standard 210E), user credential information for accessing one or more capabilities of computing system 208, and/or instructions for running one or more digital models, tests, and/or simulations using a subset of DE tools 202.

Referring to another example shown in FIG. 2, user 204 can use the DE and certification ecosystem to produce a digitally certified drug, chemical compound, or biologic 212A. For example, user 204 may be primarily concerned with certifying drug, chemical compound, or biologic 212A as satisfying the requirements of a particular medical standard 210G and medical certification regulation 210H. In this usage scenario, user 204 can develop a digital prototype of the drug, chemical compound, or biologic on user device 206A or using API 206B and can transmit the prototype data (e.g., as a molecular modeling file) to computing system 208. Along with the prototype data, user 204 can transmit, via user device 206A, additional data including an indication of the common V&V products that user 204 is interested in certifying the product for (e.g., medical standard 210G and medical certification regulation 210H), user credential information for accessing one or more capabilities of computing system 208, and/or instructions for running one or more digital models, tests, and/or simulations using a subset of DE tools 202 (e.g., drug M&S tools 202D-202E).

Referring to yet another example shown in FIG. 2, user 204 can use the digital engineering and certification ecosystem to produce a digitally certified manufacturing process 212C. For example, user 204 may be primarily concerned with certifying manufacturing process 212C as satisfying the requirements of a particular manufacturing standard 210I and manufacturing certification regulation 210J. In this usage scenario, user 204 can develop a digital prototype of the manufacturing process on user device 206A or using API 206B and can transmit the prototype data to computing system 208. Along with the prototype data, user 204 can transmit, via the user device 206A, additional data including an indication of the common V&V products that user 204 is interested in certifying the process for (e.g., manufacturing standard 210I and manufacturing certification regulation 210J), user credential information for accessing one or more capabilities of computing system 208, and/or instructions for running one or more digital models, tests, and/or simulations using a subset of DE tools 202 (e.g., manufacturing M&S tools 202F-202G).

In any of the aforementioned examples, computing system 208 can receive the data transmitted from user device 206A and/or API 206B and can process the data to evaluate whether the common V&V product of interest (e.g., regulatory standard 210E, medical standard 210G, medical certification regulation 210H, manufacturing standard 210I, manufacturing certification regulation 210J, etc.) is satisfied by the user's digital prototype, in the context of analysis and control plane 150 shown in FIG. 1. For example, this can involve communicating with the repository of common V&V products 210 via the API/SDK 216 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 210 can be hosted by a regulatory and/or certification authority (or another third party), and retrieving the regulatory and/or certification data can involve using API/SDK 216 to interface with one or more data resources maintained by the regulatory and/or certification authority (or another third party). In some implementations, the regulatory and/or certification data can be provided directly by user 204 via user device 206A and/or API 206B (e.g., along with the prototype data).

Evaluating whether the common V&V product of interest is satisfied by the user's digital prototype can also involve processing the prototype data received from user device 206A or API 206B to determine if the one or more identified requirements are actually satisfied. In some implementations, computing system 208 can include one or more plugins, local applications, etc., to process the prototype data directly at the computing system 208. For example, model splicing and digital threading applications are discussed in detail later with reference to FIGS. 6 to 9. In some implementations, the computing system can simply pre-process the received prototype data (e.g., to derive inputs for DE tools 202) and can then transmit instructions and/or input data to a subset of DE tools 202 via API/SDK 214 for further processing.

Not all DE tools 202 are necessarily required for the satisfaction of particular regulatory and/or certification standards. Therefore, in the UAV example provided in FIG. 2, computing system 208 may determine that only a data analysis tool 202A and a finite element analysis tool 202B are required to satisfy regulatory standard 210E for failure conditions. In the drug, chemical compound, or biologic example provided in FIG. 2, computing system 208 may determine that only drug M&S tools 202D-202E are required to satisfy medical standard 210G and medical certification regulation 210H. In the manufacturing process example provided in FIG. 2, computing system 208 may determine that only manufacturing M&S tools 202F-202G are required to satisfy manufacturing standard 210I and manufacturing certification regulation 210J. In other implementations, user 204 may themselves identify the particular subset of DE tools 202 that should be used to satisfy the common V&V product of interest, provided that user 204 is a qualified subject matter expert (SME). In other implementations, user 204 may input to computing system 208 some suggested DE tools 202 to satisfy a common V&V product of interest, and computing system 208 can recommend to user 204 a modified subset of DE tools 202 for final approval by user 204, provided that user 204 is a qualified SME. After a subset of DE tools 202 has been identified, computing system 208 can then transmit instructions and/or input data to the identified subset of DE tools 202 to run one or more models, tests, and/or simulations. The results (or “engineering-related data outputs” or “digital artifacts”) of these models, tests, and/or simulations can be transmitted back and received at computing system 208.

In still other implementations, user 204 may input a required DE tool such as 202F for meeting a common V&V product 210I, and the computing system 208 can determine that another DE tool such as 102G is also required to satisfy common V&V product 210I. The computing system can then transmit instructions and/or input data to both DE tools (e.g., 202F and 202G), and the outputs of these DE tools can be transmitted and received at computing system 208. In some cases, the input data submitted to one of the DE tools (e.g., 202G) can be derived (e.g., by computing system 208) from the output of another of the DE tools (e.g., 202F).

After receiving engineering-related data outputs or digital artifacts from DE tools 202, computing system 208 can then process the received engineering-related data outputs to evaluate whether or not the requirements identified in the common V&V product of interest (e.g., regulatory standard 210E, medical standard 2110G, medical certification regulation 210H, manufacturing standard 210I, manufacturing certification regulation 210J, etc.) are satisfied. For example, applications and services 222 may provide instructions for orchestrating validation or verification activities. In some implementations, computing system 208 can generate a report summarizing the results of the evaluation and can transmit the report to device 206A or API 206B for review by user 204. If all of the requirements are satisfied, then the prototype can be certified, resulting in digitally certified product 212 (e.g., digitally certified drug, chemical compound, or biologic 212A; digitally certified UAV 212B; digitally certified manufacturing process 212C, etc.). However, if some of the regulatory requirements are not satisfied, then additional steps may need to be taken by user 204 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 202, computing systems 208 may provide user 204 with a report recommending partial certification, compliance, or fulfillment of a subset of the common V&V products (e.g., digital certification of a subsystem or a sub-process of the prototype). The process of generating recommendations for user 204 is described in further detail below.

In response to reviewing the report, user 204 can make design changes to the digital prototype locally and/or can send one or more instructions to computing system 208 via user device 206A or API 206B. These instructions can include, for example, instructions for computing system 208 to re-evaluate an updated prototype design, use one or more different DE tools 202 for the evaluation process, and/or modify the inputs to DE tools 202. Computing system 208 can, in turn, receive the user instructions, perform one or more additional data manipulations in accordance with these instructions, and provide user 204 with an updated report. Through this iterative process, user 204 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 202, computing system 208 may provide user 204 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 208 within the architecture of the ecosystem enables computing system 208 to monitor and store the various data flows through the ecosystem. Thus, as an increasing number of users utilize the ecosystem for digital product development, data associated with each use of the ecosystem can be stored (e.g., in storage 218), traced (e.g., with metadata), and analyzed to yield various insights, which can be used to further automate the digital product development process and to make the digital product development process easier to navigate for non-subject matter experts.

Indeed, in some implementations, user credentials for user 204 can be indicative of the skill level of user 204, and can control the amount of automated assistance the user is provided. For example, non-subject matter experts may only be allowed to utilize the ecosystem to browse pre-made designs and/or solutions, to use DE tools 202 with certain default parameters, and/or to follow a predetermined workflow with automated assistance directing user 204 through the product development process. Meanwhile, more skilled users may still be provided with automated assistance, but may be provided with more opportunities to override default or suggested workflows and settings.

In some implementations, computing system 208 can host applications and services 222 that automate or partially automate components of common V&V products; expected or common data transmissions, including components of data transmissions, from user 204; expected or common interfaces and/or data exchanges, including components of interfaces, between various DE tools 202; expected or common interfaces and/or data exchanges, including components of interfaces, with machine learning (ML) models implemented on computing system 208 (e.g., models trained and/or implemented by the ML engine 220); and expected or common interfaces and/or data exchanges between the applications and services themselves (e.g., within applications and services layer 222).

In some implementations, the data from multiple uses of the ecosystem (or a portion of said data) can be aggregated to develop a training dataset. For example, usage records 217 collected via computing system 208 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 202 that should be used to satisfy a common V&V product of interest.

This training dataset can then be used to train ML models (e.g., using ML engine 220) to learn the steps and actions for certification processes and to perform a variety of tasks including the identification of which of DE tools 202 to use to satisfy a particular common V&V product; the identification of specific models, tests, and/or simulations (including inputs to them) that should be performed using DE tools 202; the identification of the common V&V products that need to be considered for a product of a particular type; the identification of one or more recommended actions for user 204 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 202) based on previously entered inputs, forecasting time and cost requirements for developing a product, predictively estimating the results of sensitivity analyses, and even suggesting design changes, original designs or design alternatives (e.g., via assistive or generative AI) to a user's prototype to overcome one or more requirements (e.g., regulatory and/or certification requirements) associated with a common V&V product. In some implementations, with enough training data, ML engine 220 may generate new designs, models, simulations, tests, common V&V products and/or digital threads on its own based on data collected from multiple uses of the ecosystem. Furthermore, such new designs, models, simulations, tests, common V&V products and digital threads generated by ML engine 220, once approved and adjusted by a user, may be added to the training set for further fine-tuning of ML algorithms in a reinforcement learning setup.

As shall be discussed in the context of FIGS. 7 to 9, the aforementioned collection of training datasets and the training of ML and AI modules including ML engine 220 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 2, ML engine 220 may manage or orchestrate the interactions between spliced DE models, DE tools, and common V&V products (e.g., DE requirements), based on digital thread options specific to user's intent and input. Sample DE tasks that may be carried out by ML engine 220 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 220 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 218) to enable users to search for and build upon the work of others. For example, previously designed components, systems, models, simulations and/or other engineering representations thereof can be searched for by user 204 and/or suggested to user 204 by computing system 208 in order to satisfy one or more requirements associated with a common V&V product. The previously designed components, systems, models, simulations and/or other engineering representations thereof can be utilized by user 204 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 204 can be checked by computing system 208 to determine which designs and/or solutions stored in the repository can be accessed by user 204. In some implementations, usage of the previously designed components, systems, models, simulations and/or other engineering representations thereof may be available only to other users who pay a fee for a usage.

Exemplary IDEP Implementation Architecture with Services and Features

FIG. 3 shows another exemplary implementation of the IDEP illustrating its offered services and features, in accordance with some embodiments of the present invention. Specifically, an exemplary implementation architecture diagram 300 is shown in FIG. 3 to include multiple illustrative components: an IDEP enclave 302, cloud services 304, and a customer environment 310 which optionally includes an IDEP exclave 316. This exemplary architecture 300 for the IDEP is designed in accordance with zero-trust security principles and is further designed to support scalability as well as robust and resilient operations. IDEP enclave 302 and IDEP exclave 316 together instantiate IDEP 100 shown in FIG. 1, with IDEP exclave 316 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 302 may serve as a starting point for services rendered by the IDEP, and may be visualized as a central command and control hub responsible for the management and orchestration of all platform operations. For example, enclave 302 may be implemented using computer system 208 of the interconnected DE and certification ecosystem shown in FIG. 2. DE platform enclave 302 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 302 also supports an ML engine such as 220 for real-time analytics, auto-scaling features for workload adaptability, and API-based interoperability with third-party services. Security and resource optimization are enhanced through multi-tenancy support, role-based access control, and data encryption both at rest and in transit. DE platform enclave 302 may also include one or more of the features described below.

First, IDEP enclave 302 may be designed in accordance with zero-trust security principles. In particular, DE platform enclave 302 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 302 can also be designed to maintain isolation and independence. A key aspect of the enclave's architecture is its focus on impartiality and isolation. DE enclave 302 disallows cryptographic dependencies from external enclaves and enforces strong isolation policies. The enclave's design also allows for both single-tenant and multi-tenant configurations, further strengthening data and process isolation between customers 306 (e.g., users 204). Additionally, DE enclave 302 is designed with decoupled resource sets, minimizing interdependencies and thereby promoting system efficiency and autonomy.

IDEP enclave 302 can further be designed for scalability and adaptability, aligning well with varying operational requirements. For example, the enclave 302 can incorporate hyperscale-like properties in conjunction with zero-trust principles to enable scalable growth and to handle high-performance workloads effectively.

IDEP enclave 302 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 300's adaptability makes it highly versatile for a multitude of use-cases, while ensuring consistent performance and robust security.

IDEP enclave 302 can further be designed to enable analytics for robust platform operations. At the core of the enclave's operational efficiency is a machine learning engine (e.g., machine learning engine 220) capable of performing real-time analytics. This enhances decision-making and operational efficiency across platform 300. Auto-scaling mechanisms can also be included to enable dynamic resource allocation based on workload demand, further adding to the platform's responsiveness and efficiency.

In the exemplary embodiment shown in FIG. 3, IDEP enclave 302 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 300 to ensure good service delivery, including advanced machine learning capabilities for real-time analytics. A “Search Service Cell” provides “Search Service” to aid in the efficient retrieval of information from DE platform 300, adding to its overall functionality. A “Logging Service Cell” and a “Control Plane Service Cell” provide “Logging Service,” “File Service”, and “Job Service” to record and manage operational events and information flow within platform 300, and are instrumental in the functioning of platform 300. A “Static Assets Service Cell,” provides “Statics Service”, and may house user interface, SDKs, command line interface (CLI), and documentation for platform 300. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 316 to provide splice functions for model splicing purposes.

As shown in FIG. 3, the architecture of DE platform 300 may also include a cloud services 304 that provide services which cannot interact with customer data but can modify the software for the orchestration of DE platform operations. In example implementations, several cloud resources provide support and foundational services to the platform. For example, in the embodiment of the DE platform 300 shown in FIG. 3, cloud services 304 includes a “Customer Identity and Access Management (IAM) Service” that ensures secure and controlled access to platform 300. Cloud services 304 also includes a “Test Service” that tests tools to validate platform operations. In the context of software testing, the Test Service can be thought of as the execution layer that manages and orchestrates the different types of tests on the platform. The Test Service may utilize the test scripts generated, and additionally has functionality to generate tests for specific UI or API level testing. Cloud services 304 may also include an “Orchestration Service” that controls and manages the lifecycle of containers on the platform 300. Cloud services 304 may also include an “Artifact Service” and “Version Control and Build Services,” which may be used to maintain the evolution of projects, codes, and instances in the system, while also managing artifacts produced during the product development process.

As shown in FIG. 3, the architecture of DE platform 300 may also include a customer environment 310 with an “Authoritative Source of Truth” 312, customer tools 314, and an optional DE platform exclave 316. Customer environment 310 is where customer data resides and is processed in a zero-trust manner by DE platform 300. As described previously, DE platform enclave 302, by focusing on both zero-trust principles and hyperscale-like properties, provides a robust and scalable environment for the secure processing of significant workloads, according to the customer's unique needs. In some examples, DE platform exclave 316 may be situated within customer environment 310 in order to assist the customer(s) 306 with their DE tasks and operations, including model splicing and digital threading.

When a customer 306 (e.g., user 204) intends to perform a DE task using DE platform 300 (e.g., IDEP 100), typical operations may include secure data ingestion and controlled data retrieval. Derivative data generated through the DE operations, such as updated digital model files or revisions to digital model parameters, may be stored only within customer environment 310, and DE platform 300 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 310 through a pre-validated secure tunnel, such as Secure Socket Layer (SSL) tunnel. This can enable direct and secure file transfer to a designated cloud storage, such as a simple storage service (S3) bucket, within customer environment 310. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 310 while adhering to zero-trust security protocols. Example implementations may also include tokenization utility, in which a specialized DE platform tool referred to as a “tokenizer” is deployed within customer environment 310 for secure management of derivative metadata, conforming to zero-trust guidelines.

Customer environment 310 may interact with other elements of secure DE platform 300 and includes multiple features that handle data storage and secure interactions with platform 300. For example, one element of the customer environment 310 is “Authoritative Source of Truth” 312, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 310 while providing smooth interactions with other elements of DE platform 300.

Customer environment 310 may also include additional software tools such as customer tools 314 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 310 and elements of DE platform 300. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 310, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 316 may be employed within customer environment 310 to assist with customer DE tasks and operations, supervise data processing, and rigorously adhering to zero-trust principles while delivering hyperscale-like platform performance. IDEP exclave 316 is maintained by the IDEP to run DE tools for customers who need such services. IDEP exclave 316 may contain a “DE Tool Host” that runs DE tools and a “DE Platform Agent” necessary for the operation. Again, native DE tools are typically access-restricted by proprietary licenses and end-user license agreements paid for by the customer. IDEP exclave 316 utilities and manages proprietary DE tools hosted with customer environment 310, for example, to implement model splicing and digital threading functionalities.

In some embodiments, the machine learning (ML) models and artificial intelligence (AI) assistance approaches as described herein adapt to suit different customer instances of the IDEP (see FIG. 4) and the availability of training data. In an example, a pre-trained ML or AI model (e.g., within the IDEP enclave 302) is deployed in instances where there are restrictions around sharing customer data. In another example, AI models are deployed in a federated manner adjacent to DE agents and DE tools in the customer environment (e.g., within IDEP exclave 316). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 4 shows potential scenarios for instantiating an IDEP in connection to a customer's physical system and IT environment, in accordance with some embodiments of the present invention. Specifically, FIG. 4 illustrates various potential configurations for instancing or instantiating an IDEP (“DE platform) 402 in connection to a customer's IT environment and physical system 404. The IT environment may be located on a virtual private cloud (VPC) protected by a firewall. The physical system may refer to a physical twin as discussed with reference to FIG. 1. In some embodiments, IDEP 402 may be instanced as an enclave such as 302 shown in FIG. 3. For example, IDEP 402 may be instanced on the cloud, possibly in a software-as-a-service (SaaS) configuration. The platform instances in these embodiments include software and algorithms, and may be described as follows:
1. External Platform Instance 410: This option showcases the IDEP as a separate platform instance. The platform interacts with the physical system through the customer's virtual environment, or a Customer Virtual Private Cloud (“Customer VPC”), which is connected to the physical system.
2. External Platform Instance with Internal Agent 420: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 430: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 440: This option shows the DE platform linked directly to an DE edge instance on the physical system. The DE platform and the physical system are depicted separately, connected by an edge computing instance in the middle, indicating the flow of data.
5. Direct API Connection 450: This deployment scenario shows the DE platform connecting directly to the physical system via API calls. In this depiction, an arrow extends directly from the platform sphere to the physical system sphere, signifying a direct interaction through API.
6. Air-Gapped Platform Instance 460: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 5 illustrates the use of multimodal user interfaces 590 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 502 and 504 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 5 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 594, a workflow-based interface 596, conversational interfaces 598, spatial computer interfaces 592, and code interfaces 599.

Dashboard-style interface 594 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 596 guides users through the decision-making process, presenting relevant data, options, and contextual information at each stage. It integrates external feedback and is designed as a progressive web app or a mobile app. In the context of alternative tool selection, workflow-based interface 596 may provide options on individual tools at each stage, or provide combinations of tool selections through various stages to achieve better accuracy or efficiency for the overall workflow.

Conversational interfaces 598 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

According to the latest prior art, a “conversational interface” or “conversational user interface” refers to a human-computer interaction model that enables users to interact with digital systems through natural language, either via text or voice. These interfaces utilize advanced natural language processing (NLP), machine learning, and artificial intelligence technologies to understand and respond to user inputs in a manner that mimics human conversation. Conversational interfaces can take various forms, including chatbots, voice assistants, and messaging platforms, allowing users to communicate with systems using everyday language rather than traditional graphical user interface elements. The goal of these interfaces is to provide a more intuitive, accessible, and personalized user experience by leveraging the familiar paradigm of conversation, enabling users to accomplish tasks, retrieve information, or control devices through natural dialogue without requiring specialized knowledge of complex commands or navigation structures.

FIG. 5 also illustrates the use of spatial computing interfaces 592 and code interfaces 599 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

A “spatial interface” or “spatial user interface” refers to a user interaction paradigm that leverages three-dimensional space and spatial relationships to present and manipulate digital information. This approach goes beyond traditional 2D graphical user interfaces by incorporating depth, volume, and spatial positioning to create more intuitive and immersive user experiences. Spatial interfaces often utilize technologies such as augmented reality (AR), virtual reality (VR), or mixed reality (MR) to overlay digital content onto the physical world or create entirely virtual environments. These interfaces allow users to interact with digital objects and information as if they were physical entities in space, using natural gestures, body movements, direction of audio or eye gaze, and spatial awareness to navigate, manipulate, and organize content in ways that more closely mimic real-world interactions.

Note that in the context of multimodal interfaces, “2.5 dimension” (often referred to as 2.5D) describes a visual representation that falls between traditional 2D and full 3D interfaces. It typically involves adding depth and perspective to 2D elements to create a pseudo-3D effect, without fully rendering a complete 3D environment. The 2.5D approach is typically designed to create the illusion of depth and dimensionality on flat, two-dimensional displays such as computer monitors, smartphone screens, or tablets, although it may be used within a 3D setting (e.g., 2D screens overlaid into 3D). This approach often uses techniques such as layering, parallax scrolling, or isometric projections to give the illusion of depth and volume while maintaining the simplicity and familiarity of 2D interfaces.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 6 describes the architecture and inherent complexity of digital threads, in accordance with the examples disclosed herein. Specifically, FIG. 6 is a schematic diagram comparing exemplary digital threads 600 of various complexities that manipulate and/or connect DE models, in accordance with some embodiments of the present invention. In the most basic sense, a digital thread may “thread” together DE models into a simple daisy-chain architecture 602 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 604 represents a more complex digital thread where a change in one DE model may affect more than one downstream model. In both 602 and 604, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 604, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 606 is a partial representation of a real-world digital thread, illustrating the complexity of digital threads and its multiplicative growth.

FIG. 6 further shows special cases 603, 605, 607, 608, and 609 of exemplary simple digital threads. Diagram 607 represents a degenerate digital thread where data is shared from a single DE model. Diagram 608 represents a model-to-document digital thread where data (e.g., system attributes, performance attributes) extracted from a single DE model may be used to generate or update a text-based document (e.g., a Capability Development Document (CDD)). Diagrams 603 and 605 are generalized from 608 to represent cases where data extracted from a single model may be used to update multiple models, or vice versa. Specifically, diagram 605 may represent the dynamic updates of live or magic documents discussed in the context of FIG. 1. Here, the logic to connect the DE models shown is clear: data are extracted from multiple DE models A, B, and C to update a document model D. There are no interactions between the extracted data. Furthermore, diagram 609 shows a special case of a digital thread where data is loaded to and extracted from only a single model A. For example, as discussed in the context of FIG. 7 next, input splice functions of the model A shown in 609 may be executed to update the model, and output splice functions of model A shown in 609 may be executed to produce digital artifacts for sharing. For these special simple threads, the IDEP may provide a GUI-based interface to the user to connect the models and execute the digital threads. For complex threads such as 606, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 7 is a schematic 700 showing an exemplary model splicing setup, according to some embodiments of the present invention. Specifically, FIG. 7 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 7, a CAD model file diesel-engine .prt 704 proceeds through a model splicing process 710 that comprises a data extraction step 720 and a splice function generation step 730. This input DE model 704 is in a file format .prt native to certain DE tools. Data extraction may be performed via a DE model crawling agent implemented as model crawling scripts within a model splicer to crawl through the input DE model file and to distill model data with metadata 722. Metadata are data that can be viewed without opening the entire input DE model file, and may include entries such as file name, file size, file version, last modified date and time, and potential user input options as identified from a user input 706. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 702 that is being used in splicing the DE model, and establishes a model data schema. This data schema describes the structure and format of the model data, some of which are translated into, or used to create input/output API endpoints with corresponding input/output schemas. In some embodiments, model data with metadata 722 may be stored in an access-restricted storage 726, such as the “customer buckets” 312 within customer environment 310 in FIG. 3, so that model splices such as 742, 744, and 746 may be generated on-demand once an input DE model 704 has been crawled through.

The model splicer further generates splice functions (e.g., API function scripts) 732 from native APIs 702 associated with the input CAD model. In the present disclosure, “native” and “primal” refer to existing DE model files, functions, and API libraries associated with specific third-party DE tools, including both proprietary and open-source ones. Native API 702 may be provided by a proprietary or open-source DE tool. For example, the model splicer may generate API function scripts that call upon native APIs of native DE tools to perform functions such as: HideParts(parts_list), Generate2DView( ), etc. These model-type-specific splice functions may be stored in a splice function database 736, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 702 of any native DE tool integrated into the IDEP, thus enabling engineers from different disciplines to interact with unfamiliar DE tools, and previously non-interoperable DE tools to interoperate freely.

Next, based on user input or desired user application 706, one or more model splices or wrappers 742, 744, and 746 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 722 and the API function scripts such as 732. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 733 are model modification scripts that allow updates or modifications to an input DE model. For example, a model update may comprise changes made via an input splice function to model parameters or configurations. “Output” splice functions or “output nodes” 734 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 726, or other similar access-restricted customer buckets.

One advantage of model splicing is its inherent minimal privileged access control capabilities for zero-trust implementations of the IDEP as disclosed herein. In various deployment scenarios discussed with reference to FIG. 4, and within the context of IDEP implementation architecture discussed with reference to FIG. 3, original DE input model 704 and model data storage 726 may be located within customer buckets 312 in customer environment 310 of FIG. 3. Splice functions 732 stored in database 736 call upon native APIs 702. The execution or invocation of splice functions 732 may rely on job-specific authentication or authorization via proprietary licenses of DE tools (e.g., residing within customer environment 310 of FIG. 3 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models Via Model Splicing

FIG. 8 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 8, an orchestration script 894 is written in Python code and designed to interact via API endpoints such as 892 to determine if a CAD model meets a total mass requirement. API endpoint 892 is an output splice function and part of a platform API 890. Platform API 890 comprises not only splice functions but also platform scripts or orchestration scripts such as 894 itself.

Orchestration script 894 is divided into three main steps:
1. Get Data From a CAD Model Splice: A POST request may be sent via the IDEP platform API to execute a computer-aided design (CAD) model splice 871. This model splice provides a uniform interface to modify and retrieve information about a CAD model 881. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 881, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 872. SysML is a general-purpose modeling language used for systems engineering. Output function 892 of model splice 872 retrieves the total mass requirements for the system from a SysML model 882. The response from the platform API includes the total mass requirement for the system. 3. Align the Variables and Check If Requirement Met: The total mass from CAD model 881 is compared with the total mass requirement from SysML model 882. If the two values are equal, a message is printed indicating that the CAD model aligns with the requirement. Otherwise, a message is printed indicating that the CAD model does not align with the requirement.

In short, orchestration script 894, which may be implemented in application plane 160 of IDEP 100 shown in FIG. 1, links digital models 881 and 882 via model splice API calls. Orchestration script 894 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 9 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 982 and 984, requires respective connections to a central platform 910, and potential additional linkages from every model to every other model. The central platform 910 comprises program code that is able to interpret and manipulate original DE models of distinct model types. For example, platform 910 under the control of a subject matter expert may prepare data from digital model 982 into formats that can be accessed by digital model 984 via digital model 984's native APIs, thus allowing modifications of digital model 982 to be propagated to digital model 984. Any feedback from digital model 984 to digital model 982 would require similar processing via platform 910 so that data from digital model 984 are converted into formats that can be accessed by digital model 982 via digital model 982's native APIs. This hub-and-spoke architecture 934 is not scalable to the sheer number (e.g., hundreds or thousands) of digital models involved within typical large-scale DE projects, as model updates and feedback are only possible through central platform 910.

In contrast, once the DE models are spliced, each original model is represented by a model splice including relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 6. Note that in FIG. 1, only a set of generated splices is shown within splice plane 170, while in FIG. 9, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 4. That is, individual API function scripts generated via model splicing by a DE platform agent may be tailored to call upon proprietary tools the customer has access to in its private environment. No centralized platform 910 with proprietary access to all native tools associated with all individual digital models shown in FIG. 9 is needed. Instead, orchestration scripts call upon platform API function scripts that may be implemented differently in different customer environments.

Hence, model splicing allows model splices such as model splice 972 from digital model 982 and model splice 974 from digital model 984 to access each other's data purposefully and directly, thus enabling the creation of a model-based “digital mesh” 944 via platform scripts and allowing autonomous linking without input from subject matter experts.

An added advantage of moving from the model plane 180 to the splice plane 170 is that the DE platform enables the creation of multiple splices per native model (e.g., see FIG. 7), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twinning capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 950 for the IDEP is shown on the right side of FIG. 9, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 10 shows an exemplary directed acyclic graph (DAG) representation 1000 of pipelined DE tasks related to digital threads, in accordance with some embodiments of the present invention. In diagram 1000, tasks performed through a digital thread orchestration script (e.g., 894) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 8, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

### Inner/Outer Loop Architecture for Digital Threads in Cyber-Physical Systems

FIG. 11 is an exemplary schematic 1100 illustrating the interplay between a digital thread and the individual digital models or digital artifacts it uses, thus defining outer and inner loop processes, in accordance with some embodiments of the present invention.

In various embodiments of the IDMP, the architecture for managing digital threads and their associated digital models in cyber-physical systems involves an interaction between an Outer Loop (representing the digital thread) and an Inner Loop (representing individual models or artifacts). This structure enables secure, permission-based collaboration across multiple models, ensuring traceability, controlled data flow, and efficient interaction within the digital workflow. Based on software engineering principles, this inner/outer loop design is modular: the Outer Loop manages high-level coordination and communication, while the Inner Loop handles the detailed, iterative operations of each model or system. While the Outer Loop and Inner Loop interactions commonly seen in software packages may involve access to all of the software packages within the same Integrated Development Environment (IDE), the Outer Loop/Inner Loop interactions for cyber-physical systems must manage to link interoperably with different digital models and tools, while also ensuring zero trust security. Various embodiments of the IDMP are well suited to manage such digital threads for cyber-physical systems as the platform is able to interoperably link with various digital models and tools (in different Inner Loops) through the model splicer architecture (see FIGS. 7 and 8). Additionally, the IDMP uses zero trust and zero knowledge security, ensuring that every interaction, whether within the same security network or across different networks, is strictly authorized, while keeping sensitive data private (e.g., through tokenization).

In the embodiment shown in 1110, an Outer Loop 1104 manages the sequence of tasks in a digital workflow, where user actions are authorized for access through a process 1120 in an Inner Loop 1116. Outer Loop 1104 can issue instructions to Inner Loop 1116 to:
Create models by defining structure, behavior, and parameters.
Fetch data artifacts from a model.
Update artifacts with controlled, traceable changes.

For example, when Outer Loop 1104 commands a data artifact retrieval, the IDMP platform may manage it using zero trust principles, as described in FIG. 3. Each user request in Outer Loop 1104 is authorized through an enclave 302 and its Control Plane service cell, coordinated with platform exclave 316. Different Inner Loops exist within Customer Tools 314, each operating in specific Customer Environments 310 where each request is authorized for access to the necessary data operations.

After retrieving data artifacts from Inner Loop 1116, Outer Loop 1104 handles configuration control 1106, versioning, and integrates the artifacts into the broader digital thread 1108 for testing or validation at a process step 1112.

Inner Loop 1116, by contrast, is responsible for localized operations related to individual digital models, including:
Model creation, where digital models are initialized or updated.
Model execution, through automation, simulations or data analysis.
Saving results, preserving outcomes from model runs.
Analyzing data, providing insights and validation for digital workflow improvements.

Outer Loop 1104 interacts with any step in Inner Loop 1116 to access or update data artifacts. Outer loop computations often compare the current workflow to a baseline 1110.

Outer and Inner Loops 1104 and 1116 work together in an iterative process, integrating localized model adjustments with system-wide digital workflow coordination and validation. The Outer Loop manages tasks like configuration control, system integration, and VVUQ (Verification, Validation, and Uncertainty Quantification), while the Inner Loop handles model-based operations. FIG. 11 shows the Outer Loop performing authorized access 1120, configuration control 1106, digital thread integration 1108, and VVUQ/testing 1112. In various implementations of digital threads in the IDMP, these steps can vary in sequence or iterate as needed. Ultimately, the outer and inner loop architecture enables continuous integration and development (CI/CD) of digital workflows and digital threads across the digital platform.

### Decentralized Digital Threads in the IDMP

The IDMP enables decentralized management of digital threads across different models, security networks, and user permissions under a zero trust security principle. This architecture enforces strict access controls and permission-based interactions between models, ensuring security across diverse environments. In some embodiments, a zero knowledge approach further secures sensitive data during orchestration, ensuring no unauthorized access (e.g., by using tokenization).

In FIG. 11, two exemplary setups 1122 and 1132 illustrate IDMP embodiments with decentralized digital threads across different security networks. In 1122, Outer Loop 1 operates within Security Network 1, connecting to multiple Inner Loops (e.g., Inner Loop 1, Inner Loop 2, and Inner Loop 3). These Inner Loops manage data operations within the same security framework, allowing collaboration while maintaining security.

In 1132, Outer Loop 2 operates in a separate Security Network 2, linking to additional Inner Loops (e.g., Inner Loop 4, Inner Loop 5, and Inner Loop 6). For links from Outer Loop 1, dotted lines and “X” symbols represent isolated models or components, indicating access restrictions enforced by the zero trust framework. Only authenticated users can access authorized models and artifacts.

In various implementations, 1122 and 1132 can be regarded as different instances of the Customer environment 310 shown in FIG. 3.

In the IDMP, digital threads handle both simple and complex model connections. FIG. 6 shows simple threads with sequential model links (e.g., 602, 604), while the more complex thread 606 is shown in FIG. 11 as an illustrative element 1142. Simple threads propagate changes in a linear fashion, while complex threads manage branching dependencies, where changes in one model affect multiple downstream models. In complex threads implemented by the IDMP, the Outer Loop coordinates interactions across multiple Outer loops and Inner loops, ensuring secure, scalable execution of the entire digital workflow with appropriate permission controls.

Converting Digital Workflows into Digital Threads with Data Relationships

The IDMP links different types of digital model files in a decentralized fashion with zero-trust security. When a user requests a data operation on a digital model file using a specific digital tool, IDMP executes the request via digital tool-specific and platform agents within the customer's environment. These agents extract data artifacts and, when changes to a digital artifact occur, a newer version of the digital model file is made. During the versioning step, platform agents ensure sensitive data is protected through tokenized version control.

Extracted data artifacts are securely stored in the customer's cloud data storage (e.g., an S3 bucket). If changes are made to the digital model, the agents save the updated version of the model or data artifact, extract the relevant data artifacts, and store it securely.

Using the IDMP, users are able to link data artifacts into a magic doc for documentation and commentary, which can include AI-assistance in various embodiments. A digital thread accompanying the magic doc lists data artifacts in sequence, creating a digital workflow. The IDMP further tracks data relationships between data artifacts (e.g., derivation, grouping, or data flow). This digital workflow of user actions and data relationships is stored in a non-proprietary format within the customer's environment.

Emergent digital workflows and sequence of tasks captured by data relationships of various types:
1. Generational—(Between version 1 and version 2 of a model)
2. Parent/Child—(The Model and Derived information from a model)
3. Sibling—(Different bits of derived data from the same model (e.g., an image view of a CAD model and an associated parameter)
4. Generational (derived)—The same piece of data extracted from version 1 or version 2 of a model
5. Data Context (Connected by how they are used for a mission or business purpose in a Magic Doc)
6. Data Flow (Connected via digital threads—data from one model into another)

Such data relationships can vary from one user to another even for the same overall digital workflow task.

Converting Digital Workflows into Digital Thread Scripts in an API-First Manner

FIG. 12 illustrates an exemplary digital engineering process in the aerospace industry, showing outer loop processes, according to one embodiment of the present invention. The left of FIG. 12 contains a simplified depiction 1202 of current engineering processes related to a digital engineering operation in the aerospace industry. The digital platform is instrumental in mapping those processes 1204 to digitized (software-defined) workflows. Each process step may be connected to software-defined digital threads (outer loop) using Git Workbooks or Runbooks. The generated workflows may belong to the inner or outer loops, as depicted in FIG. 11. For completeness and compliance, the digital platform may further add tests for the key steps and tasks of the digitized workflows in the outer loop 1206. These outer-loop threads incorporate built-in feature tests and unit tests, ensuring the digital thread is validated as it is being created. Finally, the scripts for the digital threads are executed, generating outputs that can be presented as dynamic reports, such as magic docs, linked to digital models or data artifacts. The digital platform may hence generate dynamic reports 1208 (e.g., Magic Docs) linked to the inner-loop models used by the digital workflows. In various implementations, the IDMP adopts an API-first approach, where digital workflows are structured around secure and modular API integrations. In the IDMP, digital threads link to specific data artifacts through authorized API endpoints in a zero-trust framework, ensuring secure access. Process steps are connected to software-defined workflows using tools like Git Workbooks or Runbooks, with user intent driving both platform and tool-specific API calls. This approach enables seamless integration, modularity, and validation, with built-in feature and unit tests ensuring the reliability of each API interaction throughout the system.

### Overview of Alternative Tool Selection

Broadly, the present invention relates to methods and systems for the optimization and enhancement of digital workflows by providing alternative digital tools to perform user-requested digital tasks, thus better balancing cost, compute power, error, and overall digital workflow performances.

Within the digital modeling framework including digital engineering (DE), users are restricted to specific native software environments with a limited selection of digital tools when working with digital model-type files. Nonetheless, for various digital tasks, there often exists a multitude of analogous digital tools capable of performing similar functions and completing similar digital tasks. Such tools range from proprietary commercial software to freely available open-source alternatives, thus providing a broad spectrum of options. Yet users are typically reluctant to switch or transition any part of their digital workflows to new tools for a variety of reasons. For instance, organizations may be tied to long-term commercial licenses, making a switch to a new tool financially unfeasible. The introduction of a new tool may necessitate a steep learning curve with significant time investments. Additional resources may also be needed to convert or reformat existing digital model type files when transitioning from a legacy tool to a newer alternative. Even the mere perception of a new tool requiring extensive user training or data preparation may lead to hesitation by a user or a team of users to seek alternatives.

Embodiments of the present invention provide a solution to these challenges by offering, within an interconnected digital model platform (IDMP), alternative tools for performing platform functions executed during the completion of digital tasks, which also generalize to digital workflows, thus broadening the range of digital tools available to users and alleviating the limitations imposed by native tools or native software environments. The IDMP as disclosed herein uses model splicing technologies and script generation to standardize and generalize digital model data and documentations, and to provide API interfaces and functions for fast evolving digital tools and digital model types. This standardization and generalization enable the access of model type files outside of their native software environments, allowing for interoperable linking of model type files, and facilitates the substitution of individual digital tool functions called within platform scripts by alternatives without interrupting the execution of a digital workflow. That is, the IDMP facilitates interoperability among different digital tools, and assists users in implementing their digital workflows, thereby enhancing efficiency and productivity.

Specifically, embodiments of the present invention are directed to alternative tool selection, a process that encompasses one or more of tool usage pattern and task history tracking, tool functionality and performance characteristic mapping and isomorphic analysis, alternative tool recommendation based on the digital task at hand and iterative user feedback, and token management to link selected alternative tools to execute and complete a requested digital task.

In this disclosure, a “tool,” “digital tool,” or “DE tool” refers to a software application, computer program, or script that is executable to generate an output from an input derived from at least one digital model type file. For example, the input may be a digital model file, a model splice of a digital model file, or one or more digital artifacts extracted or derived from a digital model file. A “tool function” refers to specific operations, capabilities, features, or methods provided by a digital tool. A digital tool comprises multiple tool functions.

Within the IDMP, a “platform function” represents platform capabilities that can be performed via the IDMP on digital models, model splices, and other digital artifacts or digital assets. Extending from the discussion of splice function scripts and digital thread orchestration scripts in the contexts of FIGS. 7 and 8, a platform function may be implemented in a scripting language as a platform script. A platform function may call upon other platform functions, including splice functions and digital thread orchestration scripts, each involving one or more different digital tools and each accomplishing a specific digital task or sub-task. Conversely, any script available and executable on the IDMP may be viewed as a platform function. A function variant is a version of a function tailored to operate in a specific context, such as within a particular operating system, using a third-party tool, using an open-source tool, or by data resource type.

Furthermore, while the terminology section of the present disclosure lists “digital workflow” and “tasks and process steps” as separate entries, within the framework of alternative tool selection, a digital task (e.g., written as a platform script) may represent a full digital workflow (e.g., written as a digital thread orchestration script, which is a type of platform script), and a digital workflow can be viewed as a workflow-task. That is, a digital task may comprise a series of sub-tasks each completed through different processes by different agents. Alternative tool suggestions may be made at a digital thread level for a workflow. Execution of a platform function (e.g., a digital thread) may include a sequence of steps or sub-tasks (e.g., each written as a platform script) to complete a digital workflow-task to achieve a specific outcome. Embodiments of the present invention enable the substitution of one digital tool by another without interrupting the digital workflow or compromising the performance of the digital workflow. As digital workflows are typically rather complex digital tasks involving multiple linked digital tools, in addition to alternative tools being suggested individually, in some embodiments, multiple alternative tools and tool functions may be suggested collectively for a specific workflow and its associated tools, where the sequence and inter-dependencies of tools and functions are central to achieving desired outcomes.

Digital tool functions, through the process of model splicing, are called upon to construct IDMP platform functions that implement or complete specific digital tasks. That is, by establishing connections with various digital model types via model files' API endpoints (e.g., model splice functions), the IDMP can leverage a resource-capability mapping to create its own platform API, defining distinct capabilities, or platform functions, for each specific resource (e.g. digital model types, digital tool functions). An alternative tool that is analogous or equivalent to an initial digital tool, when substituted into an IDMP platform function, completes the digital task and generates an output that is similar to the output produced by the initial digital tool. Two function outputs may be considered as similar or identical if they are within a given error tolerance. Overall performance of an alternative tool may be measured by one or more digital model-specific, digital tool-specific and/or digital task-specific criteria. Such criteria include but are not limited to, cost, accuracy, precision, speed, computational load, accessibility, and the like. To facilitate seamless tool substitution, the IDMP platform function may comprise a universal schema to support different variants of the IDMP function implemented with different digital tools respectively. For example, a function variant called upon in a digital thread script may be swapped out with an alternative one by updating the digital thread's pointers to function metadata.

Furthermore, exemplary system components of the IDMP for alternative digital tool selection include one or more of a user interface, a digital tool and task history database, an analysis engine for tool usage pattern tracking, a rule-based or ML-based tool comparator and recommender module, and a token management module.

In summary, the following exemplary features of the IDMP enables an alternative tool selection process. These features are for illustrative purposes only, and not meant to limit the scope of the invention.
1. Model Splicing-Enabled Interoperability of Digital Tools: digital model splicing enables the linking of different digital model type files that were not previously interoperable. This interoperability of digital model files in turn presents an opportunity for users to swap out specific digital tools (e.g., under license or owing to legacy reasons) to similar performant alternative tools in platform function scripts or platform scripts (e.g., splice function scripts, digital thread orchestration scripts) that manipulate or orchestrate model splices. This interoperability of digital tools then allows the integration of diverse alternative or equivalent tools into the IDMP to provide the user with more cost efficient or more precise options, especially in relatively mature fields such as modeling and simulation.
2. Isomorphic Analysis: isomorphism refers to the general concept of an invertible mapping between entities that preserves form, shape or structure among corresponding elements. In the context of alternative digital tool selection, an isomorphic analysis between different digital tools may map the tools' corresponding functionalities and performance characteristics to understand equivalences and potential substitutions. The IDMP may employ a combination of a tool catalog, resource-capability mapping, and task history for isomorphic analysis between pairs of digital tools, to identify isomorphic, equivalent, or similar tools that can perform the same or similar digital task. Isomorphic analysis may also be performed on task inputs/outputs within task history (such as an event log in an IDMP) to narrow tool choices.
3. Resource-Capability Mapping: the IDMP leverages a resource-capability map to create its own platform API, defining distinct capabilities, or platform functions, for each specific resource (e.g. digital model-type file, digital tool functions). Stored in a central database or distributively in IDMP module manifests, such a resource-capability mapping ensures alternative tools comply with the functional schema and metadata attributes of the original tool, enabling seamless integration and execution. In certain embodiments where the resource-capability map is distributively included in IDMP module manifests, the IDMP may additionally present a representative summary of resources and associated capabilities. Furthermore, the IDMP can dynamically filter and match tasks to platform functions based on their specific capabilities, and identify suitable platform functions and function variants for a given task, thus facilitating efficient and scalable task assignment and execution.
4. Platform Function Schema and Variants: a platform function schema outlines the fundamental parameters and operational constraints of the function, including metadata that specifies the function's purpose, inputs, outputs, and environmental requirements, such as compatible operating systems or tool versions. This metadata-driven schema approach provides platform functions with the flexibility to accommodate multiple isomorphic tools in respective platform function variants. A platform function variant is a specific instance of a platform function, tailored to a specific digital tool, configuration, or tool version. This platform function variant-based approach facilitates the scalable and seamless integration of alternative tools and digital models, enhancing the platform's adaptability and flexibility, and enabling the streamlined deployment of specialized tools and platform functions across diverse digital environments.
5. Recommendation Module: the IDMP may incorporate a rule-based expert system or an AI/ML-based tool comparator or recommender to suggest alternative digital tools, possibly based on input from a subject matter expert (SME) as well. This system may use a combination of isomorphic analysis, historical data, tool performance, task analysis, and user requirements to make comparisons and recommendations.
6. Idempotent Token Management: after an alternative digital tool is found, the IDMP may implement a requested digital task using the original/initial digital tool or the alternative digital tool. An idempotent token is a unique identifier, key, string, or data structure that tracks requests across services to ensure that each request is handled only once, and guarantees that performing the same operation multiple times has the same effect as performing it once. Idempotent token management may be employed to avoid duplicate task executions and to ensure that the transition to a new digital tool does not disrupt the workflow or lead to inconsistent results. In other words, this feature ensures that digital tasks can be consistently and reliably implemented with new digital tools without altering the outcome, hence maintaining consistency and reliability in the digital workflow.
7. Training Data for Digital Tool Usage Patterns: as user interacts with digital tools accessible through the IDMP, including user-specified digital tools and alternative digital tools recommended by the IDMP, user action data related to digital tool selection and usage patterns may be collected to train, refine, and further enhance the performance of the machine learning engine used in the recommendation module. Such digital tool usage patterns may include aggregated statistics that summarize how digital tools are used by different users for a given digital model type, a given digital task, or a given type of digital task, individual user preferences related to digital tool selection, as well as how individual users may navigate through the digital tool to complete the digital task. For example, a digital tool and task history database may comprise event logs that capture requested task, model-type file, tool ID, function name, parameter IDs, time stamp, user access tokens, etc. as part of each action in the event log. Some data from the event log may be masked. Tool usage pattern may then refer to the sequence of such digital tasks, and the associated mapping of digital tools to different digital tasks, with appropriate parameters or metadata. By learning from past usage patterns, the system may predict future tool requirements and optimize digital workflows accordingly. Tracking tool usage patterns not only improves the recommendation system but also potentially identifies new efficiencies and integrations. Furthermore, by tracking task history and tool usage across workflows, the platform may generate training data to inform future alternative tool selections, supporting decisions through data-driven insights based on criteria such as cost-effectiveness, reliability, and workflow alignment.
8. Scalability of Implementation Using Agents and Modules: agent-based and modular implementation of the IDMP facilitate the scalability of alternative tool selection. The IDMP may implement alternative tool selection through agents operating within its architecture. Agents installed on an exclave executes tasks assigned by a Jobs Service using dynamically installed modules. Modules are discrete collections of platform functions that can be run on digital models. Agents support multiple modules simultaneously, with each module providing specific functions and capabilities defined in its manifest. Agents maintain directories of installed modules with manifest files defining their capabilities, and register these capabilities with the platform enclave upon installation. This registration enables the enclave to maintain a dynamic mapping of agent capabilities, allowing the Jobs Service to optimize task assignments. Agents periodically communicate their status and capabilities to the enclave, ensuring real-time awareness of active agents and their readiness. The system dynamically matches tasks to agents based on specific capabilities, ensuring efficient allocation. Agents also feature lifecycle management capabilities for module activation, deactivation, or updates without process interruption. By supporting multiple versions of functions, modules, and granular function variants for diverse tools, operating systems, and configurations, the IDMP ensures compatibility and adaptability, enabling seamless alternative tool and function variant selections for efficient scaling and handling of complex tasks while maintaining high performance and flexibility.
9. Digital Workflow Optimization: The IDMP enables a holistic approach to tool selection, ensuring that alternative tools match the required functionality while maintaining the integrity of a whole workflow across a digital thread. That is, alternative tool suggestions may optimize entire workflows, taking into account linkages among individual digital tools involved in the workflow and considering factors like cost reduction, performance improvements, or fidelity-efficiency trade-offs when an individual digital tool or multiple alternative tools are suggested for a workflow. Furthermore, to ensure robustness, the platform may use Continuous Compliance (CC) mechanisms, leveraging automated software validation test scripts to dynamically validate alternative tool selections against workflow objectives and dependencies. CC ensures changes maintain compliance with functional and operational requirements, minimizing risks associated with tool substitutions or workflow optimizations. By prioritizing workflows, the IDMP offers a transformative approach to digital thread management, enabling seamless interoperability, informed decision-making, and operational resilience across diverse digital ecosystems.

Thus, the use of alternative digital tools to complete digital tasks and the resulting digital workflow optimization may lead to a multitude of advantages. First, significant reductions in cost and delays may be achieved while maintaining or improving performance throughout different stages of the digital workflow and a digital engineering lifecycle. Second, a wider range of digital model file types and formats may be supported through alternative digital tools, thereby enhancing the system's overall interoperability and further presenting robustness to the digital workflow. Furthermore, integration of multiple alternative digital tools in specific digital tasks such as digital modeling and simulations can expand the design space, diversify the output datasets, and allow a more comprehensive evaluation of potential design performances. The enrichment of datasets within the same design space can further provide additional training data for the development of machine learning models for digital simulation applications, thereby improving the accuracy, efficiency, and adaptability of such models. From a user-centric perspective, alternative digital tool selection and function variant-based implementations of IDMP platform functions simplify the process of integrating new digital tools into a user's existing digital workflows, expands the range of cost-performance tradeoffs available to users, and allows the user to select tools that offer the greatest value for the user's specific requirements and digital task on hand.

### Variant-Based Implementation of IDMP Platform Functions

As discussed in the context of FIGS. 7 to 12, the IDMP enables interoperable connectivity across multiple digital models and associated domain-specific digital tools through API integrations. In this disclosure, a “tool,” “digital tool,” or “DE tool” refers to a software application, computer program, or script that is executable to generate an output from an input derived from at least one digital model type file. For example, the input may be a digital model file, a model splice of a digital model file, or one or more digital artifacts extracted or derived from a digital model file. A “tool function” refers to specific operations, capabilities, features, or methods provided by a digital tool. A digital tool comprises multiple tool functions.

Digital tool functions, through the process of model splicing, are called upon to construct IDMP platform functions that implement or complete specific digital tasks and facilitate digital workflows. That is, by establishing connections with various digital model types via model files' API endpoints (e.g., model splice functions), the IDMP can leverage a resource-capability mapping to create its own platform API, defining distinct capabilities, or platform “functions,” for each specific resource (e.g. digital model types, digital tool functions).

Within the IDMP, a “platform function” represents platform capabilities that can be performed via the IDMP on digital models, model splices, and other digital artifacts or digital assets. It is a discrete operation or action defined by its capability to process specific types of data resources or inputs. Extending from the discussion of splice function scripts and digital thread orchestration scripts in the contexts of FIGS. 7 and 8, a platform function may be implemented in a scripting language as a platform script. A platform function may call upon other platform functions, including splice functions and digital thread orchestration scripts, each involving one or more different digital tools and each accomplishing a specific digital task or sub-task. Conversely, any script available and executable on the IDMP may be viewed as a platform function. A function variant is a version of a function tailored to operate in a specific context, such as a particular operating system, third-party tool, open source tools, or by resource type. Function variants allow the same high-level operation to be executed under varying conditions by adapting to the environmental variables, dependencies, and tool versions present at runtime. With alternative tool selection, the IDMP can dynamically select the most appropriate variant for a given task, thus supporting efficient scaling and handling of complex tasks while maintaining high performance and flexibility.

A resource-capability mapping is a framework for identifying and linking available resources with the capabilities they enable or support. An exemplary resource may refer to digital tools and their functions integrated into and accessible via the IDMP to manipulate specific digital model files, while an exemplary capability may refer to IDMP functions written in scripts for completing certain tasks using the available resources. That is, any script available on the IDMP (e.g., splice function scripts, digital thread orchestration scripts, other IDMP platform scripts), when executed, completes a specific IDMP platform function or digital task. The resource-capability mapping therefore identifies a digital task completed when a script is run, and corresponding digital tool and tool functions invoked by the script, and the input digital model types and output formats.

A resource-capability mapping also represents the relationship between data resources (e.g., files, datasets, other inputs) and the platform functions capable of operating on them. As shall be discussed in more detail in the context of FIG. 18, in agent-based implementation of the IDMP and modular implementations of IDMP platform functions, this mapping may be implemented within module manifests, files that specify the types of resources a given function within the module can support and the operations the function can perform. Module manifests may also specify different function variants' compatibilities such as operating system requirements or tool-specific configurations. By embedding resource-capability mappings in module manifests and discretizing the scope of capabilities, the IDMP can dynamically filter and match tasks to agents and modules based on their specific capabilities, identify suitable functions for a given task, thus facilitating efficient and scalable task assignment and execution. In some embodiments, such modular mappings may replace the need for centralized resource-function or resource-capability databases, and enhance modular extensibility by allowing resource-function relationships to evolve with updates to individual modules.

An alternative tool that is analogous or equivalent to an initial digital tool, when substituted into an IDMP platform function, or when used to create a new variant of the platform function, completes the digital task and generates an output that is similar to the output produced by the initial digital tool via an initial function variant, as measured by one or more digital model-specific, digital tool-specific and/or digital task-specific criteria. Such criteria include but are not limited to, cost, precision, speed, computational load, accessibility, and the like. To facilitate seamless tool substitution, the IDMP function may comprise a universal function schema to support the different variants of the IDMP function implemented with different digital tools respectively.

FIG. 13 illustrates IDMP platform function variants under the same IDMP platform function schema, in accordance with some embodiments of the present invention. A digital tool and task history database 1356 stores historical and/or generalized IDMP platform data, including but not limited to, a resource-capability mapping, user action data collected from prior user interactions with the IDMP, generated and updated scripts (e.g., splice function scripts, orchestration scripts, other platform scripts), and the like. In an agent-based implementation of the IDMP with modular implementations of IDMP platform functions, the resource-capability mapping may be decentralized and distributively embedded in corresponding module manifest files. An IDMP function 1310 may be described by the resource-capability mapping that lists its input parameters, output formats, function schema, one or more function variants implemented with different tools or tool versions for different operating environments. Usage of IDMP platform function 1310 may be recorded in database 1356. For example, user-requested digital tasks that require the execution of a variant of platform function 1310 may be recorded, together with information on input digital models, function execution or digital task completion metadata, any additional user preferences, user selections, and other user actions data collected throughout the usage of platform function 1310. Such usage data may be further analyzed and pattern-tracked by a rule-based or ML-based software unit.

Function schemas such as 1312 of IDMP function 1310 and function variants such as 1314 and 1316 establish a structured framework that supports scalable, alternative tool selection across diverse digital models and operational environments. A function schema outlines the fundamental parameters and operational constraints of each function, including metadata that specifies the function's purpose, inputs, outputs, and environmental requirements, such as compatible operating systems or tool versions. This metadata-driven schema approach provides functions with the flexibility to accommodate multiple tools, enabling precise control over input constraints (e.g., specific formats or file types) and environmental dependencies (e.g., operating systems such as Windows or Linux). Again, as discussed in the context of FIGS. 7 and 8, on the IDMP, a platform function variant is implemented as one or more platform scripts according to the function variant's metadata (e.g., with respective tool APIs under a specific operating environment).

Thus, platform function variants are created as specialized function instances tailored to specific configurations or tool versions, ensuring platform functions, when provided to a customer for execution within its own secure environment (e.g., as part of a tool agent within exclave 310 in FIG. 3), operate optimally under such customized settings. Each function variant may be implemented with a different digital tool (e.g., 1334 and 1336), or optimized for a unique environment, such as a designated operating system or version of the digital tool. Such an approach allows functions to achieve cross-platform compatibility without needing a single universal implementation. For instance, one function may support both Windows and Linux by deploying separate variants individually configured for each operating system. In another example, a first platform function variant may rely on a commercial off-the-shelf (COTS) software tool, while a second platform function variant might execute the same capability using an open-source software tool.

While discussions so far have referred to function variants as being implemented in a particular digital tool, such illustrative examples are not meant to be limiting to the scope of the invention. Specifically, any platform function variant may involve multiple digital tools. Two variants of the same platform function may involve overlapping or non-overlapping digital tools or tool functions. An alternative tool selection process may replace or substitute a particular digital tool in a function variant with an alternative tool. Similarly, multiple digital tools may be replaced together (e.g., two proprietary tools replaced simultaneously by two open-source tools).

This variant-based framework facilitates the scalable integration of alternative tools and digital models, enhancing the platform's adaptability and enabling the streamlined deployment of specialized tools and functions across diverse digital environments. This approach increases the versatility of the IDMP, providing efficient, flexible function deployment tailored to a broad array of hardware and software configurations.

### Exemplary Function Variants: Extract Function for a Spreadsheet File

To illustrate the concept of function variants, consider an exemplary use case of alternative tool selection on the IDMP, where a user uploads a spreadsheet model file in .xlsx format to extract specific digital artifacts that are subsequently used within a digital thread or an accompanying Magic Doc created by the user. The below sequence of steps highlights how the alternative tool selection process provided by the IDMP can utilize a resource-capability mapping and schemas of modules and functions to support function variants implementable by agents and modules of the platform.
1. The user uploads an .xlsx file (EXCEL spreadsheet) and initiates an extract job by clicking an Extract button on a user interface. At this point, no specific tool has been chosen for the desired extraction task.
2. The IDMP system may review platform function schemas within its database and identify two available extract function variants provided by the IDMP capable of processing .xlsx files: one that utilizes MS EXCEL and another that employs LIBREOFFICE (an open-source option).

```
Example extract platform function schema for MS EXCEL
“@IDMP:extract”: [
  {
  “entrypoint”: “excel_module.exe”,
  “run_command”:“{entrypoint}DataExtraction--input-file{input_file}--output-
      file{output_file}--temp-dir{temp_dir}”,
  “function_schema”:“function_schemas/data_extraction_schema.json”,
  “operating_systems”: [
    “Windows 10”,
    “Windows 11”,
    “Windows Server 2019”,
    “Windows Server 2022”
  ],
  “tool_versions”: [“2019”, “2021”]
  }
],
```

Note in this example, the variable “function_schema” refers to a specific tool function schema for extract from MS EXCEL. The presented IDMP platform function schema for extract for xlsx model files is the superset of all too-specific function variants.

```
Example extract function schema for LIBREOFFICE
“@IDMP:extract”: [
  {
  “entrypoint”: “libreoffice_module.exe”,
  “run_command”: “{entrypoint}CalcDataExtraction
  --input-file {input_file}--output-
    file{output_file}--temp-dir{temp_dir}”,
  “function_schema”: “function_schemas/libreoffice_data_extraction_schema.json”,
  “operating_systems”: [
    “Windows 10”,
    “Windows 11”,
    “Windows Server 2019”,
    “Windows Server 2022”,
    “Ubuntu 22.04”,
    “RHEL 8”,
    “RHEL 9”.
    “macOS 14”
  ],
  “tool_versions”: [“6.4”, “7.0”, “7.2”, “7.4”]
  }
]
```

3. The IDMP system may prompt the user to select a preferred digital tool for the extraction task, allowing the user to choose between MS EXCEL and LIBREOFFICE.
4. Once the user makes a selection, the system may update and finalize the job, now reflecting the chosen tool.

The above example assumes that both platform function variants, one implemented in MS EXCEL and the other implemented in LIBREOFFICE, already exist and can be searched and identified from an IDMP resource-capability mapping comprising the listed function schema and metadata. Moreover, the user has requested a specific extraction task to be completed, but does not specify any digital tool to use for completing the task. The IDMP provides both function variants to the user, who makes a selection (e.g., based on ownership of a license for MS EXCEL, based on a comparison between the two variants in terms of execution time, computational load, accurate and similar criteria, etc.), and the platform executes the selected digital tool or function variant to complete the user-requested extraction task.

In software development, a function schema is a structured representation or definition that describes the characteristics, inputs, outputs, and behavior of a software function or software application. Within embodiments of the present invention, it serves as a template that ensures consistency and adherence to predefined structures and formats for instantiating platform function variants. Within the context of the IDMP, function schemas may be used to standardize the interfaces between different functions, model splices, and digital threads and workflows. Some exemplary elements of a platform function schema include, but are not limited to:
1. Function name: an identifier used to call or reference the platform function
2. Input parameters: the types, names, and descriptions of data the function accepts as input
3. Output or return value: the types, formats, and descriptions of data the function produces or returns
4. Constraints or preconditions: any requirements that must be met before the function can be executed
5. Error handling: information on how the function deals with potential errors or exceptional cases
6. Dependencies: any other functions, libraries, or resources the function relies on to operate
7. Metadata: additional information such as version, author, creation date, last modified date, last execution date
8. Performance characteristics: expected time complexity, space complexity, or other performance-related information.

Furthermore, note in the simple extract function example above, the IDMP extract function variants are linked to different tool extract functions (e.g., DataExtraction in MS EXCEL, CalcDataExtraction in LIBREOFFICE) directly, as each tool already provides specific tool functions for completing the desired extraction task.

Extending onto more specific and complex digital tasks or digital workflows, recall from FIG. 13 that an IDMP function completing such a task may be written as a platform script or task script that calls upon multiple tool functions from one or more digital tools (e.g., 732 in FIG. 7, and 894 in FIG. 8). In some embodiments, each tool function may be masked, wrapped, or encapsulated in a corresponding IDMP function variant (e.g., extract function example above, where an extract function on the IDMP is directly linked to an extract function in each of the two exemplary tools), and the platform script calls upon the appropriate IDMP-function-as-tool-function variant when needed. In this setup, the platform script is unchanged when an alternative digital tool substitutes for an initial digital tool, but platform function metadata associated with the platform script may be specific to the digital tool used. During execution, the IDMP utilizes the metadata to decide which IDMP-function-as-tool-function variant to call upon. On the other hand, in some embodiments, the platform script may have different variants each making specific function calls to specific tools. In this setup, the platform script may be updated (e.g., by an AI-assisted substitution module) into a new variant when an alternative digital tool replaces an initial digital tool. In yet some embodiments, a combination of these two approaches may be implemented.

### Exemplary Alternative Digital Tool Selection Processes in an IDMP

FIG. 14 shows an exemplary implementation of an alternative digital tool selection process 1400 within an IDMP based on a user request, in accordance with some embodiments of the present invention. A digital tool may implement multiple capabilities, functions or methods, with integrated Application Programming Interface (API) libraries. A digital tool is executed through such functions or API calls available within. “Alternative tool selection” or “cross-tool selection” refers to the isomorphic analysis, determination/identification, recommendation, and user-selection of an alternative to a user's initial digital tool choice for a specific digital task or a specific digital model type. A digital tool that can be used to generate an output similar to the output produced by an initial digital tool, as measured by one or more digital model-specific, digital tool-specific and/or digital task-specific criteria, may be considered an equivalent tool, or a similar tool. The IDMP as disclosed herein may present similar digital tools to a user as an initial tool's alternative options. A digital task may require one or more functions within a single digital tool or multiple digital tools and tool functions to be invoked/executed.

In the exemplary implementation shown in FIG. 14, one or more of the following sequence of steps 1402 to 1416 are executed. Each step is also labeled with reference numerals ranging from 1 to 8 to indicate where they may be implemented within an exemplary IDMP 1430, numbered consecutively in the list below, discussed in detail in the context of FIG. 1.

### 1. (Step 1402) Collect User Input for Digital Task and Initial Digital Tool

As digital tools are constantly evolving, users may not be aware of the availability or the applicability of alternative tools to perform a desired digital task involving one or more digital model type files. Alternative tool recommendation within an IDMP 1430 may be prompted by a user input or user request 1458 received through a user interface such as 590 in FIG. 5.
In some exemplary embodiments, one or more of the following substeps may be performed:
a. Receive a user request for an alternative to an initial digital tool for a specific task: For example, a user may upload a digital model file (e.g., .xlsx file, .stl file), use a conversational user interface to describe a digital task and an initial digital tool choice (e.g. “extract graphs from the first three sheets of this input file using Tool A”, “perform stress analysis on the input 3D model in Tool B”), and request an alternative tool (e.g., “can you perform this task with a different tool?”, “what open-source simulator can I use to run the stress analysis?”). In some embodiments, the user may ask for an alternative digital tool directly (e.g., “what is an open-source alternative to Tool A?”). In some embodiments, this step may be optional, and the IDMP may prompt the user on whether to consider an alternative tool, when the platform detects that a more efficient or cost effective tool is available.
b. Set a default initial digital tool for the specific digital task: If the user does not explicitly specify an initial digital tool choice (e.g. “extract graphs from the first three sheets of the input .xlsx file”, “perform stress analysis on the input 3D model”), IDMP 1430 may identify a default initial digital tool as one that is implicitly associated with the input model file type (e.g., .xlsx, .stl) and that the user has a license for (e.g., spreadsheet software that operates on .xlsx, engineering simulation software that operates on .stl, etc.). A digital tool may be considered associated with a model type, a specific digital task, or a specific stage of a digital workflow, if it can be applied to a model type file, to the specific task, or to the specific stage of the digital workflow.
c. Generate a list of available digital tools: When the user does not specify an initial digital tool, IDMP 1430 may also present the default initial digital tool to the user as a tool selection option in a list of all available digital tools. In some embodiments, IDMP 1430 may check the user's access rights (e.g., licenses) and only present to the user digital tools that he or she has access to, including open-source tools. In some embodiments, IDMP 1430 may check a digital tool and task history database 1456 to identify which tools and/or tool functions the user prefers to use and has used more frequently in the past, and present such tools with higher priority to the user.
d. Collect user input iteratively for a digital workflow: In some embodiments, the user may utilize a workflow-based interface 596 to navigate through data, decisions, contextual information, user input, and external feedback involved in a digital workflow or a digital thread. IDMP 1430 may offer alternative digital tools at individual process steps, when available. Furthermore, IDMP 1430 may be instructed to replace all instances of a particular tool within a digital workflow with an alternative tool.

### 2. (Step 1404) Analyze Past Usage of Digital Tools and Tasks

In the Analysis & Control Plane 1450 within IDMP 1430, a comparison engine 1452 may compare the initial digital tool to candidate alternative digital tools, based on data retrieved from a digital tool and task history database 1456. In some embodiments, this digital tool and task history database 1456 may contain a tool catalog or a resource-capability mapping.
A tool catalog may categorize and index all digital tools integrated into IDMP 1430. For example, this database may store all digital tools available on or accessible through IDMP 1430, tool APIs, plugins, and tool function/method libraries.
A resource-capability mapping is a framework for identifying and linking available resources with the capabilities they enable or support. An exemplary resource-capability mapping is the IDMP API, or platform API, where the resource may refer to digital tools and their functions integrated into and accessible via the IDMP, and where the capability may refer to IDMP functions written in scripts for completing certain tasks using the available resources. That is, any script available on the IDMP (e.g., splice function scripts, digital thread orchestration scripts, IDMP platform scripts), when executed, completes a specific IDMP platform function or digital task. The resource-capability mapping stored in digital tool and task history database 1456 therefore identifies a digital task completed when a script is run, and corresponding digital tool and tool functions invoked by the script. In some embodiments, such a resource-capability mapping may assist with zero-knowledge implementations where the capability details are available to a user while the specific digital tool resource or its functions are only mapped within a customer environment. In some embodiments, such mappings are not included during analysis 1404. In some embodiments involving modular implementation of platform functions, a resource-capability mapping is distributively stored within module manifest files.
In some embodiments, database 1456 may additionally store past user behavior data (e.g., how a user navigated different tools and what parameters have been used), past tool usage patterns (e.g., how users have navigated a tool and what parameters are typically used for the tool for what specific tasks), tool use outcome and performance metrics, and associated metadata. For example, digital tool and task history database 1456 may comprise event logs that capture requested task, model-type file, tool ID, function name, parameter IDs, user inputs, time stamps, user access tokens etc. as part of each action in the event log. Some data from the event log may be masked. A tool usage pattern may refer to the sequence of such tasks, and the associated mapping of tools and tool functions to different tasks.
In some exemplary embodiments, one or more of the following substeps may be performed:
a. Retrieve similar functions: given a user-requested task, digital tool and task history database 1456 may be accessed to retrieve tool functions or platform function variants that can be used to complete the task; given an initial digital tool, digital tool and task history database 1456 may be accessed to retrieve tool functions or platform function variants similar to those that can be performed by the initial digital tool; given a user-requested task and an associated initial digital tool, digital tool and task history database 1456 may be accessed to retrieve tool functions or platform function variants similar to those that can be performed by the initial digital tool or initial platform function variant to complete the user-requested task.
   i. Two tool functions f₁ and f₂ may be considered similar, equivalent, or isomorphic if they meet an isomorphism criterion. Isomorphism refers to the general concept of an invertible mapping between entities that preserves form, shape or structure among corresponding elements. Functional isomorphism may be measured by comparing the schema of the input and output for f₁ and j₂, content of the input and output for f₁ and f₂, and/or by comparing the content of f₁ to f₂ using syntax analysis when possible. For example, the two functions may be compared on metadata on model type, keywords in function description, correspondence of data structure for input or output, and the like.
   ii. Identical function input/output schemas/contents may be sufficient for functional isomorphism, but may not be absolutely necessary, as IDMP 1430 may be capable of providing platform scripts that mask/encapsulate differences. For example, if f₁ maps an input tuple (a, b, c) to an output a+b+c, while f₂ maps the input tuple (a, b, c) to an output tuple (a+b, c), then f₁ and f₂ may still be considered isomorphic, as f₁'s output can be easily obtained from f₂'s output using simple mathematical operations available on IDMP 1430. Such platform scripts that mask/encapsulate the differences may be viewed as different platform function variants that complete the same task using different tool functions. The goal is to ensure that given the same input, these tool functions or corresponding platform function variants generate outputs that are about the same (e.g., difference in outputs is within a certain bound, threshold, or error tolerance; the outputs are identical with a high probability or above a probability threshold).
   iii. In this disclosure, each tool function may also be viewed as a tool attribute, in addition to other tool features and characteristics. Tools having similar tool functions may be viewed as tools with similar attributes.
   iv. In some embodiments, tool function isomorphism may be determined or confirmed based on SME feedback. Human-in-the-loop expert involvement in this decision making process minimizes potential impacts and risks of incorrectly substituting one tool function with an alternative tool function that may look the same but produces an entirely different output, especially when the tool function output is propagated through a digital workflow.
b. Determine similar digital tools that perform similar tool functions: a search may be performed on digital tool and task history database 1456 to find similar tools that perform some or all of the retrieved similar tool functions. In some embodiments, IDMP 1430 may incorporate user profiles or preferences to learn from the user's past tool selections and usage patterns, then predict/suggest tools that the user is likely to prefer or select, thereby reducing time and effort spent on digital tool selection. These similar tools may be referred to as candidate tools for alternative digital tool selection.
c. Isomorphic analysis and comparisons to refine the set of similar tools: Isomorphic analysis may be conducted in step 1404 among digital tools (e.g., between the initial tool and a similar tool) to map the tools' corresponding tool functions and performance characteristics to understand equivalences and potential substitutions. For example, a similarity measure may be computed between an initial digital tool and a similar digital tool, based on how many isomorphic functions they support. Such isomorphic analysis of digital tools may be independent of the user-requested task as it may consider all functions within the tools. In some embodiments, isomorphic analysis of digital tools may be task-specific, where only isomorphic functions involved in completing the user-requested task are considered for comparing the digital tools. Furthermore, isomorphic analysis may be conducted among digital tasks (e.g., between the user-requested task and a task retrieved from tool and task history database 1456), by comparing the respective input and outputs of these tasks (e.g., input/output schemas). Isomorphic analysis of digital tasks may help narrow tool choices by limiting similar tools to only those used for completing isomorphic tasks.
   3. (Step 1406) Identify Alternative Digital Tools that can Perform the Requested Task and Evaluate
From the set of similar tools found in step 1404, one or more alternative tools may be identified by an analysis engine that evaluates the tools' performances on the user-requested task.
For example, an expert system 1457 (e.g., based on SME input, or based on prior-established rules), or a machine learning (ML) engine 1454 may identify one or more best-performing isomorphic tools as candidate alternative tools.
Performance characteristics for a digital tool may be measured by a cost function. Different users may rely on different cost functions depending on resources available to them and individual user priorities and preferences. Exemplary cost functions include, but are not limited to, monetary costs (e.g., license vs. open source), compute load (e.g., even for the same task, compute load may be different for different clouds that the user has access to), and additional user effort to manage the data outputs and accuracy/precision of task completion results. Furthermore, the analysis engine/module 1454 may provide users with a detailed breakdown of the cost implications of using different digital tools. This could help users make more informed decisions about selection among isomorphic tools, especially in cases where cost is a major consideration.

### 4. (Step 1408) Suggest Alternative Tools to the User

One or more isomorphic tools, as identified in step 1406, may be suggested or recommended to the user by IDMP 1430. This tool recommendation may also be provided in the form of function variants implemented with the suggested tools.
In some embodiments, a conversational interface may be used to obtain user input, such as user selection of an alternative tool for executing/completing the requested digital task. An “user” may be a human or non-human entity, such as a human user, an “AI-user”, an AI agent, or an API call from another subsystem of the IDMP.
Alternative tool suggestion within the IDMP makes switching to a new digital tool and new platform function variant less onerous (e.g., minimal learning curve, minimal model data pre-processing or preparation), as the selected alternative tools are called via universal splice function scripts or API function scripts orchestrated by platform scripts.

### 5. (Step 1410) Link and Adjust Model Splices to Implement the Requested Task

To apply a selected alternative tool to complete the requested digital task by executing a platform function in the form of a platform script or task script (e.g., a splice function script, a digital thread orchestration script, other platform scripts), the initial script may be revised (e.g., to change tool/function ID, data format, and/or other syntax) into an alternative script to invoke the selected alternative digital tool and tool functions instead of the initial digital tool and tool functions. For example, orchestration scripts call upon universal splice function scripts and link model splices into a digital thread/workflow for a specific task. Either a human expert user or an AI agent/algorithm can make revisions to the orchestration links between model splices, or adjust splice function scripts within model splices.
In some use cases, a single isomorphic tool may be suggested as an alternative to an initial digital tool (e.g., an open-source equivalent replacing a proprietary tool); in some use cases, a combination of multiple digital tools may be suggested as an alternative to an initial digital tool (e.g., multiple open-source digital tools each with a small set of dedicated tool functions collectively replacing a complex proprietary digital tool); in some use cases, a single digital tool may be suggested as an alternative to several interoperable digital tools (e.g., one cheaper but comprehensive digital tool to replace multiple proprietary digital tools each with high license fees). In each of these scenarios, IDMP 1430 may both adjust model splices and relink them accordingly.
In some embodiments, token management with fungible idempotent tokens (FIT) may be conducted in an application plane 1460 to assign tasks to specific tools. Token management is described in more detail in the context of FIG. 21. Specifically, idempotent tokens offer a comprehensive means to ensure reliable task execution, efficient resource utilization, and enhanced scalability. An idempotent token is a unique identifier, key, string, or data structure that tracks requests across services to ensure that each request is handled only once, and guarantees that performing the same operation multiple times has the same effect as performing it once. A function is designated as idempotent if the function can execute multiple times without side effects. These functions are state-invariant. For example, pressing the “close doors” button on an elevator can be deemed to be an idempotent operation because pressing the button multiple times causes the desired action to occur only once. Idempotent tokens can be fungible or non-fungible. An FIT presents an externally visible representation of the requested work to the IDMP. It can encapsulate specific request elements that include, for example, the initiating tenant or requesting account/user ID, the requested tool/function, and the intended model for execution.
A non-fungible idempotent token (NFIT) can be data that represents an internal construct used by operators. The NFIT can incorporate similar elements used by the FITs with an included selected digital tool constraint. FIT and NFIT can be created in pairs, where the FIT represents a request that can be fulfilled by various digital tools and the NFIT represents a unit of work being completed by a certain digital tool. That is, FIT and NFIT may be used to decouple the work being requested from the work actually being performed. An FIT identifies the work being requested, and an NFIT identifies the work actually being performed at a digital tool according to the user request.
In some embodiments, “linking”, “connecting”, or “combining” two digital models or model splices refers to jointly accessing constituting splices via splice functions or API endpoints. For example, data may be retrieved from one splice to update another splice (e.g., one splice as data source and one splice as data sink, linked by an orchestration script or platform script); data may be retrieved from both splices to generate new output (e.g., both splices as data sources, fed into an orchestration script); data from a third splice may be used to update both a first and a second splice (e.g., both splices as data sinks). A digital thread on the IDMP is constituted by linking model splices via orchestration scripts that invoke digital tools/functions via the linked model splices. Swapping an initial digital tool out for an alternative tool corresponds to revising model splices.
Put another way, linking of digital models or model splices can be viewed as outputting by a digital tool a derived model (file) from a base model, where the derived model can be used by other digital tools. That is, using output information from a model in another digital tool function. Model/splice linking may also refer to using derived information/models from different tools in a platform function that performs a task that is impossible without the information/models derived from these tools.
Some model linking or linked model examples include:
a. A polygonal representation of a CAD model (e.g., OpenCAD) can be generated and used in a Finite Element Analysis (FEA) simulation tool function.
b. Requirements may be extracted from a SysML model, and used to check if the CAD model meets these requirements.
c. Utilizing AI to generate a document using the output of a drawing from a CAD model and a requirement extracted from a SysML model.
d. Modifying a CAD model parameters (e.g. modify a hole diameter in a model); getting the mass/weight of a model after the modification; getting the mass/weight requirements from a SysML model; updating an Excel sheet with the data extracted from the CAD model (weight) and the requirement from the SysML model for an engineer to review.

### 6. (Step 1412) Perform Requested Task Using Alternative Digital Tool

To perform the user-requested task using the selected alternative tool, a platform function variant written as a platform script within application plane 1460 may be executed, which in turn calls splice function scripts within model splices in a splice plane 1470. Model splices are generated from digital models in a model plane 1480.
As discussed in list item 5 above, token management with NFIT in splice plane 1470 assigns digital tools as decided by the user in step 1408.
In some embodiments, the analysis/control plane 1450 and the application plane 1460 reside in the IDMP, while the splice plane 1470 may be implemented behind a customer firewall as part of an agent of the IDMP. That is, individual splice function scripts generated via model splicing by an IDMP agent may be tailored to call upon proprietary digital tools the customer has access to in its private environment, using alternative tools when necessary. Platform scripts within the IDMP call upon universal splice function scripts that may be implemented as different variants in different customer environments. The splice plane 1470 acts based on the upper planes' decisions. The analysis/control plane 1450 and the application plane 1460 manage orchestration, authentication, and routing rules for tasks performed on digital models. They determine which digital model to interact with and how to interact with the digital model, while the splice plane 1470 handles the executing of the tasks.

### 7. (Step 1414) Validate Alternative Digital Tool

Task execution results by alternative tools may be compared to that from the initial digital tool, to evaluate different tools' performance characteristics and to validate a recommended or selected alternative digital tool.
For example, isomorphic analysis of tool outputs may be conducted, comparing output from alternative tools to output from the initial digital tool. Note that in the isomorphic analysis of step 1404, input/output schema/form are compared (e.g., metadata on model type, keywords in function description, correspondence of data structure for input or output, data type of the fields), while this validation step considers whether a sufficiently correct output has been generated (e.g., for the same input, the difference in outputs is 0/null or within a certain bound or threshold; for the same input, the outputs are identical with a high probability or above a probability threshold).
In some embodiments, digital tool and task history database 1456 may store tool performance metrics. These metrics may provide quantitative data on the performance of different tools, such as their speed, precision, accuracy, and reliability. This information may help users to choose the tools that are the most suitable for their tasks.
As discussed in list item 3 above, in some embodiments, performance characteristics for a digital tool may be measured by a cost function. Different users may rely on different cost functions depending on resources available to them and individual user priorities and preferences. In addition to the accuracy of task completion results and speed of task completion, cost functions may be based on monetary costs (e.g., license vs. open source), compute load (e.g., even for the same task, compute load may be different for different clouds that the user has access to), and other relevant factors.

### 8. (Step 1416) Save to Digital Tool and Task Repository

Each user input/request received, alternative tool recommended/selected, platform function variant chosen/generated, tool execution/validation results, and/or task completion output/results may be recorded in digital tool and task history database 1456 for future use in steps 1404, 1406, and 1414.

### Exemplary System Implementation of Alternative Digital Tool Selection

FIG. 15 shows illustrative component modules 1500 of an IDMP that implements alternative tool selection, in accordance with some embodiments of the present invention. In this illustrative example, the following system components may be implemented to execute process steps shown in FIG. 14. Each system component is also labeled with reference numerals ranging from 1 to 6 to indicate where they may be implemented within an exemplary IDMP.

### 1. (Component 1502) User Interface

Examples in the above discussions of FIG. 14 refer to user requests comprising a simple digital task that can be executed through a digital tool directly on an input digital model file. In practice, a digital task may involve multiple input files, metadata, parameters, and requires the execution of multiple functions, possibly from multiple digital tools, as coordinated via a platform function written as a platform script (e.g., model splice function script or an orchestration script).
For example, a digital workflow through a digital thread often comprises extensive linkages among models and tools. FIG. 6 describes the inherent complexity of digital threads. As such, alternative digital tool selection within the IDMP may predicate multiple iterations of feedback to/from the user to perform all functions requested to complete a requested task. User interface 1502 therefore plays a very important role in presenting information in the right context, capturing user input such as tool preferences, license information, model information, and tasks to be completed, and in allowing users to interact with presented digital tool recommendations to make decisions on alternative digital tool selection and to invoke script/task/tool/function execution instructions. Following are two exemplary use cases for user interface 1502. These are for illustrative purposes only and do not limit the scope of the present invention.
a. A user requests an action on a digital model, with a suggested/preferred digital tool. The IDMP performs isomorphic review of prior tasks to present alternative tools. The user selects an alternative tool, e.g. an open source version.
b. Back-and-forth dialogue instead of isomorphic review:
   i. User requests a sequence of actions as a digital thread or digital workflow.
   ii. Through a Graphical User Interface (GUI), the user may upload digital models and preferred digital tools for steps in the digital thread.
   iii. An IDMP platform Application Programming Interface (API) allows the user to write task scripts with tool API calls, using tool names, tool function names and parameter names, to perform the sequence of actions requested on one or more input digital models or digital model splices.
   iv. The system converses with the user to capture the user's actions or to tag user-requested tasks with specific metadata. Then the system may perform a lookup via a comparison engine (e.g., 1552) in a tool and task history database (e.g., 1556) to suggest alternative tools.
While not shown explicitly, user interface 1502 may be supported by a natural language processing sub-module (e.g., a transformer-based language model) of an analysis engine 1506 to interpret natural language-based user inputs. For example, the user may describe an intent, a sequence of desired actions, or a digital workflow, and analysis engine 1506 may convert the user input into machine-readable conditions and programming codes.

### 2. (Component 1504) Tool and Task History Database

As discussed in the context of FIG. 14, digital tool and task history database 1504 is a database of available digital tools and past tasks completed using the available tools. Specifically, database 1504 may store a resource-capability mapping, a tool catalog, user action data collected from prior user interactions with the IDMP to complete digital tasks, generated and updated platform scripts (e.g., splice function scripts, orchestration scripts), and the like.
For example, tool and task history database 1504 may comprise event logs that capture requested task, model-type file, tool ID, function name, parameter IDs, time stamp, user access tokens, etc. as part of each action in the event log. Some data from the event log may be masked. A tool usage pattern may refer to the sequence of such tasks, and the associated mapping of tools to different tasks, as well as aggregated statistics that summarize such tool usage information.
In another example, tool and task history database 1504 may comprise a resource-capability mapping, which in turn may include a tool catalog that categorizes and indexes all digital tools and tool functions integrated into the IDMP. That is, this database may store all digital tools available on or accessible through the IDMP, as well as tool APIs, plugins, and tool function/method libraries for the available tools. A digital tool is considered accessible through the IDMP if it has previously been integrated into the IDMP and is recorded in the resource-capability mapping. The more generalized resource-capability mapping identifies and links available resources with the capabilities they enable or support, and further identifies platform functions constructed using various digital tools. An exemplary resource-capability mapping is the IDMP API, or platform API, where the resource may refer to digital model types, and digital tools and their functions integrated into and accessible via the IDMP, and where the capability may refer to IDMP functions written in scripts for completing certain tasks using the available resources. That is, any script or task script available on the IDMP (e.g., splice function scripts, digital thread orchestration scripts, other IDMP platform scripts), when executed, completes a specific IDMP platform function or digital task. The resource-capability mapping stored in digital tool and task history database 1504 therefore identifies a digital task completed when a script is run, and corresponding digital tool and tool functions invoked by the script. In agent-based implementation of the IDMP with modular implementations of IDMP platform functions, the resource-capability mapping may be decentralized and distributively embedded in corresponding module manifest files.
Database 1504 can additionally store past user behavior data (e.g., how a user navigated different tools and what parameters have been used; what platform scripts or task scripts the same user has written before; what tasks scripts other users have written before for the requested task or similar tasks), past tool usage pattern (e.g., how users have navigated a tool and what parameters are typically used for the tool for what specific tasks; how tools are called with what parameters for which tasks in past task scripts), tool use outcome and performance metrics (e.g., output accuracy, cost, compute load), and associated metadata. Note that in FIG. 15, a comparison engine 1552 is labeled as part of the tool and task history database 1504. Prior discussion of process step 1420 describes the retrieval and comparison functions performed by a comparison engine. In some embodiments, comparison engine 1552 may be implemented as part of an analysis engine 1506 and/or an expert system/recommender system 1508, discussed next.

### 3. (Component 1506) Analysis Engine for Isomorphic Analysis and Pattern Tracking

An analysis & control plane 1550 within the IDMP contains different modules to track tool usage on the IDMP. Analysis engine/module 1506 interprets user actions within the system by tracking task inputs and tool selections (e.g., user input as received via user interface 1502 in exemplary use case list item 1a and 1b above). This analysis module may also measure the success and efficiency rates of each task. Two exemplary implementations of this analysis module are as follows:
a. A pattern-tracking system that monitors how users navigate through the platform and their tool decisions. For example, what is the sequence of steps a user takes to implement a digital task, including iterations and revisions? Such user actions may occur via a GUI (e.g., in list item 1b-ii above) or API-based task script (e.g., in list item 1b-iii above).
b. Analysis module 1506 may process tool attributes information, user preferences, and performs comparison analyses including isomorphic analysis. For example, what are the common functions implemented by multiple digital tools on the same model type file? Which functions are isomorphic? Each function may be viewed as a tool attribute. In some embodiments, analysis module 1506 may consider only functions or tool-attributes relevant to a specific requested task, as discussed with reference to process step 1404. In some embodiments, such an analysis module may consider all functions or tool-attributes available. Again, comparison engine 1552 may be implemented within analysis module 1506.
As an illustrative example for tool function/tool-attribute comparison among two digital tools, consider the use case of comparing openpyxl and the EXCEL Component Object Model (COM) interface. Both can interface with .xlsx documents and perform certain operations. The EXCEL COM interface implements the full range of functions available in EXCEL, but mandates a complete installation of EXCEL for its operationality. Consequently, it tends to run slower and incur higher licensing costs. As an alternative, openpyxl operates without necessitating an EXCEL installation, but it cannot perform the entire range of functionalities found within modern EXCEL documents. Nevertheless, for operations suited to openpyxl, it generally operates faster than its equivalent operation in EXCEL.
For example, below are exemplary sequences of steps for tool function comparison or functional isomorphic analysis between openpyxl and EXCEL COM to execute certain tasks.
   Openpyxl:
      a) Receives the request to process a function with given parameters
      b) openpyxl library is loaded
      c) functions from openpyxl is executed in the same process as the current script
      d) Result is formatted and returned to the agent
   EXCEL:
      a) Receives the request to process a function with given parameters
      b) MICROSOFT (MS) interop services is loaded
      c) Instance of Microsoft Excel is started using MS interop services
      d) File is loaded if necessary
      e) Functions inside of excel are called through MS interop services
      f) EXCEL executes the functions in order
      g) Results are returned to the module
      h) The module format and return the results to the agent
For platform scripts (e.g., splice function scripts or orchestration scripts) residing in the Application Plane 1560 of the IDMP, a heuristic may map respective tool options for tool-attribute substitutions. For example, given a .xlsx type file, splice functions below may have corresponding tool options:
   update_cell->openpyxl or Excel COM
   download_workbook-->openpyxl or Excel COM
   evaluate_macro_in_file-->Excel COM
   extract_graphic_from_file-->Excel COM
Subsequently, a user may specify a desired digital tool for a specific action (e.g., “use EXCEL COM to extract graphs from the uploaded .xlsx file”), or dictate his/her preference regarding the platform's selection method (e.g., “use a free tool when possible”). This could be done via specific settings in the user interface or by specifying within a platform API call or task script.

### 4. (Component 1508) Expert System/Recommender System for Tool Selection or Optimization

Analysis & Control plane 1550 may include system modules that use rules, logic or machine learning algorithms to suggest digital tools based on user actions, tool use outcomes, or other specified metrics, for example as discussed in reference to process steps 1406 and 1408. Two exemplary implementations of this recommender module are as follows:
a. An expert system that employs a set of rules to recommend digital tools. The expert system maps out tool alternatives to each function offered by the platform as per predefined rules (e.g., based on functions/tool attributes). These rules may initially be selected based on an SME's input and subsequently be updated based on user actions and user feedback
b. A machine recommender system that uses machine learning (ML) algorithms to predict and suggest alternative tools. For example, ML models that are trained from past user interactions and tool performance data may be used to predict tools for a user based on the user's search query, or based on an input model type file, or additional inputs.

### 5. (Component 1510) Token Management Module

A token management module may implement requested digital tasks consistently using selected alternative digital tools. In addition to offering alternative digital tool suggestions for the user's consideration, the IDMP may complete the requested task using the alternative digital tool. FIG. 21 shows an illustrative data flow when a requested digital task is assigned to a digital tool and tracked using idempotent tokens to avoid duplicate executions, according to some embodiments of the present invention. As discussed in reference to process steps 1410 and 1412, fungible idempotent tokens (FIT) track the assigned task and avoid duplicate executions. FIT are linked with nonfungible idempotent tokens (NFIT) that track the execution of the task. In these implementations, data sovereignty is a major guiding principle.

### 6. (Component 1512) Feedback and Archival Module

Feedback model 1512 performs process step 1416 and closes the loop by recording performance outcomes of suggested tools and platform function variants, constantly refining rule sets/learning models based on new data, and evolving the adaptive optimization engine to enhance recommendation efficiency.

### Additional Exemplary Implementations

FIG. 16 is another exemplary flowchart 1600 showing a process for alternative digital tool selection, in accordance with some embodiments of the present invention. In this particular example, the alternative tool selection process described in the context of FIGS. 14 and 15 are explained in the function variant-based framework discussed in the context of FIG. 13. Furthermore, the user only specifies input digital model(s) and a desired digital task, and the IDMP determines different function variants implemented in different digital tools, one of which is selected for execution to complete the input digital task.

Specifically, at a step 1610, a user request is received. The user request is indicative of a digital task involving an input digital model. For example, the user request may be a natural language-based description of a user intent or a description of the digital task itself. In one embodiment, the user intent may relate to the IDMP, and the user request may comprise one or more operations performable by the user on the IDMP to achieve the user intent. The user intent may comprise an outcome desired by the user when interacting with the IDMP, and the digital task may be generated based on the user intent.

In another example, the user request may be a user click or user selection of a button (e.g., “Extract”) on a user interface. Given an input digital model type, the IDMP may present to the user all or a selected list of commonly selected platform functions (e.g., splice functions, orchestration functions, etc.) available on the IDMP. In agent-based implementation of the IDMP and modular implementations of IDMP platform functions, discussed in detail in the context of FIG. 18

At a step 1620, an input digital model file of the input digital model is retrieved. The digital task is to be completed on this digital model file using an initial digital tool already integrated into the IDMP. A description of the initial digital tool and tool functions is available through a resource-capability mapping of the IDMP.

At a step 1630, a platform function is identified from the resource-capability mapping of the IDMP. For example, the given digital task may have been requested by a prior user, and an IDMP platform function may already exist to complete this task. This IDMP platform function may be described by an IDMP resource-capability mapping, recorded in a digital tool and task history database, or recorded distributively within module manifests. As discussed in reference to digital tool and task history database 1504, this resource-capability mapping provides a correspondence between a given resource and a corresponding capability of the given resource. For example, the given resources may comprise tool functions and digital model types accessible on the IDMP; the given capabilities may comprise platform functions executable on the IDMP. In agent-based implementation of the IDMP and modular implementations of IDMP platform functions, this identification of the platform function may be performed progressively. The IDMP may dynamically filter and match the task to agents based on their specific capabilities, then determine the particular module and platform function. The identified platform function completing the digital task may comprise a function schema that outlines the platform function metadata needed for function execution.

At a step 1640, an initial function variant of the platform function implemented with the initial digital tool is identified from the resource-capability mapping. This initial function variant complies with the given function schema. For example, the given digital task may have been requested by a prior user, and this initial IDMP platform function variant tailored to the initial digital tool may already exist in the resource-capability mapping.

At step 1650, an alternative function variant of the platform function implemented with the alternative digital tool is retrieved from the resource-capability mapping. This alternative function variant complies with the function schema of the platform function. For example, this alternative IDMP platform function variant tailored to the alternative digital tool may already exist in the resource-capability mapping, and may be identified similarly to the initial platform function variant. In some embodiments, this alternative IDMP platform function variant may not exist already, but the alternative tool may have been used to complete other similar tasks in the past. The IDMP may then generate the alternative function variant accordingly.

At a step 1660, the alternative function variant of the platform function is executed to complete the digital task using the alternative digital tool.

In addition to the process shown in FIG. 16, the IDMP is capable of facilitating additional deployment scenarios where an alternative tool is used via an alternative function variant to complete a user-requested digital task. Below are some illustrative examples that are non-limiting in scope, tagged by user input in each scenario:
a) Digital Model+User Intent/Digital Task: The user provides only input digital model(s) and an intent (e.g., a description of a digital task to be completed). For example, the user may describe the available input and the desired output. A rule-based analysis module may compare the description to historical data stored in database 1356 to determine the desired task and identify the necessary platform function for completing the task. In some embodiments, an AI module (e.g., a transformer-based large language model) may analyze the user input to determine the desired task and identify the necessary platform function for completing the task.
b) a)+User Preferences: In scenario a), the user may further specify one or more selection criteria or preferences for a tool selection. For example, the user may request the cheapest tool per execution of a platform function to complete the task (e.g., with or without taking into account proprietary licenses). The user may request the fastest tool to return results for the desired task, or the tool that takes up the least amount of memory. Other similar criteria are also possible.
c) a)+User Request to Use An Initial Digital Tool: The user may provide input digital model(s), describe or specify the digital task, and specify an initial tool that the IDMP should use to complete the task. The IDMP may identify a platform function with a variant implemented with the user-specified initial digital tool to complete the desired task, and determine other function variants written in alternative tool(s) that can be offered to the user as alternative selections.
d) c)+Function Variant Generation: In some embodiments, while a platform function may be identified with an initial function variant implemented with an user-specified initial digital tool, it is possible that no other function variant exists. The IDMP may then utilize information stored in database 1356 to identify an isomorphic tool, find tool functions of the isomorphic tool that correspond to tool functions of the initial tool used in the initial function variant, and use an AI-based substitution unit to generate an alternative function variant implemented in the isomorphic tool, for example by replacing the corresponding tool functions. Two isomorphic digital tools comprise corresponding tool functions that perform similar data operations on similar tool function inputs. The IDMP may further use an generative AI unit to create testing scripts to verify that the newly generated function variant is valid, and can be offered to the user as an alternative option.
e) a)+User Request to Use an Alternative Digital Tool: Similar to scenario d), the user may request to use an alternative digital tool, but it is possible that no function variant implemented with the alternative tool exists for an identified platform function that completes the desired task via an existing function variant implemented with an initial digital tool. The IDMP may similarly perform an isomorphic analysis between the initial digital tool and the alternative digital tool, based on usage information of the initial digital tool and of the alternative digital tool retrieved from the digital tool and task history database, API documentation of the alternative digital tool, and the resource-capability mapping of the IDMP. Tool functions of the alternative tool that correspond to tool functions of the initial tool used in the initial function variant may be identified, and an AI-based substitution unit may be used to generate an alternative function variant implemented in the alternative tool, by replacing the corresponding tool functions, and based on results of the isomorphic analysis. The new function variants may be further added to the resource-capability mapping of the IDMP.
f) a)+User Request to Choose Among Multiple Tools: The user may provide input digital model(s), describe or specify the digital task, and specify two or more digital tools that the IDMP can compare to find an optimized tool. The user may also specify one or more criteria for the comparison. The IDMP may identify a platform function that completes the desired task, and with at least a first function variant implemented in one of the input digital tools. The IDMP may then determine if other function variants implemented with the other input digital tool(s) already exist. If so, the IDMP may compare the different function variants to provide an optimal alternative option. If not, the IDMP may generate alternative function variants similar to scenario d).

In the aforementioned exemplary scenarios, an isomorphic analysis may be limited to only tool functions of the initial digital tool called upon by its function variant. Furthermore, in some embodiments, both an initial function variant implemented with the initial digital tool and an alternative function variant implemented with the alternative tool are executed, and their respective outputs may be compared based on one or more evaluation criteria (e.g., cost, computational load, accuracy, precision). The user may be given the option to select a tool with a better performance, and the user selection result may be added to the digital tool and history database as user action data, together with information on the digital task and function variants.

In some embodiments, the IDMP may identify a function variant implemented using the alternative tool, by analyzing digital tool and task history data stored in a digital tool and task history database to pattern-track how the user navigated through the digital platform and the user's tool decisions to complete analogous tasks in the past.

In some embodiments, the execution of the alternative function variant is tracked using a token management unit to complete the digital task using one or more idempotent tokens to avoid duplicate executions.

In some embodiments, the initial digital tool and the alternative digital tool are provided by at least two distinct digital tool providers, where at least one of the initial digital tool and the alternative digital tool is open-sourced.

In some embodiments, a platform script may be modified by the IDMP by replacing an invocation of the first function variant with an invocation of the alternative function variant. In some embodiments, the modified platform script is verified to ensure it generates an identical output as the original platform script, within a given error tolerance or threshold.

Furthermore, recall that digital workflows are typically rather complex digital tasks involving multiple linked digital tools. Tool linking generally refers to jointly accessing two or more digital tools within a platform function. That is, disparate digital tools and tool functions may be called upon jointly to perform a digital task. In addition to the illustrative examples above where alternative tools are suggested individually, in some embodiments, multiple alternative tools and tool functions may be suggested and selected collectively for a specific workflow and its associated tools, where the sequence and inter-dependencies of tools and functions are central to achieving desired outcomes. To ensure robustness, the IDMP may use Continuous Compliance (CC) mechanisms that leverage automated software validation test scripts to dynamically validate alternative tool selections against workflow objectives and dependencies. For example, platform function variants that deploy different combinations of digital tools and/or digital tool functions may be unit-tested to ensure that compliance with functional and operational requirements are maintained when function variants are replaced within workflows, thus minimizing risks associated with tool substitutions or workflow optimizations.

FIG. 17 is an exemplary system diagram 1700 for implementing an alternative digital tool selection process on the IDMP, in accordance with some embodiments of the present invention. In this illustrative example, a non-transitory physical storage medium 1790 is provided to store program code 1792, the program code executable by a hardware processor 1795 to cause the hardware processor to execute computer-implemented processes, including completing a digital task using a variant of an IDMP function 1760 implemented using an alternative digital tool as suggested by the IDMP.

In some embodiments, program code 1792 comprises code to receive user input 1710, which may include a user request, one or more digital model files, and other user input data such as user identity, access level, authorization and authentication credentials, and the like. An input digital model file may be in a native file format. In some embodiments, user input 1710 may be received from a user 1702 through a user interface (UI) 1704. User 1702 may be a human or a computing entity, and UI 1704 may be a graphical UI (GUI), a code interface such as an API/SDK interface, or a multimodal interface as discussed with reference to FIG. 5. For example, user 1702 may represent an artificial intelligence (AI)-based software unit that intends to find an open-source alternative to a proprietary digital tool to perform a digital task or run a digital thread with. In some embodiments, user 1702 may provide additional inputs for alternative tool selection. Exemplary user input include, but are not limited to, indication of accessibility to an initial digital tool (e.g., EXCEL), proprietary licenses or access codes for using proprietary digital tools, preferences for an alternative tool (e.g., LIBREOFFICE) or type of alternative tool (e.g., open-sourced), preference for tool selection criteria (e.g., cheaper, faster, more accurate, higher fidelity, etc.), and the like. In some embodiments, the one or more digital model files may be received directly from a data source, for example, retrieved from an internal database or a cloud-based storage service.

An analysis/comparison/recommendation engine 1752 function as a core processing unit, and may analyze user input 1710 to determine the desired digital task to be completed, and may identify an IDMP function 1760 from a digital tool and task history database 1756, which in turn may comprise a resource-capability mapping, digital tool catalog and APIs for various digital tools 1720 that have been integrated into the IDMP, historical user action data, and platform function execution data (e.g., tuples of user-request/prompt, digital tools or platform functions deployed, digital task or workflow completed, output generated, and performance measurements or comparison results). Engine 1752 may be implemented as a rule-based expert system or comparator, a ML/AI-based analyzer or recommender, or any combinations thereof.

IDMP platform function 1760 comprises function metadata 1764 and is associated with a function schema 1762 that any of its variants such as 1766 and 1768 must comply with. An exemplary schema 1763 for an extract platform function on the IDMP is shown, including fields for tool commands, pointers to tool function schemas, and other metadata on the operating system and tool versions that a function variant is compatible with.

As in the various embodiments discussed in the contexts of FIGS. 13-16, engine 1752 resides in an analysis/control plane (e.g., 1450 in FIG. 14) of the IDEP, and may be used to perform any of the process steps 1402 to 1416 shown in FIG. 14, or process steps 1610 to 1660 shown in FIG. 16. Assuming that function variant 1766 is associated with an initial digital tool and function variant 1768 is associated with an alternative tool, the input digital task may be completed on the input digital model files using one or both of the function variants, based on the user input and the particular deployment scenario of the invention.

Again, generalizing digital tasks to include digital workflows, the execution of a function variant and the completion of a desired digital task can be viewed as operating an IDMP application 1780. The execution of IDMP application 1780 may involve one or more model splices such as 1784, accessible through model splice APIs 1782, and may carry out a digital thread 1786 as a workflow implemented via an orchestrate script.

In various embodiments of the present invention, one or more additional software units or software modules may be implemented within IDMP 1701. For example, a scripting unit 1790 may utilize AI-assistance to generate platform scripts as alternative function variants. An ML training, fine-tuning, and validation unit 1792 may train, fine-tune, and/or validate ML and AI models (e.g., within engine 1752) using historical data stored in digital tool and task history database 1756. A substitution unit 1794 may utilize AI-assistance to substitute function calls of tool functions from an initial digital tool, with isomorphic or analogous tool function calls from an alternative digital tool. A documentation unit 1796 may generate a resource-capability mapping entry for an alternative function variant, possibly using AI-assistance. A token management unit 1798 may utilize idempotent tokens to monitor task execution.

### Agent-Based Implementation of the IDMP and Support for Alternative Tool Selection

In another exemplary embodiment of the IDMP, alternative tool selection can be deployed over agents that operate within the platform's architecture. Agents may be installed on an IDMP exclave (e.g., 316 in FIG. 3), and may execute tasks assigned by a Jobs Service, leveraging dynamically installed modules, described in more detail in the next subsection. In this exemplary implementation, an IDMP module or a module is a self-contained software component of the IDMP that encapsulates functionality for performing specific tasks or actions on behalf of a user. Modules represent a collection of functions that can be run on digital models, and may be implemented as a collection of platform scripts. A resource-capability mapping is a structured representation that includes the relationship between data resources (e.g., files, datasets, or other inputs) and functions capable of operating on them. A function is a discrete operation or action that a module can perform, defined by the module's capability to process specific types of resources (e.g., mode type files, data artifacts) or inputs. A function variant is a version of a function to operate in a specific context, such as a particular operating system, third-party tool, open-source tool or by resource type.

Each agent may maintain a directory of installed modules, which include manifest files (e.g., metadata) that define the modules' capabilities, such as supported resource types, functions, and function variants. Upon registering with the IDMP, agents may communicate their available capabilities to the platform enclave. This registration enables the enclave to maintain a dynamic mapping of agent capabilities, ensuring that the Jobs Service assigns digital model tasks optimized for the agents' capabilities.

Agents may periodically query the Jobs Service for tasks that match their capabilities. Tasks may be assigned to agents in a zero-trust manner using attribute-based access control (ABAC) or relationship-based access control (ReBAC), facilitated by a permissions layer in the enclave. Once assigned a task, the agent may reference its installed modules to identify the appropriate platform function or function variant required for task execution.

This agent-based implementation supports alternative tool selection by leveraging a resource-capability mapping embedded within the module manifests. For instance, if a task specifies a function but multiple function variants are available (e.g., for different tools, operating systems, or versions), the platform may dynamically narrow the options based on the agent's capabilities during the alternative tool selection process, ensuring the task is executed using the most compatible and efficient variant. This process enhances system performance, modularity, and support for alternative tool execution across diverse environments.

Similar to the different exemplary scenarios listed under the discussion of FIG. 16, in certain embodiments, agents may directly implement a platform function variant for a tool requested by the user. In other embodiments, agents may suggest an alternative tool and its associated platform function variant, and upon user approval, execute the task using the alternative tool. Additionally, in some embodiments, agents may suggest alternative function variants for the same tool tailored for different environments (e.g., operating systems, cloud configurations, or software versions) and await user input for selection before proceeding with execution.

### IDMP Modules and Functions as Related to Alternative Tool Selection

This subsection discusses platform function, function variant, and resource-capability mapping in the context of the exemplary IDMP implementation built upon agents and modules.

Specifically, a module is a self-contained software component of the IDMP that encapsulates functionality for performing specific tasks or actions on behalf of a user. Modules represent a collection of functions that can be run on digital models, and a module may be implemented as a collection of platform scripts. Each module is designed to be reusable and operates either independently or in conjunction with third-party tools and libraries. A module includes a manifest (e.g., metadata) that declaratively specifies its capabilities, such as the functions it supports, the types of resources it can act upon, and its compatibility with different operating environments, such as operating systems or tool versions. In many embodiments, such a structured representation of resources and functions capable of operating on them is called a resource-capability map. Module manifests can include a resource-capability map in an explicit manner or implicitly in the details of the functions available for various resources. Modules may dynamically register with the platform in an agent-based deployment, enabling efficient task assignment and execution, and support versioning to maintain compatibility across diverse environments.

A resource-capability mapping is a structured representation of the relationship between resources (e.g., files, datasets, or other inputs) and the functions capable of operating on them. This mapping may be implemented within module manifests, where each platform function schema specifies the types of resources the platform function supports and the operations it can perform. By embedding the resource-capability mapping in the module manifests, the platform can dynamically identify suitable functions for a given task, facilitating efficient and scalable task assignment. In some embodiments, such mapping eliminates the need for centralized resource-function databases and enhances modular extensibility by allowing resource-function relationships to evolve with updates to individual modules. In other embodiments, the IDMP may include a centralized resource-capability mapping that provides an outlook of all the functions across all modules that are available for operations on the IDMP platform.

A function is a discrete operation or action that a module can perform, defined by its capability to process specific types of resources (e.g. model type files, data artifacts) or inputs. Functions are the operational units of a module and can act on resources such as files, data structures, or APIs. Each function is described within the module manifest using a schema that specifies its input parameters, output formats, and compatibility with resource types and execution environments. Functions form the fundamental interface between the user's requested tasks and the underlying module operations, enabling the execution of targeted actions on defined resource types.

A platform function variant or function variant is a version of a function tailored to operate in a specific context, such as a particular operating system, third-party tool, open-source tool or by resource type. Function variants allow the same high-level operation to be executed under varying conditions by adapting to the environmental variables, dependencies, and tool versions present at runtime. A module manifest specifies each variant's compatibility, such as operating system requirements or tool-specific configurations, ensuring seamless execution in diverse environments. This approach supports scalability by enabling multiple function variants to coexist, allowing systems to dynamically select the most appropriate variant for a given task.

### Scalability of Implementation Using IDMP Modules

The scalability of the IDMP's implementation of modules is achieved through its dynamic and modular architecture, which integrates components seamlessly while minimizing dependencies on the platform's core structure. Agents in the IDMP may support multiple modules simultaneously, with each module providing specific functions and capabilities defined in its manifest. The platform dynamically registers the capabilities of installed modules and assigns tasks using the resource-capability mapping. Tasks are allocated in a zero-trust manner, leveraging Attribute-Based Access Control (ABAC) or Relationship-Based Access Control (ReBAC) to ensure secure and efficient operations.

FIG. 18 is an exemplary schematic diagram 1800 illustrating the orchestration of agents in an IDMP exclave, in accordance with some embodiments of the present invention. Specifically, a tool agent 1815 within an exclave 1810 monitors agent status and advertises its select capabilities while polling for new jobs. For example, tool agent 1815 may poll a Job Service 1870 with requests such as 1825 to inquire if there are any jobs available for it to perform, using one or more digital tools (e.g., under MATLAB, to extract from csv files in EXCEL, or to get file size in WORD). Each of these jobs may be handled by an individual module integrated within tool agent 1815. Job Service 1870 may respond with a message 1830 to point tool agent 1815 to a job_description.json file stored via a File Service 1890. These job descriptions may be built upon new job requests such as 1820 received by Job Service 1870. Tool agent 1815 may also broadcast to an Orchestration Service 1880 with messages such as 1840, identifying itself as a new agent and providing a list of its capabilities, or 1845, providing a link to its status file stored via File Service 1890. If a user 1805 probes Orchestration Service 1880 with an inquiry 1850 on tool agent status, a response 1855 may be provided.

In general, agents (e.g., tool agent 185) within the exclave 1810 may periodically communicate their operational status and installed capabilities to the enclave in the platform (e.g., 302 in FIG. 3). This ongoing communication allows the platform to maintain an accurate and real-time understanding of active agents and their readiness to execute tasks. The system may dynamically filter and match tasks to agents based on their specific capabilities, ensuring efficient and precise task allocation. Furthermore, agents may feature lifecycle management capabilities, enabling modules to be activated, deactivated, or updated without interrupting ongoing processes. By supporting multiple versions of platform functions and modules, as well as granular function variants for diverse tools, operating systems, and configurations, the IDMP ensures robust compatibility and adaptability. These capabilities enable seamless alternative tool and function variant selections, allowing the platform to scale efficiently and handle increasing task complexity and volume while maintaining high performance and flexibility.

In what follows, several exemplary use cases for alternative tool selection within the IDMP are presented.

### Exemplary Use Case: An MBSE-Based Digital Thread

FIG. 19 shows an exemplary schematic illustrating implementation steps for digital thread creation on the IDMP from input Model-Based Systems Engineering (MBSE) model files as uploaded by a user for a particular user application, with options for alternative tool selection, according to some embodiments of the present invention. In this illustrative example, users have the option to use multiple tools for the same purpose and compare performance across cost, compute power, overall error, or other performance metrics, in every stage of the digital thread. Process steps involving alternative tool comparison and selection are highlighted with thickened lines.

As described earlier with reference to FIG. 2, an IDMP may include a user device1906A, API1906B, or other similar human-to-machine, or machine-to-machine communication interfaces operated by a user 1904. The IDMP may further comprise a computing and control system1908 (“computing system1908” hereinafter) connected to and/or including a data storage unit1918, an artificial intelligence (AI) engine1920, and an application and service layer 1922. In some implementations, the data from multiple uses of the IDMP (or a portion of said data) can be aggregated to develop a training dataset. For example, usage records 1917 collected via computing system 1918 may be de-identified or anonymized, before being added to the training set. As described earlier with reference to FIG. 2, a digital workflow involving product certification may take in as input various digital tools 1931 and information from a repository of common Verification & Validation (V&V) products 1941.

In creating a digital thread, a user may upload a digital model file (e.g., MBSE) to the IDMP, which upon receiving the digital model file, analyzes the file to extract relevant information. An artificial intelligence (AI) algorithm may suggest appropriate model splice functions and parameters for the model file and a user-requested digital task, and create a set of model splices or wrappers for V&V purposes. That is, the system generates one or more splice function scripts using API calls from the relevant digital tool and in this process creates model splice API endpoints that return relevant digital artifacts (e.g., an analysis result file). Using the model splice API endpoints, multiple model splices or wrappers can be linked into a digital thread. Corresponding digital tools may be connected with the wrappers (e.g., tool functions are called upon in splice function scripts accessible via the wrappers), and corresponding digital tools may be linked in sequence (e.g., output from a first digital tool may be fed into a second digital tool as input). Under this paradigm, the repository 1941 of common V&V products may monitor the digital thread, particularly after corresponding digital tools are linked in sequence. User inputs may refine and execute the digital thread. Thus, the system as presented links two or more models, with or without AI-assistance, to create a digital thread. Progressive linking of models may lead to complete or partial digital threads. The process can be repeated with additional files to create links between multiple files, and an AI or machine learning (ML) engine can learn from the use of API endpoints to provide better recommendations for connecting digital models in the future.

When the option of alternative tool selection is offered, a user 1904 may first upload one or more MBSE files at a step 1951 onto the IDMP for the creation of and execution within a digital thread. The IDMP, upon receiving the MBSE file at a step 1953, may first analyze the MBSE file at a step 1955 to extract relevant model data and information. User 1904 may provide text inputs (e.g., search terms for digital tasks and/or digital tools) at a step 1956, and the IDMP analyzes related digital tools at a step 1957 for the user-requested task. Service calls may be initiated, so that an initial digital tool (e.g., as identified by the user, or a default tool provided by the IDMP) may be compared at a step 1958 against tools within a task history and tool repository and as described by a resource-capability mapping, so that similar tools may be suggested to the user as alternatives at a step 1960. A digital thread may involve multiple digital tools, and a combination of several alternative tools may be suggested at step 1960. A first AI algorithm may then create a set of MBSE model splice/wrappers for the requested task(s) at a step 1961, with splice functions comprising API function calls to corresponding digital tools 1963, and possibly based on further user feedback 1959 to use alternative tools. Such model splices may be linked or connected via platform or orchestration scripts that call upon corresponding digital tools, for example with AI assistance at a step 1967, to create a digital thread at a step 1969. That is, one or more platform function variants may be created by an AI algorithm (2) at process step 1967, each utilizing different combinations of digital tools. Each platform function variant is a digital thread that provides a template for linking corresponding digital tools in sequence 1965 into a digital workflow, for execution by the IDMP. In some embodiments, further user inputs 1973 may be received to refine linkages among the models and digital tools in the digital thread, with the repository of common V&V products 1941 monitoring the digital thread at a step 1971.

As a specific example of the process shown in FIG. 19, consider a user providing text inputs or prompts to link a Computer-Aided Design (CAD) file and an Finite Element Analysis (FEA) model to generate a list of digital artifacts (e.g., stresses, strains, simulation data) that are incorporated into a certification report. The user may or may not identify a preferred digital tool. If a preferred digital tool is identified, the system may provide a list of alternative tools. If a preferred digital tool is not identified, the system may provide a list of tools that can be used on the input model type file to achieve the user requested task. The system compares the requested task of generating the digital artifacts and generating the certification report with past task history and corresponding tool usage patterns in its database, and suggests one or more FEA tools for the user to select from. The system may also present to the user a list of tool functions offered by each suggested tool and are relevant to the requested task. In some embodiments, the system may provide task and tool history records for the user to examine. The user may in turn provide inputs (e.g., inquiry on a suggested digital tool function, tool selection decision) for the system to create one or more model splices/wrappers for completing the requested task using a selected tool. Next, an AI algorithm may create the necessary model splices or wrappers, including splice function scripts that calls upon the selected digital tool and tool function APIs to generate the desired digital artifacts. Another AI algorithm may check the scripts, and link the CAD file and the FEA model together by calling the splice functions which serve as API endpoints to the input models or generated model splices. A machine learning engine may log the use of model splice API endpoints and learn the relation between them. The user may provide further inputs to refine and execute the digital thread to complete the desired task of design certification, and user inputs, selected digital tools, tool functions used, and other relevant metadata may be stored in a digital task history and tool database or repository for training of an AI recommender or for future tool comparison and analysis.

### Exemplary Use Case: Enhancing DE Simulations Through Alternative-Tool Integration

As another specific use case for alternative tool selection, FIG. 20 shows an illustrative process 2000 for implementing the selection of alternative simulation tools for the same design space during digital engineering (DE) simulation, in accordance with some embodiments of the present invention.

Simulations are integral to DE, providing a means to test and evaluate designs under various scenarios. Traditional approaches often rely on a single simulation tool, leading to constraints to the solution space. Such constraints may be attributed to legacy systems, time constraints, and switching costs, and other similar factors. The introduction of the IDMP addresses these challenges by facilitating the integration of multiple simulation tools into respective platform function variants. Such integration not only expands the accessibility of the design space but also diversifies the output datasets, thereby allowing for a more comprehensive evaluation of potential design performances.

The IDMP's ability to link a diverse range of simulation tools significantly enhances simulation capabilities within DE workflows. The IDMP ensures seamless integration of design inputs and simulation parameters across various tools, thus circumventing the limitations of using a single tool but also enriching the solution space with varied data outputs. The outcome is a more comprehensive understanding of design performance across multiple scenarios, fostering innovative solution exploration.

Alternative-tool or cross-tool linkages facilitated by the IDMP can be pivotal for generating training data for machine learning (ML) models. The IDMP makes the design space easily accessible for multiple tools by linking the design inputs and the modeling and simulation parameters. By training ML models on a wide range of simulation data, the platform enhances its predictive capabilities, enabling it to anticipate modeling and simulation outcomes with reduced error margins. This advancement not only streamlines the simulation process but also bolsters the accuracy and reliability of simulation outcomes, effectively broadening the simulation solution space in digital engineering.

Specifically, FIG. 20 describes how the selection of alternative simulation tools for the same design space may be implemented in the IDMP, resulting in additional training data for the same design space that can be used for ML models. Upon initiation, the user uploads a digital model to the IDMP at a process step 2010. Next, at a step 2020, scripts may be executed, to generate multiple variants of the digital model to define a design space (e.g., by varying parameters or adding perturbations). The user may then link, at a step 2030, the digital model to a simulation tool he or she has access to within the environment (e.g., under a commercial license). Concurrently, an expert may select, at a step 2035, an alternative tool (e.g., an open-source tool) to run simulations on the same design space. Simulation results for the model variants using different digital tools may be reviewed by an expert at a step 2040, who decides which tool may be better suited for the customer need and performance needs, and/or which design variants are better, at a step 2050. Input models, design spaces, simulation results, and expert feedback may all be collected in a system database 2015 for use to train an ML module. An “expert” in FIG. 20 may refer to a human user or an ML/AI algorithm trained on historical data.

### Tool and Task History as Training Data

Thus, the IDMP may provide users with the data capture of individual steps in their workflows and also capture the overall design space. The tool and task history that serve as reference in alternative-tool selection may serve as training data for improving user experience, workflow improvements and for training machine learning models that assist users in the platform.

### Token Management for Task Execution

FIG. 21 shows an illustrative data flow when a requested digital task is assigned to a tool and tracked using idempotent tokens to avoid duplicate executions, in accordance with some embodiments of the present invention. The use of idempotent tokens allows the IDMP to reliably assign the requested task to different digital tools, for better cost control or to meet user preferences. An API call, operation, or requested task is idempotent if it has the same results no matter how many times it is applied. That is, making multiple identical task requests has the same effect as making a single request. An idempotent operation provides protection against accidental duplicate calls or task executions that may waste resources or have unintended consequences. The IDMP as disclosed herein utilizes idempotent tokens to preserve data sovereignty while tracking tool usage consistently.

Specifically, token management is described in detail in U.S. patent application Ser. No. 18/899,772, filed on Sep. 27, 2024, and PCT Application No. PCT/US24/49072, filed on Sep. 27, 2024, both incorporated by reference in their entireties herein. A function is designated as idempotent if the function can execute multiple times without side effects. These functions are state-invariant. For example, pressing the “close doors” button on an elevator can be deemed to be idempotent operation because pressing the button multiple times causes the desired action to occur only once. Idempotent tokens can be fungible or non-fungible. A fungible idempotent token (FIT) presents an externally visible representation of the requested work to the IDMP. It can encapsulate specific request elements that include, for example, the initiating tenant or requesting account/user ID, the requested tool/function, and the intended model for execution. A non-fungible idempotent token (NFIT) can be data that represent an internal construct used by operators. The NFIT can incorporate similar elements used by the FITs with an included selected digital tool constraint. FIT and NFIT can be created in pairs, where the FIT represents a request that can be fulfilled by various digital tools and the NFIT represents a unit of work being completed by a certain digital tool. That is, FIT and NFIT may be used to decouple the work being requested from the work actually being performed. An FIT identifies the work being requested, and an NFIT identifies the work actually being performed at a digital tool according to the user request.

In FIG. 21, a Jobs Service layer 2125 may generate, store, and validate both FITs and NFITs. For example, a Control Plane 2110 in an IDMP 2100 may create and issue fungible tokens, and a splicing plane implemented in a customer environment (e.g., “Data Plane 2120” in FIG. 21, implemented within an agent that is behind the customer firewall) may issue non-fungible tokens. The data flow shown in FIG. 21 presents a method for estimating a performance of a task at one or more tools using idempotent tokens. Here the Jobs Service layer 2125 estimates the cost or performance for a digital tool to perform a user-request. In some implementations, the Job Service layer 2125 may include an analysis engine to evaluate the suitability of a digital tool for the user request, for example by estimating the cost of computation for the user request and route the request to the cheapest digital tool that can fulfill the request. Such cost estimations may utilize prior benchmarks and selectively query specific DE tools on a customer environment.

In one illustrative example, a user request of “getParts” for a digital request may be performed across two digital tools. The user may issue an HTTP request to an API Gateway 215 of the IDMP. The HTTP request may include a request for a getParts wrapper on a digital model that the user previously uploaded to the IDMP. API Gateway 2125 may respond to the user with an HTTP code and a FIT for the request. The request may poll at an interval until the HTTP status request returns a status code OK, with the output of getParts.

Next, API Gateway 2125 may request getParts on the requested model from Job Service layer 2125. Job Service layer 2125 may query a jobs database to determine which digital tool of a set of digital tools has performed getParts with the lowest compute cost. In response, Job Service layer 2125 may select the digital tool from the set to perform getParts that has the lowest compute cost, e.g., select the digital tool whose compute cost satisfies (meets or falls below) a threshold value. Job Service layer 2125 may select the digital tool whose prior compute costs meet this criterion to provide the request. The job database may return that a digital tool 1, for example, has the lowest cost for this model/task. In some cases, Job Service layer 2125 may select any digital tool to perform an operation such as getParts, in the event that the jobs database does not have a compute cost for a particular digital tool. In some cases, Job Service layer 2125 may obtain cost performances for each of the digital tools from third parties and other external services.

Furthermore, Job Service layer 2125 may create an NFIT for its request to the digital tool 1 to execute getParts on the requested model/splice, saving the NFIT with this job in the jobs database. The digital tool executes getParts and saves the output of getParts with the FIT to cache future lookups. On any subsequent request to API Gateway 2115 to getParts on this model/splice, the FIT's request is now fulfilled and will be returned by API Gateway 2115 to the user.

### Exemplary Use Case: Cost-Efficient Alternative Tool Use in Certification

FIG. 22 presents an overview 2200 of approaches within the IDMP to simplify certification workflows, in accordance with some embodiments of the present invention. The certification process 2204 involves the use of various digital tools to process digital model files in order to parse digital artifacts, map to paragraphs, and build sections that constitute a target certification document. Such a complex process may be represented by a workflow data structure, where each node represents a specific task, and each inter-node connection represents a data flow required between related tasks. In FIG. 22, the certification workflow data structure is represented as a directed acyclic graph (DAG) 2202. Alternative tool selection is applicable to any task node or groups of task nodes.

A workflow optimization process may be carried out at an analysis and control plane 2206 (e.g., see Analysis and Control Plane 150 in FIG. 1). FIG. 22 shows three illustrative approaches within the IDMP to simplify certification workflows:
1. Representing User Journey Progress: This method 2208 uses visual management of progress to enable users to better prepare for the overall certification process. It involves the use of the digital platform's UI tools to represent DAG progress towards certification (e.g., see FIG. 10), thus enabling the detection of redundancies and inefficiencies. In one embodiment, the IDMP may keep a database of user actions to reconstruct workflows of specific processes (e.g., certification). Workflow datasets may thus be assembled over the IDMP to train machine learning models to detect inefficiencies and reduce redundancies, or to predict efficient task orders, as discussed below.
2. Workflow Simplification: This method 2210 uses graph theory algorithms to simplify workflow data structures (e.g., DAGs). Multiple algorithms may be applied, including algorithms that generate a minimal spanning tree of a DAG, identify the most prominent nodes in the DAG, or eliminate redundant nodes and/or edges.
3. Workflow Prediction: This method 2212 uses machine learning models to offer predictive analysis to users based on their current action (e.g., a selected digital model, a step of the certification process, etc.). In one embodiment, a certification workflow prediction ML model may train on training datasets composed of multiple digital certification workflows represented as DAGs. More generally, the ML models may be trained on training data sets composed of workflows represented as DAGs, where the workflows are not limited to certification workflows. In one embodiment, a dataset including various workflows, each paired with an efficient followup task, may be used to train a workflow prediction machine learning model to predict the next task of a workflow.

The use of an IDMP that converts certification processes into scripted digital threads simplifies the certification process, enhancing operational efficiency and resource management. In the context of the three outlined approaches, the system is effective in identifying and reducing redundancy, thereby optimizing the utilization of time and resources. Alternative tool selection may provide further optimization gains. Visual management of the certification process is facilitated through the visualization of the digital thread within IDMP UI tools 2220, including the various user interfaces described in FIG. 5, including 3D visualization interfaces with VR, AR, audio, text, and/or code 2222, dashboard-style interfaces 2224, and workflow-based interfaces 2226. Using visualization tools helps detect and mitigate workflow inefficiencies and associated risks. The methods also provide cost-effective solutions by increasing efficiencies and eliminating unnecessary processes, or substituting in more efficient tools. The integration of machine learning models provides a predictive analytics capability, enabling users to make informed decisions at each step of the certification process, enhancing the overall approach to certification.

In the context of the three outlined strategies, the guidance offered to the users helps users navigate the complexities inherent to the certification process and streamline their efforts towards efficient certification. These strategies also manage users' expectations and enhance the user experience. Overall, these guidance methods, coupled with the capacity to reduce redundant steps, substitute in more cost-effective tools, and predict potential process pathways, improve the overall efficiency of the certification system. The methods and processes described herein apply beyond certification to any digital thread represented by a workflow data structure.

### Exemplary Use Case: CAD Model Evaluation

The methods and systems disclosed herein may provide improvements for efficiently generating, revising, and evaluating computer-aided design (CAD) models within a simulation environment. FIGS. 23-24 show how an illustrative example of evaluating CAD models within a simulation environment can be enhanced through the IDMP, according to examples disclosed herein.

In a conventional example of evaluating CAD models within a simulation environment, a CAD model subject matter expert (SME) may utilize custom CAD software to produce multiple versions of an input CAD model. Subsequently, these iterations are processed through specific scripts before being introduced into a simulation environment. This simulation environment may encompass three digital tools: a mesher, a computational fluid dynamics (CFD) solver, and an output visualization tool, with additional customized scripts acting as interfaces between the different digital tools and the simulation environments. Upon finishing the simulations, a comprehensive report containing simulation outcomes and results may be generated. A separate CFD SME may then review this report to evaluate the optimizations. Necessary feedback and modifications to the model parameters may be relayed to the CAD model SME, who manually revises the models in a similar systematic manner.

Within the IDMP, a more efficient procedure for evaluating CAD models may be implemented. Initially, the IDMP model splices the given CAD model, and these splices may be used to create multiple CAD model variants within the IDMP's application plane (e.g., see FIG. 1), which are then passed to subsequent scripts in a simulation environment. Additional scripts (e.g., splice function scripts, other IDMP platform scripts) may act as interfaces between the different digital tools, the simulation environment, and the IDMP. The CFD model may also be spliced, and the resulting data may be directed to an analysis module within the IDMP's analysis plane (e.g., see FIG. 1) for the CFD SME to make decisions on an authoritative reference design (e.g., authoritative twin) or suggest revisions to the CAD model parameters. In some embodiments, the CFD SME may be assisted by AI tools for various operations such as the selection of an authoritative reference design (e.g., authoritative twin). In this setup, each listed digital tool may be analyzed for alternatives for the CAD model evaluation task.

FIG. 23 shows an example of evaluating CAD models within a simulation environment, enhanced through orchestrated digital threads over the IDMP, in accordance with the examples disclosed herein. In this illustrative figure, the IDMP is referred to as an IDEP 2330. Here a CAD model 2302 is input to the IDEP 2330 through an IDEP platform API 2314, where a series of digital tools are enabled, including a mesher, a CFD analysis tool, a visualization tool, a Finite Element Analysis (FEA) tool, and an overall cost model. Various corresponding models 2304-2312 may be generated from the CAD model 2302 using these tools. Each of the generated models are spliced in the splicing plane (e.g., see FIG. 1) of the IDEP 2330. Splicing provides each of the generated models with an IDEP platform API 2314-2324 enabling it to be accessed through the IDEP 2330 to be connected with other models, to be updated, to be executed, etc. Additionally, the application plane of the IDEP 2330 links the model splices together into a digital thread through engineering orchestration scripts 2336, where multiple digital threads 2332 can be generated, one for each iteration of the CAD model 2302. As discussed in the context of FIG. 10, the orchestration scripts may therefore be structured as Directed Acyclic Graphs (DAGs) 2334, allowing model updates to be interconnected and carried out as pipelined DAG tasks linking the splices with a range of corresponding parameter values. Furthermore, orchestration scripts may include isomorphic analyses to suggest alternative tools at every step, and incorporation of user feedback additionally.

The use of model splicing and orchestration scripts facilitates adaptability and flexibility in the CAD model analysis and revision processes. In addition, the methods described herein enable a more scalable and comprehensive workflow for analyzing and refining CAD models across various tools.

FIG. 24 shows an example of evaluating CAD models within a simulation environment, further enhanced through AI-enabled processes over the IDEP, in accordance with the examples disclosed herein. In various embodiments represented by FIG. 24, input CAD model variants, modeling and simulation parameters, simulation results, and SME decisions serve as training data for AI models 2402-2414, automating aspects of data review for future simulations. Again, orchestration scripts may include isomorphic analyses to suggest alternative tools at every step, and incorporation of user feedback additionally.

### Machine Learning (ML) and Neural Networks

Machine learning (ML) algorithms are characterized by the ability to improve their performance at a task over time without being explicitly programmed with the rules to perform that task (i.e., learn). An ML model is the output generated when a ML algorithm is trained on data. As described herein, embodiments of the present invention use one or more artificial intelligence (AI) and ML algorithms. Various exemplary ML algorithms are within the scope of the present invention. The following description describes illustrative ML techniques for implementing various embodiments of the present invention.

### Neural Networks

A neural network is a computational model including interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 25 describes neural network operation fundamentals, according to exemplary embodiments of the present invention.

FIG. 25 shows a single-layered neural network, also known as a single-layer perceptron. The operation of a single-layered neural network involves the following steps:
1. Input: Receiving a DE input vector v 2504 with elements vⱼ, with j∈[1, n] representing the j^{th} DE input, and where each element of the vector corresponds to an element 2506 in the input layer. A DE input can be a user prompt, a DE document, a DE model, DE program code, system data from the IDMP, and/or any useful form of data in digital engineering.
2. Transfer Function: Multiplying each element of the DE input vector by a corresponding weight wⱼ 2508. These weighted inputs are then summed together as the transfer function, yielding the net input to the activation function

$${\sum }_{j = 1}^{n} {v}_{j} \cdot {w}_{j} 2510.$$

Each neuron in a neural network may have a bias value 2512, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${\sum }_{j = 1}^{n} \{ {v}_{j} \cdot {w}_{j} \} + b .$$

3. Activation Function: Passing the net input through an activation function 2514. The activation function σ determines the activation value o 2518, which is the output of the neuron. It is typically a non-linear function such as a sigmoid or ReLU (Rectified Linear Unit) function. The threshold θ 2516 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
4. Output: The activation value o 2518 is the output of the activation function. This value is what gets passed on to the next layer in the network or becomes the final DE output in the case of the last layer. A DE output can also be an updated twin configuration, digital twin, physical twin, DE document, DE model, DE program code, or any useful form of data in digital engineering.

FIG. 26 shows an overview of an IDMP neural network training process, according to exemplary embodiments of the present invention. The training of the IDMP neural network involves repeatedly updating the weights and biases 2610 of the network to minimize the difference between the predicted output 2604 and the true or target output 2606, where the predicted output 2604 is the result produced by the network when a set of inputs from a dataset is passed through it. The predicted output 2604 of an IDMP neural network 2602 corresponds to the DE output 2518 of the final layer of the neural network. The true or target output 2606 is the true desired result. The difference between the predicted output and the true output is calculated using a loss function 2608, which quantifies the error made by the network in its predictions.

The loss function is a part of the cost function 2608, which is a measure of how well the network is performing over the whole dataset. The training goal is to minimize cost function 2608. This is achieved by iteratively adjusting the weights and biases 2610 of the network in the direction that leads to the steepest descent in the cost function. The size of these adjustments is determined by the learning rate 2608, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 2610 of the network based on the error (e.g., cost function) 2608 of the output. After forward propagation through the IDMP neural network 2602, the output 2604 of the network is compared with true output 2606, and the error 2608 is calculated. This error is then propagated back through the network, starting from the output layer and moving towards the input layer. The weights and biases 2610 are adjusted to minimize this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 27 provides additional details on the training process or an IDMP machine learning model, according to exemplary embodiments of the present invention.

### Transformer Model Architecture

The transformer architecture is a neural network design that was introduced in the paper “Attention is All You Need” by Vaswani et al. published in June 2017 (available at arxiv(dot)org/abs/1706.03762), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 27 is an illustrative flow diagram showing the different phases and datasets involved in training an IDMP ML model, according to exemplary embodiments of the present invention.

The training process starts at step 2710 with DE data acquisition, retrieval, assimilation, or generation. At step 2720, acquired DE data are pre-processed, or prepared. At step 2730, the IDMP ML model is trained using training data 2725. At step 2740, the IDMP ML model is evaluated, validated, and tested, and further refinements to the IDMP ML model are fed back into step 2730 for additional training. Once its performance is acceptable, at step 2750, optimal IDMP ML parameters are selected.

Training data 2725 is a dataset containing multiple instances of system inputs and correct outcomes. It trains the IDMP ML model to optimize the performance for a specific target task, such as the prediction of a specific target output data field within a specific target document. In FIG. 27, training data 2725 may also include subsets for validating and testing the IDMP ML model, as part of the training iterations 2730 and 2740. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2725 may be expanded via a document database augmentation process.

In some embodiments, an additional fine-tuning 2760 phase including iterative fine-tuning 2760 and evaluation, validation, and testing 2770 steps, is carried out using fine-tuning data 2755. Fine-tuning in machine learning is a process that involves taking a selected 2750 pre-trained model and further adjusting or “tuning” its parameters to better suit a specific task or fine-tuning dataset 2755. This technique is particularly useful when dealing with deep learning models that have been trained on large, general training datasets 2725 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 2725, such as ImageNet (available at image-net(dot)org) for image recognition tasks. The model's existing weights, which have been learned from the original training, serve as the starting point. During fine-tuning, the model is trained further on a new fine-tuning dataset 2755, which may contain different classes or types of data than the original training set. This additional training phase allows the model to adjust its weights to better capture the characteristics of the new fine-tuning dataset 2755, thereby improving its performance on the specific task it is being fine-tuned for.

In some embodiments, additional test and validation 2780 phases are carried out using DE test and validation data 2775. Testing and validation of a ML model both refer to the process of evaluating the model's performance on a separate dataset 2775 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 2730, selected 2750, and optionally fine-tuned 2760 and validated/tested 2780, the process ends with the deployment 2790 of the IDMP ML model. Deployed IDMP ML models 2795 usually receive new DE data 2785 that was pre-processed 2780.

In machine learning, data pre-processing 2720 is tailored to the phase of model development. During model training 2730, pre-processing involves cleaning, normalizing, and transforming raw data into a format suitable for learning patterns. For fine-tuning 2760, pre-processing adapts the data to align with the distribution of the specific targeted task, ensuring the pre-trained model can effectively transfer its knowledge. Validation 2780 pre-processing mirrors that of training to accurately assess model generalization without leakage of information from the training set. Finally, in deployment 2790, pre-processing ensures real-world data matches the trained model's expectations, often involving dynamic adjustments to maintain consistency with the training and validation stages.

Unless otherwise stated, the methods and systems disclosed herein regarding training, particularly pertaining to training data collection, generally apply to tuning, fine-tuning, pre-training, and/or post-training.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka(dot)com/blog/2023/llm-reading-list.html), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances and output instances, or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 28 provides illustrative schematics of a server (management computing entity) 2810 connected via a network 2820 to a client (user computing entity) 2830 used within an IDMP, according to some embodiments of the present invention. While FIG. 28 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 28 for a server or management computing entity 2810. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital engineering process.

In one embodiment, management computing entity 2810 may be equipped with one or more communication interfaces 2812 for communicating with various computing entities, such as by exchanging data, content, and/or information (similar terms used herein interchangeably) that can be transmitted, received, operated on, processed, displayed, stored, and/or the like. For instance, management computing entity 2810 may communicate with one or more client computing devices such as 2830 and/or a variety of other computing entities. Network or communications interface 2812 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 2810 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 28, in one embodiment, management computing entity 2810 may include or be in communication with one or more processors 2814 (also referred to as processors and/or processing circuitry, processing elements, and/or similar terms used herein interchangeably) that communicate with other elements within management computing entity 2810, for example, via a bus. As will be understood, processor 2814 may be embodied in a number of different ways. For example, processor 2814 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 2814 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 2814 may be configured for a particular use or configured to execute instructions stored in volatile or non-volatile (or non-transitory) media 2816 and 2818, or otherwise accessible to processor 2814. As such, whether configured by hardware or computer program products, or by a combination thereof, processor 2814 may be capable of performing steps or operations according to embodiments of the present disclosure when configured accordingly.

In one embodiment, management computing entity 2810 may further include or be in communication with non-transitory memory 2818 (also referred to as non-volatile media, non-volatile storage, non-transitory storage, physical storage media, memory, memory storage, and/or memory circuitry similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 2810 may further include or be in communication with volatile memory 2816 (also referred to as volatile storage, memory, memory storage, memory and/or circuitry—similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 2814. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 2810 with the assistance of processor 2814 and an operating system.

Although not shown, management computing entity 2810 may include or be in communication with one or more input elements, such as a keyboard input, a mouse input, a touch screen/display input, motion input, movement input, audio input, pointing device input, joystick input, keypad input, and/or the like. Management computing entity 2810 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 2810 may be located remotely from other management computing entity components, such as in a distributed system. Furthermore, one or more of the components may be combined and additional components performing functions described herein may be included in management computing entity 2810. Thus, management computing entity 2810 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 28 further provides an illustrative schematic representation of a client user computing entity 2830 that may be used in conjunction with embodiments of the present disclosure. In various embodiments, computing device 2830 may be a general-purpose computing device with dedicated modules for performing digital engineering-related tasks. It may alternatively be implemented in the cloud, with logically and/or physically distributed architectures.

As shown in FIG. 28, user computing entity 2830 may include a power source 2831, an antenna 2870, a radio transceiver 2832, a network and communication interface 2834, and a processor unit 2840 that provides signals to and receives signals from the network and communication interface. The signals provided to and received may include signaling information in accordance with air interface standards of applicable wireless systems. In this regard, user computing entity 2830 may be capable of operating with one or more air interface standards, communication protocols, modulation types, and access types. More particularly, user computing entity 2830 may operate in accordance with any of a number of wireless communication standards and protocols, such as those described above with regard to management computing entity 2810. Similarly, user computing entity 2830 may operate in accordance with multiple wired communication standards and protocols, such as those described above with regard to management computing entity 2810.

Via these communication standards and protocols, user computing entity 2830 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 2830 may also download changes, add-ons, and updates, for instance, to its firmware, software (e.g., including executable instructions, applications, program modules), and operating system.

In some implementations, processing unit 2840 may be embodied in several different ways. For example, processing unit 2840 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 2840 may be embodied as one or more other processing devices or circuitry. The term circuitry may refer to an entirely hardware embodiment or a combination of hardware and computer program products. Thus, processing unit 2840 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 2840 may be configured for a particular use or configured to execute instructions stored in volatile or non-volatile media or otherwise accessible to the processing unit. As such, whether configured by hardware or computer program products, or by a combination thereof, processing unit 2840 may be capable of performing steps or operations according to embodiments of the present invention when configured accordingly.

In some embodiments, processing unit 2840 may comprise a control unit 2842 and a dedicated arithmetic logic unit (ALU) 2844 to perform arithmetic and logic operations. In some embodiments, user computing entity 2830 may comprise a graphics processing unit (GPU) 2846 for specialized parallel processing tasks, and/or an artificial intelligence (AI) module or accelerator 2848, also specialized for applications including artificial neural networks and machine learning. In some embodiments, processing unit 2840 may be coupled with GPU 2846 and/or AI accelerator 2848 to distribute and coordinate digital engineering related tasks.

In some embodiments, computing entity 2830 may include a user interface, including an input interface 2850 and an output interface 2852, each coupled to processing unit 2840. User input interface 2850 may comprise any of a number of devices or interfaces allowing computing entity 2830 to receive data, such as a keypad (hard or soft), a touch display, a mic/speaker for voice/speech/conversation, a camera for motion or posture interfaces, and appropriate sensors for spatial computing interfaces. User output interface 2852 may comprise any of a number of devices or interfaces allowing computing entity 2830 to provide information to a user, such as through the touch display, or a speaker for audio outputs. In some embodiments, output interface 2852 may connect computing entity 2830 to an external loudspeaker or projector, for audio and/or visual output. In some embodiments, user interfaces 2850 and 2852 integrate multimodal data in an interface that caters to human users. Some examples of human interfaces include a dashboard-style interface, a workflow-based interface, conversational interfaces, and spatial-computing interfaces. As shown in FIG. 5, computing entity 2830 may also support bot/algorithmic interfaces such as code interfaces, text-based API interfaces, and the like.

User computing entity 2830 can also include volatile and/or non-volatile storage or memory 2860, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 2860 may store an operating system 2862, application software 2864, data 2866, databases, database instances, database management systems, data, applications, programs, program modules, scripts, source code, object code, byte code, compiled code, interpreted code, machine code, executable instructions, and/or the like to implement functions of user computing entity 2830. As indicated, this may include a user application that is resident on the entity or accessible through a browser or other user interface for communicating with management computing entity 2810 and/or various other computing entities.

In some embodiments, user computing entity 2830 may include one or more components or functionalities that are the same or similar to those of management computing entity 2810, as described in greater detail above. As will be recognized, these architectures and descriptions are provided for exemplary purposes only and are not limited to the various embodiments.

In some embodiments, computing entities 2810 and/or 2830 may communicate to external devices like other computing devices and/or access points to receive information such as software or firmware, or to send information from the memory of the computing entity to external systems or devices such as servers, computers, smartphones, and the like.

In some embodiments, two or more computing entities such as 2810 and/or 2830 may establish connections using a network such as 2820 utilizing any of the networking protocols listed previously. In some embodiments, the computing entities may use network interfaces such as 2812 and 2834 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### Terminology

Some illustrative terminologies used with the IDMP are provided below to assist in understanding the present invention, but these are not to be read as restricting the scope of the present invention. The terms may be used in the form of nouns, verbs, or adjectives, within the scope of the definition.

### Digital Engineering

Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.

### IDMP IDEP

Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 1-4). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
AI Agent or Tool Agent: a software entity or module that takes instructions from the enclave and acts on behalf of a user or another program to perform specific tasks or operations related to an AI model or a DE tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is a variable mapping table.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.

### Model Splicing on IDMP IDEP

Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDMP/IDEP API: A library of API scripts available on the IDEP/IDMP as disclosed herein.
API function scripts, “splice functions,” “splice methods,” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice. In some embodiments, as a matter of design choice, a digital artifact is atomic and indivisible in terms of security levels, so that permissions for users to access and/or modify the digital artifact apply to the digital artifact as a whole, and may not apply to segments of the digital artifact. In other embodiments, a digital artifact includes segments that may have different access (e.g., viewing) and modification (e.g., updating) security levels. Consequently, for a given user, an “authorized artifact” for access is an artifact for which all segments fall under an access security level that allows the given user to access (e.g., view) it. Similarly, for a given user, an “authorized artifact” for modification is an artifact for which all segments fall under a modification security level that allows the given user to modify (e.g., update) it.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.

### Digital Threads

Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the digital twin.
Tool linking: Similar to model splice linking, tool linking generally refers to jointly accessing two or more DE tools via model splices, where model splice functions that encapsulate disparate DE tool functions are called upon jointly to perform a DE task.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.

### Digital Twin

Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).

### Security

Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Security Network: Information security networks are security networks that are configured to maintain the confidentiality, integrity, and availability of digital information (e.g., digital model data) through cybersecurity measures such as encryption, firewalls, intrusion detection systems, and access controls. A “security network” is a set of networked resources having identical access control restrictions, where each networked resource provides access to one or more digital model files. In various embodiments, the networked resources of a security network may be determined by one or a combination of the following factors: (1) having a minimum security access level, (2) belonging to a given physical network, (3) belonging to a given customer organization, and (4) belonging to a given business division.
Information Security (Infosec) Levels: Also referred to as “security levels” or “security access levels”, information security (Infosec) levels designate classifications assigned to data and operations based on sensitivity and security requisites, dictating access control and data handling procedures across networks. In some embodiments, an infosec level may define a security network.

### Testing

Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number±10%, such that “about 10” would include from 9 to 11. In other exemplary embodiments, the term “about” may include the recited number±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. One or more non-transitory storage media for completing a digital task using an alternative digital tool, the one or more non-transitory storage media comprising program code executable by a processor, the program code when executed by the processor, causing the processor to:
receive a user request indicative of the digital task involving an input digital model;
retrieve a digital model file of the input digital model, wherein the digital task is to be completed on the digital model file using an initial digital tool within a digital platform;
identify a platform function from a resource-capability mapping of the digital platform, wherein an execution of the platform function completes the digital task on the digital model file, wherein the platform function is associated with a given function schema, wherein the resource-capability mapping provides a correspondence between a given resource on the digital platform and a corresponding capability of the given resource, wherein the given resources comprise tool functions and digital model types accessible on the digital platform, and wherein the corresponding capabilities of the given resources comprise platform functions executable on the digital platform;
identify, from the resource-capability mapping, an initial function variant of the platform function implemented with the initial digital tool, wherein the initial function variant complies with the given function schema;
retrieve, from the resource-capability mapping, an alternative function variant of the platform function implemented with the alternative digital tool, wherein the alternative function variant also complies with the given function schema; and
execute the alternative function variant of the platform function to complete the digital task on the digital model file using the alternative digital tool.

2. The one or more non-transitory storage media of claim 1, wherein the program code when executed further causes the processor to:
receive a user selection of the initial digital tool.

3. The one or more non-transitory storage media of claim 1, wherein the program code when executed further causes the processor to:
receive a user request for the alternative digital tool;
determine that the resource-capability mapping of the digital platform does not include the alternative function variant implemented with the alternative digital tool;
in response to determining that the resource-capability mapping of the digital platform does not include the alternative function variant, perform an isomorphic analysis between the initial digital tool and the alternative digital tool, based on usage information of the initial digital tool and of the alternative digital tool retrieved from a digital tool and task history database, API documentation of the alternative digital tool, and the resource-capability mapping of the digital platform, wherein two isomorphic digital tools comprise corresponding tool functions that perform similar data operations on similar tool function inputs;
generate the alternative function variant for the platform function, based on a result of the isomorphic analysis; and
add the alternative function variant to the resource-capability mapping.

4. The one or more non-transitory storage media of claim 3, wherein the isomorphic analysis is limited to tool functions of the initial digital tool called upon by the initial function variant.

5. The one or more non-transitory storage media of claim 3, wherein the initial function variant and the alternative function variant are written in a scripting language, and wherein the program code to generate the alternative function variant, when executed, causes the processor to substitute each tool function call of the initial tool function in the initial function variant with a corresponding function call of the alternative tool function.

6. The one or more non-transitory storage media of claim 1, wherein the program code when executed further causes the processor to:
execute the initial function variant of the IDMP function to complete the target digital task on the digital model file using the initial digital tool, to generate a first output, and wherein the execution of the alternative function variant of the platform function completes the target digital task on the digital model file to generate a second output; and
generate a comparison result from comparing the first output and the second output based on one or more evaluation criteria.

7. The one or more non-transitory storage media of claim 6, wherein the program code when executed further causes the processor to:
present the comparison result to a user;
receive from the user, a selection of the alternative digital tool for use to complete the digital task; and
add the user selection to the digital tool and task database.

8. The one or more non-transitory storage media of claim 1, wherein the program code to retrieve the alternative function variant when executed further causes the processor to:
identify the alternative function variant, by analyzing digital tool and task history data stored in a digital tool and task history database to pattern-track how a user navigated through the digital platform and the user's tool decisions to complete analogous tasks in the past.

9. The one or more non-transitory storage media of claim 1, wherein the user request is indicative of a user intent related to the digital platform, wherein the user request comprises one or more operations performable by a user on the digital platform to achieve the user intent, wherein the user intent comprises an outcome desired by the user when interacting with the digital platform, and wherein the program code when executed further causes the processor to generate the digital task based on the user intent.

10. The one or more non-transitory storage media of claim 1, wherein the program code when executed further causes the processor to:
track, using a token management module, the execution of the alternative function variant to complete the digital task using one or more idempotent tokens to avoid duplicate executions.

11. The one or more non-transitory storage media of claim 1, wherein the initial digital tool and the alternative digital tool are provided by at least two distinct digital tool providers, and wherein at least one of the initial digital tool and the alternative digital tool is open-sourced.

12. The one or more non-transitory storage media of claim 1, wherein the program code when executed further causes the processor to:
modify a platform script to generate a modified platform script by replacing an invocation of the initial function variant with an invocation of the alternative function variant.

13. The one or more non-transitory storage media of claim 12, wherein the program code when executed further causes the processor to:
verify that the modified platform script, when interpreted, generates an identical output as the platform script, within a given error tolerance.

14. A computer-implemented method for completing a digital task using an alternative digital tool, the computer-implemented method executable by a processor, comprising:
receiving a user request indicative of the digital task involving an input digital model;
retrieving a digital model file of the input digital model, wherein the digital task is to be completed on the digital model file using an initial digital tool within a digital platform;
identifying a platform function from a resource-capability mapping of the digital platform, wherein an execution of the platform function completes the digital task on the digital model file, wherein the platform function is associated with a given function schema, wherein the resource-capability mapping provides a correspondence between a given resource on the digital platform and a corresponding capability of the given resource, wherein the given resources comprise tool functions and digital model types accessible on the digital platform, and wherein the corresponding capabilities of the given resources comprise platform functions executable on the digital platform;
identifying, from the resource-capability mapping, an initial function variant of the platform function implemented with the initial digital tool, wherein the initial function variant complies with the given function schema;
retrieving, from the resource-capability mapping, an alternative function variant of the platform function implemented with the alternative digital tool, wherein the alternative function variant also complies with the given function schema; and
executing the alternative function variant of the platform function to complete the digital task on the digital model file using the alternative digital tool.

15. The computer-implemented method of claim 14, further comprising:
receiving a user selection of the initial digital tool.

16. The computer-implemented method of claim 14, further comprising:
receiving a user request for the alternative digital tool;
determining that the resource-capability mapping of the digital platform does not include the alternative function variant implemented with the alternative digital tool;
in response to determining that the resource-capability mapping of the digital platform does not include the alternative function variant, performing an isomorphic analysis between the initial digital tool and the alternative digital tool, based on usage information of the initial digital tool and of the alternative digital tool retrieved from a digital tool and task history database, API documentation of the alternative digital tool, and the resource-capability mapping of the digital platform, wherein two isomorphic digital tools comprise corresponding tool functions that perform similar data operations on similar tool function inputs;
generating the alternative function variant for the platform function, based on a result of the isomorphic analysis; and
adding the alternative function variant to the resource-capability mapping.

17. The computer-implemented method of claim 16, wherein the isomorphic analysis is limited to tool functions of the initial digital tool called upon by the initial function variant.

18. The computer-implemented method of claim 16, wherein the initial function variant and the alternative function variant are written in a scripting language, and wherein the generating the alternative function variant comprises substituting each tool function call of the initial tool function in the initial function variant with a corresponding function call of the alternative tool function.

19. The computer-implemented method of claim 14, further comprising:
executing the initial function variant of the IDMP function to complete the target digital task on the digital model file using the initial digital tool, to generate a first output, and wherein the execution of the alternative function variant of the platform function completes the target digital task on the digital model file to generate a second output; and
generating a comparison result from comparing the first output and the second output based on one or more evaluation criteria.

20. The computer-implemented method of claim 19, further comprising:
presenting the comparison result to a user;
receiving from the user, a selection of the alternative digital tool for use to complete the target digital task; and
adding the user selection to the digital tool and task database.
